(19) United States
(12) Patent Application Publication
(10) Pub. No.: US 2022/0159932 A1
(43) Pub. Date: May 26, 2022

(54) METHODS, DEVICES, AND SYSTEMS FOR INFORMATION TRANSFER WITH SIGNIFICANT POSITIONS AND FEEDBACK

(71) Applicant: FILARION INC., Rancho Santa Fe, CA (US)

(72) Inventor: Rebecca Martha TAKADA NEFF, Palo Alto, CA (US)

(21) Appl. No.: 17/535,443

(22) Filed: Nov. 24, 2021

Related U.S. Application Data
(60) Provisional application No. 63/198,938, filed on Nov. 24, 2020.

(51) Int. Cl. A01K 27/00; G06F 3/16

(52) U.S. Cl. CPC A01K 27/009; A01K 27/002; G06F 3/16

(57) ABSTRACT

Systems, methods, and devices for information transfer comprising a physical or conceptual space that may be populated by significant spatial and/or conceptual positions or significant gestures. One or more users, including humans and animals such as domesticated dogs, may interact with and/or activate elements of this physical or conceptual space, including by wearing devices configured for sensing the users' position and/or movement. The user's interactions with significant spatial positions or significant gestures may produce one or more outputs, such as audio playback of phonetic sounds, or of prerecorded words or phrases. The user may build sequences of phonetic sounds to produce words. The user may receive feedback that may allow the user to detect and interact with the significant spatial positions and/or significant gestures, including by wearing devices configured to produce haptic feedback when the user interacts with or accesses a significant spatial position and/or significant gesture.

### CROSS-REFERENCE TO RELATED APPLICATIONS

This application claims priority pursuant to 35 U.S.C. § 119(e) to U.S. Provisional Application Ser. No. 63/198,938 filed on Nov. 24, 2020, which is incorporated herein by reference in its entirety.

### FIELD OF THE INVENTION

The present disclosure relates to devices, systems, and methods to improve information transfer, including communication.

### BACKGROUND

Since early recorded human history, people have wanted to communicate with and better understand animals such as dogs, dolphins, horses, and others. This theme appears across cultures in our myths, our folklore, and our stories (books and films included). It is an innate desire, and that desire reveals a problem.

Both we and our animals find ourselves frustrated by unclear communication and a desire to connect. We do our best to understand what our animals want through nonverbal cues, but communication between humans and animals has historically been difficult, and miscommunications abound.

In Agility, for example, a dog may show its irritation when his or her owner does not understand his or her needs, and vice versa. At home, a dog cannot explain to his or her frustrated owner why he or she is barking. At the airport, a security dog may be able to signal to its handlers that he or she smells something to investigate in a suitcase, but the security dog cannot tell its handlers if the item to investigate is a piece of fruit, a bomb, or drugs. In police departments, dogs may be trained to either signal bomb or drug, but not both because the dog cannot communicate what he or she smells directly to his or her human partners. A service dog may need to communicate for a variety of reasons to its handler, including if the dog needs to use the restroom or to warn the handler. Veterinarians may benefit if the dog could communicate that it was feeling discomfort. Relatedly, equestrians sometimes only realize their horses are feeling sick when it is too late to help them.

A number of animals have shown the capacity to communicate in sounds and other cues that in some ways hold similarities to human language. For example, certain animals can produce sounds that resemble human “talk.” Meerkats have been studied thoroughly and were discovered to have simple vocalized and language like communication where they can identify predators and warn their group. Meerkats can even describe a human being down to what clothes that the person is wearing, the person's height, and the color of that person's shirt. Rats also have a verbal syntax that scientists are still trying to decode and understand. Alex the Parrot was famously studied and shown to be able to communicate in human words. Dolphins and apes can understand and sometimes communicate using gestures. Dolphins can understand human gestures.

Dogs are our oldest allies and are likely the first domesticated animal. This domestication can be evidenced in the way dogs seek to communicate or understand their human companions. For example, a puppy will look at the direction a human is pointing. But a wolf pup will not. Dogs have evolved together alongside us.

Dogs are intelligent animals. One dog famously learned about one thousand words (mostly the name of her toys). Studies over the years have shown that dogs understand human speech. Based on studies of dog basic understanding of arithmetic, some have said that dogs' intelligence is on part with a two-year-old human. Studies have shown that dogs understand both words and intonation of human speech. In addition, more recently, it has been shown that dogs may communicate with their owners by means of sound producing buttons representing specific words.

Neuroscience tells us that the brain is like a computer that is programmed to use and adapt to any sensory input or limb that is provided to it, i.e., “plasticity.” If one adds an eye, for example, the brain learns to see; a nose, the brain learns to smell; infrared sensors, the brain eventually adapts and learns to “see” in infrared. The input from the sensor is sensed and adapted into the brain over time.

Animals have also been shown to adapt to using new artificial appendages such as artificial limbs, learning to control and move robot arms to do tasks such as bringing food to the animal's mouth.

Articulatory phonetics is the branch of phonetics concerned with describing the speech sounds of the world's languages in terms of their articulations, that is, the movements and/or positions of the vocal organs (articulators). Articulatory phonetics is concerned with the physical mechanisms involved in producing spoken language. A fundamental goal of articulatory phonetics is to relate linguistic representations to articulator movements in real time and the consequent acoustic output that makes speech a medium of information transfer. This area of phonetics has traditionally concerned itself with organic articulators and the human mouth.

In the field of phonetics as it has been applied to humans, the “place of articulation” is the location of where passive and active articulators may meet to produce sounds, or the location of places in the organic instrument where sound may be produced. Further in the field of phonetics, “manner of articulation” in humans may refer to what sort of constriction will be made. For example, in the humans, the movement of active and passive articulators may be brought together to make a complete closure such that airflow out of the mouth is cutoff, also known as a “stop.”

Animals such as dogs do not have the same human organic articulators that we humans use, and they cannot speak to us like we do with one another. Dogs have not been able to build speech phonetically, including in the same or similar way that humans speak. The reason is that dogs do not have access to anything like our complex tongues and mouths.

The present disclosure introduces devices, methods, and/or systems directed to improving information transfer, such as communication. An application of the present disclosures is to create a medium of information transfer such that animals and humans may interact. The novel devices, systems, and methods of this invention may allow the user to use goal-directed gestures to reach significant spatial positions that correspond with elements composing speech, including but not limited to sounds derived from the International Phonetic Alphabet (“IPA”) used in the fields of linguistics and phonetics, and or other mediums of information transfer. In some nonlimiting embodiments, phonetic sounds that are assigned to the significant spatial positions, thus creating movements of speech and or other mediums of information transfer.

This invention may allow animals like dogs and other animals to communicate by providing novel devices, methods, and/or systems. The devices, methods, and/or systems may allow the wearer to speak phonetically in a same or similar manner to the way humans construct speech. In this way, the dog can learn to use an artificial speech instrument to communicate with humans and others, such as with other animals. The present disclosures may also allow interaction with other technologies that accept verbal input, such as with voice assistants or with artificial intelligence. The device, method, and/or system may also be used by humans otherwise lacking speech facilities to build speech phonetically.

We can ask Fido a question, and he can answer in a way we understand. Fido is no longer a silent passive receiver. Instead, Fido has agency to deliberately tell us what he wants us to know. The devices of the present disclosures allow him to communicate to us.

### SUMMARY OF INVENTION

The present disclosure presents systems, methods, and devices for facilitating information transfer, including through the interaction between a user and one or more significant spatial positions and/or significant gestures. Such interaction may produce an output, including without limitation haptic feedback, vibration, sound, data, etc. In some embodiments, humans or animals may use the system, methods, and devices to communicate, including by providing systems, methods, and devices for an animal to construct speech phonetically and/or communicate using prerecorded words or phrases.

An apparatus, comprising:
one or more sensors configured to generate signals indicative of at least one of a spatial position and an orientation of a user; and
one or more processors configured to receive the signals wherein the one or more processors execute instructions for:
determining that at least a portion of the user has intersected a defined spatial region or that the user has assumed a defined orientation; and
generating, based upon the determining, one or more output signals.

The apparatus further comprising:
one or more components configured to store data wherein the data includes sound data corresponding to one or more prerecorded sounds;
one or more speakers;
wherein the instructions further include instructions for:
   selecting at least one of the one or more prerecorded sounds corresponding to the defined spatial region;
   generating, based on the selecting, an output signal based upon the sound data corresponding to the least one of the one or more prerecorded sounds;
wherein the one or more speakers are configured to produce sound comprising the least one of the one or more prerecorded sounds in response to the output signal.

The apparatus further comprising one or more prerecorded sounds stored on the one or more components configured to store data comprise phonetic sounds.

The apparatus further comprising components or programming for speech or sound synthesis, as an alternative to or in addition to prerecorded sounds.

The apparatus further comprising additional sounds, such as tones, chimes, bells, music, etc.

The apparatus further comprising a harness, a harness comprising straps, adjustable straps, elastic components, buckles, D rings, O rings, or Velcro, further comprising releasable attachment points, including for electronic components.

The apparatus further comprising a head mounted display for the display of virtual reality and/or augmented reality.

The apparatus further comprising:
one or more haptic feedback components configured to produce haptic feedback;
wherein the instructions further include instructions for generating, based on the determining, an output signal configured to activate the one or more haptic feedback components;
wherein the one or more haptic feedback components are configured to generate first haptic feedback in response to the output signal.

The apparatus further comprising:

one or more components configured to store data wherein the data includes sound data corresponding to one or more prerecorded sounds;

one or more speakers;
wherein the determining includes determining that the portion of the user has intersected the defined spatial region or that the user has assumed the defined orientation for a period of time that exceeds a threshold value representing a period of time;
wherein the instructions further include instruction for:
selecting, based upon the determining, at least one of the one or more prerecorded sounds corresponding to the defined spatial region;
generating, based on the selecting, an output signal corresponding to the at least one of the one or more prerecorded sounds;
wherein the one or more speakers are configured to generate sound comprising the at least one of the one or more prerecorded sounds in response to the output signal.

The apparatus further comprising a system on a chip.

The apparatus further comprising one or more sensors that sense the orientation, position, or motion of the user.

The apparatus further comprising haptic feedback that may comprise one or more tap sensations.

The apparatus further comprising haptic feedback that may comprise one or more vibrations.

The apparatus further comprising components for vibration feedback.

The apparatus wherein the one or more outputs comprises data.

The apparatus further comprising a transceiver, wherein the transceiver may receive and transmit data.

The user of the apparatus may be a human being, or an animal, such as a dog, cat, horse, dolphin, monkey, etc. The user of the system may also be an artificial intelligence or software algorithm.

A system, comprising:

one or more sensors configured to generate signals indicative of at least one of a spatial position and an orientation of an appendage of a user wherein paths or rotations of the appendage in three-dimensional space fixed relative to a direction of a gaze of the user correspond to one or more gestures; and

one or more processors configured to receive the signals wherein the one or more processors execute instructions for:

determining that the user has at least one of: (i) moved the appendage along a first of the paths corresponding to a first gesture of the gestures, and (ii) rotated the appendage in a manner corresponding to a second gesture of the gestures;

generating, based upon the determining, an output signal corresponding to at least one of the first gesture and the second gesture.

The system further comprising:

one or more components configured to store data wherein the data includes sound data corresponding to one or more prerecorded sounds;

one or more speakers;

wherein the instructions further include instructions for:
selecting at least one of the one or more prerecorded sounds corresponding to the at least one of the first gesture and the second gesture;
generating, based on the selecting, an output signal corresponding to the at least one of the one or more prerecorded sounds;

wherein the one or more speakers are configured to generate sound comprising the at least one of the one or more prerecorded sounds in response to the output signal.

The system further comprising:
one or more components configured to produce haptic feedback;
wherein the instructions further include instructions for generating, based on the determining, an output signal configured to activate the one or more haptic feedback components;
wherein the one or more components configured to produce haptic feedback generate first haptic feedback in response to the output signal.

The system further comprising one or more prerecorded sounds stored the one or more components configured to store data comprise one or more phonetic sounds.

The user of the system may be a human being, or an animal, such as a dog, cat, horse, dolphin, monkey, etc. The user of the system may also be an artificial intelligence or software algorithm.

The system further comprising a system on a chip.

The system further comprising one or more sensors that sense the orientation, position, or motion of the user.

The system further comprising haptic feedback that may comprise one or more tap sensations.

The system further comprising haptic feedback that may comprise one or more vibrations.

The system further comprising components for vibration feedback.

The system wherein the one or more outputs comprises data.

The system further comprising a transceiver, wherein the transceiver may receive and transmit data.

The system further comprising a server wherein the transceiver revies and transmits data with the server.

The system further comprising one or more power sources, such as a battery, rechargeable battery, power outlet, solar power, etc.

The system further comprising sensors capable of sending whether the user's mouth is closed or open, wherein when the user's mouth is open, output may be activated, and when the user's mouth is closed, output may be deactivated.

The system further comprising a phonetic space organizing certain phonetic sounds, such as consonants and vowels, to certain defined spatial regions.

The system further comprising the user's interaction with said phonetic space.

The system further comprising the user's interaction with said phonetic space using an appendage, wherein sensors track the position, movement, and orientation of the user's appendage.

The system wherein the user's appendage is a nose or snout.

An apparatus for use with a dog, the apparatus comprising:

a harness adapted to fit over a dog's snout and body;

one or more processors attached to the harness;

one or more sensors attached to the harness, the one or more sensors operatively connected to the one or more processors;

one or more haptic motors attached to the harness, the one more haptic motors operatively connected to the one or more processors;

one or more speakers attached to the harness, the one or more speakers operatively connected to the one or more processors; and

one or more power sources attached to the harness and electrically coupled to at least the one or more processors and the one or more haptic motors.

The apparatus further comprising:

one or more storage components, the one or more storage components operatively connected to the one or more processors;

one or more prerecorded sounds stored on the one or more storage components;

the one or more power sources further electrically coupled to the one or more storage components.

The apparatus wherein the one or more prerecorded sounds comprise one or more phonetic sounds or one or more prerecorded sounds or phrases.

The apparatus further comprising:

one or more storage components, the one or more storage components operatively connected to the one or more processors and configured to store sound data corresponding to one or more prerecorded sounds;

the one or more power sources further electrically coupled to the one or more storage components.

The apparatus further comprising sensors capable of sending whether the user's mouth is closed or open.

A system, comprising:

a first apparatus comprising:
one or more components configured to store and play sound;
one or more transceivers capable of communicating wirelessly;

a second apparatus comprising:
one or more transceivers capable of communicating wirelessly;
one or more microphones capable of recording sound;
one or more components configured to store and play sound;
a non-transitory computer readable storage medium embodying a computer program comprising computer instructions for:
   recording one or more sounds using the one or more microphones;
   connecting to the first apparatus wirelessly;
   transmitting a recorded sound to the first apparatus.

wherein the second apparatus transmits recorded sound to the first apparatus,

wherein the first apparatus stores the recorded sound.

A system comprising:

a processor configured to:
determine social networking context, wherein said social networking context includes information regarding pets, comprising at least one of the following:
   pet name;
   pet age;
   training statistics;
   speech statistics;
generate at least one view based at least in part on the social networking context;
display the generated view.

A training method involving a trainer and a trainee wherein the trainer is a person and the trainee is a dog, the training method comprising:
observing, by the trainer, the trainee interacting with an apparatus wherein the apparatus comprises components that audibly generate at least one prerecorded sound in response to one or predefined actions of the trainee;
hearing, by the trainer, the apparatus audibly generate at least one prerecorded sound;
providing, by the trainer, a reward to the trainee.

A training method involving a trainer and trainee wherein the trainer is a person and the trainee is a dog wearing an apparatus, the apparatus including:
one or more sensors configured to generate signals indicative of at least one of a spatial position and an orientation of the trainee;
   one or more data storage components;
   one or more speakers configured to receive signals and generate sound;
   one or more prerecorded sounds comprising the phonetic alphabet stored on the one or more data storage components;
one or more processors configured to receive the signals wherein the one or more processors execute instructions for:
   determining that at least a portion of the trainee has intersected a defined spatial region or that the user has assumed a defined orientation;
   generating, based upon the determining, an output signal comprising the one or more prerecorded sounds;
   wherein the one or more speakers configured to receive signals and generate sound receive said output signal comprising the one or more prerecorded sounds and generate sound comprising the selected one or more prerecorded sounds.
the training method comprising:
   observing, by the trainer, that the apparatus generates the sound comprising the selected one or more prerecorded sounds;
   providing, by the trainer, a reward to the trainee.

Other aspects and advantages of the invention will become apparent from the detailed description and accompanying drawings.

### BRIEF DESCRIPTION OF THE DRAWINGS

FIGS. 1 through 5 are each conceptual illustrations showing an example of a user and significant spatial and/or conceptual positions and/or significant gestures in three-dimensional Euclidean space in accordance with embodiments of the present disclosure.

FIGS. 6, 7, 8A-D illustrate process flows showing examples of processes for user interaction and output in accordance with embodiments of the present disclosure.

FIG. 9 is a schematic drawing showing an example of the Phonetic Space Organizational System in accordance with embodiments of the present disclosure.

FIG. 10 is a schematic drawing showing an example of consonants from the IPA chart in accordance with embodiments of the present disclosure.

FIG. 11 is a schematic drawing showing an example of vowels from the IPA chart in accordance with embodiments of the present disclosure.

FIG. 12 is a schematic drawing showing an example of vowels from the IPA chart in an arrangement in accordance with embodiments of the present disclosure.

FIG. 13 is a schematic drawing showing an example of an apparatus and the one or more modules that may be operably connected with said apparatus in accordance with embodiments of the present disclosure.

FIGS. 14A and 14B are schematic drawings of an exemplary environments for systems, apparatuses, and processes in accordance with embodiments of the present disclosure.

FIG. 15 is a schematic drawing of an example of a user and system, device, and/or process interaction using mobile computing devices in accordance with embodiments of the present disclosure.

FIG. 16 is a schematic drawing of an example of a Harness Device System in accordance with embodiments of the present disclosure.

FIG. 17 illustrates an example arrangement of consonant phonetic sounds in accordance with embodiments of the present disclosure.

FIGS. 18A-C, 19A-C, and 20A-D illustrate example positions the user may take in accordance with embodiments of the present disclosure.

FIGS. 21A-D illustrate views and components of a harness in accordance with embodiments of the present disclosure.

FIGS. 22A-D illustrate devices, systems, and methods in accordance with embodiments of the present disclosure.

FIGS. 23A-D illustrate functional screen diagrams in accordance with embodiments of the present disclosure.

FIGS. 24A-D illustrate functional screen diagrams in accordance with embodiments of the present disclosure.

FIG. 25 illustrates a cage device embodiment of the present disclosure.

### DETAILED DESCRIPTION

Reference will now be made in detail to various embodiments of the present invention, examples of which are illustrated in the accompanying drawings. The following description of embodiments is not intended to limit the invention to these embodiments but rather to enable a person of skill in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

This invention comprises systems, methods, and devices that facilitate the creation of a physical or conceptual space that may be populated by significant spatial and/or conceptual positions. Users may produce, interact with, and/or activate elements of this physical or conceptual space for communication and/or information transfer. Additionally, the user may be provided one or more forms of feedback that may allow user to detect the physical or conceptual space and/or significant spatial positions, or to further interact with the physical or conceptual space. Furthermore, the invention may facilitate data collection from the user. A single user or multiple users may make use of interact with the present invention.

Users of the embodiments of this invention may include but are not limited to humans or animals, such as dogs, cats, horses, pigs, dolphins, etc. This invention is not limited to dogs and may be used with other animals, computers, artificial intelligence, people, etc.; but for the purposes of describing the invention, a dog may be used in the embodiments described below.

In an exemplary embodiment, the user may interface with the systems, methods, and devices with passive/unconscious and/or active/conscious goal-directed interactions to access, interact with, produce, and/or activate elements of communication or information transfer. In some non-limiting embodiments, the user may use goal-directed gestures to reach significant spatial positions that correspond with elements composing speech and/or other mediums of information transfer. In some nonlimiting embodiments, phonetic sounds may be assigned to the significant spatial positions, interacting with, accessing, and or activating these significant spatial positions may create phonetically produced speech. In other non-limiting embodiments, other mediums of information transfer may be accessed using significant spatial positions. For example, embodiments of the invention may use numbers, codes, and other forms of information transfer and/or communication, such as words or phrases. In certain non-limiting embodiments, the user may use gestures to reach significant spatial positions that correspond with pre-recorded words and/or phrases.

In some nonlimiting embodiments, activation, interaction, and/or access of significant spatial positions may be achieved through reaching using physical movement the significant spatial position, for example through gestures towards those significant spatial positions. For example, in some embodiments, the user's head may reach or turn to specific positions and angles. Some non-limiting embodiments may include both holding the position, the direction, and/or the movement or gesture. Other non-limiting embodiments may trigger phonetic sounds when the user uses significant movements or poses in significant directions, also known as gesturing. Some embodiments may trigger pre-recorded words or phrases when the user gestures in certain positions or reaches significant spatial positions.

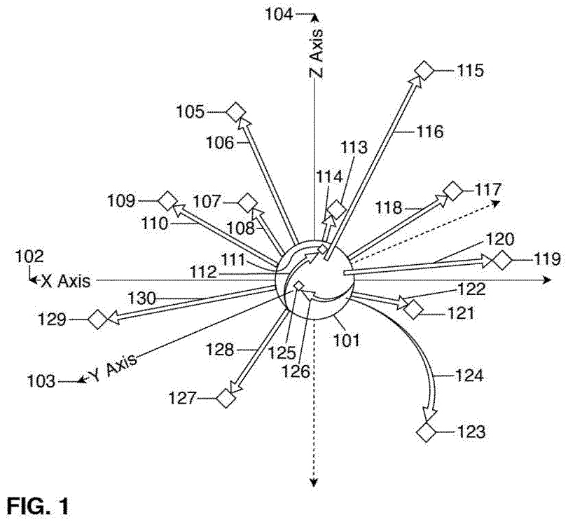

FIGS. 1 through 4 illustrate conceptually embodiments of the invention using a three-dimensional Euclidean graph with x-axis 102, y-axis 103, and z-axis 104. User 101 is illustrated spherically, but it should be understood that user 101 may be a person or animal, and may represent the user's body, head, snout, hand, arm, leg, foot, tail, or any other appendage or body part of the user. In some embodiments, user 101 may represent a real location, as illustrated in three-dimensional space as an example. In some non-limiting embodiments, user 101 may represent a conceptual location within a three-dimensional space, for example where user 101 conceptualizes a location in those embodiments using a neural implant and interacts with a conceptual space using thought or the production of electrical and or chemical signals from the brain. As illustrated in FIG. 1, user 101 may interact with significant and/or conceptual spatial positions 105, 107, 109, 111, 113, 115, 117, 119, 121, 123, 125, 127, and 129. In other non-limiting embodiments, fewer or more significant spatial and or conceptual positions may be included. In other embodiments, the number of significant spatial positions may be 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, or more. For example, tens, hundreds, thousands, hundreds of thousands, or more significant spatial positions may be included.

While significant spatial and/or conceptual positions 105, 107, 109, 111, 113, 115, 117, 119, 121, 123, 125, 127, and 129 are illustrated using diamond symbols, significant spatial positions may correspond to any point, plane, area, or region, including spherical, cubic, or any variety of shapes. The properties of a significant spatial and/or conceptual position may change over time, including varying the location, size, or region that the position encompasses.

Arrows 106, 108, 110, 114, 116, 118, 120, 124, 128, and 130 illustrate the potential paths that that user 101 may take to reach the corresponding significant spatial and or conceptual positions 105, 107, 109, 113, 115, 117, 119, 121, 123, 127, and 129. Some paths that user 101 may take, such as shown by arrow 106, may be linear, while other paths, such as shown by arrow 124, may be curved or indirect. In some embodiments, the production of an effect when a user reaches a significant spatial and or conceptual position may be agnostic to the path that the user takes. In certain embodiments, a significant spatial and or conceptual position may only produce an effect only if the user follows a specific path. Arrows 112 and 126 show conceptually the rotations that the user 101 may make to reach corresponding significant spatial positions 111 and 125. In some embodiments, the production of an effect when a user reaches a significant spatial and or conceptual position through rotation may be agnostic to the specific rotation or rotations that the user takes. In other embodiments, a significant spatial and/or conceptual position may only produce an effect when the user follows a specific rotation.

In certain embodiments, the position of each significant spatial position and/or the region representing significant spatial position is fixed relative to the gaze of the user. The gaze of the user may be described using angular coordinates and/vectors. As the user's gaze moves, each significant spatial position and/or region may move accordingly so that their positions are fixed relative to the user's gaze. In some embodiments, one or more significant spatial positions may be fixed in space agnostic to the user's gaze.

The user reaching a significant spatial position may produce one or more effects. For example, reaching a significant spatial position may produce the playback of a prerecorded sound. Movement of the user to the significant spatial position may result in feedback to the user such as but not limited to: auditory feedback, haptic/sensory feedback, olfactory feedback, gustatory feedback, etc. The effect of a significant spatial position may be to negate or eliminate the effect(s) of another significant spatial position.

Intersections of the user and a significant spatial position may be calculated, described, or understood using several methods. For example, collisions may be determined by assigning bounding boxes to a user and each significant spatial position and calculating any resulting overlapping areas. Multiple bounding boxes may be used to represent a single area, such as the user or a significant spatial position. Bounding boxes may be constrained by axis-alignment to ease computation and increase performance, or the bounding boxes may be oriented. Furthermore, collisions may be calculated including by calculating bounding boxes, comparing regions of space representing a user and a significant spatial position, or determining the three-dimensional angle between a user and a significant spatial position and calculating the force vectors, as examples. Other techniques for collision detection include using spheres as bounding volumes as an alternative to axis-aligned boxes, or using other overlap test structures such as trees, including without limitation cone trees, k-d trees, and octrees. Intersection of surfaces may also be calculated by computing intersection curves. Collision detection may be scheduled or bounded by maintaining a queue of the object pairs that are expected to collide. In addition, other techniques may be used to detect interaction with significant spatial positions, including vision-based tracking techniques, hybrid tracking techniques, marker-based tracking, marker-less tracking

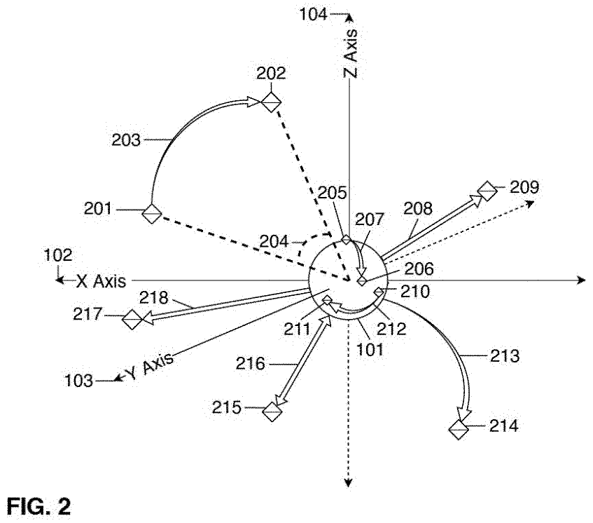

FIG. 2 further illustrates an embodiment of the invention where the user 101 may interact with significant spatial and/or conceptual gestures within a three-dimensional space, for example where user 101 conceptualizes a gesture in those embodiments using a neural implant and interacts with a conceptual space using thought or the production of electrical and or chemical signals from the brain. User 101 may interact with the Euclidean space via significant and or conceptual spatial gestures 201, 202, 205, 206, 209, 210, 211, 214, 215, and 217. In other non-limiting embodiments, fewer or more significant gestures may be included. In other embodiments, the number of significant gestures may be 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, or more. For example, tens, hundreds, thousands, hundreds of thousands, or more significant gestures may be included.

While significant spatial and or conceptual gestures 201, 202, 205, 206, 209, 210, 211, 214, 215, and 217 are illustrated using diamond symbols with a line through them, significant gestures may correspond to any path, area, or region, including spherical, cubic, or any variety of shapes. The properties of a significant spatial and/or conceptual position may change over time, including varying the location, size, length, or region that the position encompasses.

Arrows 203, 207, 208, 212, 213, 216, and 218 illustrate the potential paths that that user 101 may take to make the corresponding significant spatial and/or conceptual gestures 201, 202, 205, 206, 209, 210, 211, 214, 215, and 217. Some paths that user 101 may take, such as shown by arrows 218 and 208, may be linear and in one direction, while other paths, such as shown by arrow 213, may be curved or indirect. Some gestures that user 101 may make may take paths that move in a gesture in one direction, and then gesture back in the opposite direction afterwards such as the gesture 202 that reverses with return gesture 201 rotating along angle 204. User 101 may make gestures via rotations such as the gestures 205 and 206 using paths 207 and 212, and then reverse in direction with the respective return gestures 205 and 210. Rotational gestures may include but do not require return gestures. User 101 may use a gesture that is considered the same gesture in either direction such as is depicted in gesture 215 and path 216. In some embodiments, the production of an effect when a user makes a significant spatial and/or conceptual gesture may be agnostic to the path that the user takes. In certain embodiments, a significant spatial and/or conceptual gesture may only produce an effect only if the user follows a specific path.

In certain embodiments, the direction and/or path of each significant spatial and/or conceptual gesture is fixed relative to the gaze of the user. The gaze of the user may be described using angular coordinates and/vectors. As the user's gaze moves, each significant spatial and/or conceptual gesture may move accordingly so that their positions are fixed relative to the user's gaze. In some embodiments, the significant spatial and/or conceptual gestures may be fixed in space agnostic to the user's gaze.

The user making a significant spatial and/or conceptual gesture may produce one or more effects. For example, reaching a significant spatial and/or conceptual gesture may produce the playback of a prerecorded sound. Movement of the user via significant spatial and or conceptual gesture may result in feedback to the user such as but not limited to: auditory feedback, haptic/sensory feedback, olfactory feedback, gustatory feedback, etc. The effect of a significant spatial and or conceptual gestures may be to negate or eliminate the effect(s) of another significant spatial and or conceptual gesture.

Along with determining intersections and tracking techniques as described herein, movement, speed, direction, and other elements of a gesture by a user when the user makes a significant spatial and/or conceptual gesture may be calculated, described, or understood using several methods. For example, machine learning or deep learning may be employed to teach a computer algorithm how and when to recognize one or more gestures, based on input from one or more sensors or from vision-based input.

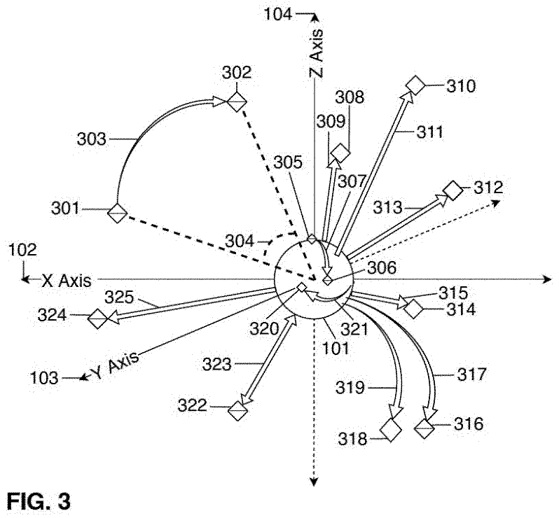

FIG. 3 further illustrates an embodiment of the invention where user 101 may interact with significant and/or conceptual spatial positions 308, 310, 312, 314, 318, and 320. User 101 may also interact with the significant and/or conceptual spatial gestures 301, 302, 305, 306, 316, 322, and 324. In non-limiting embodiments, fewer or more significant spatial and/or conceptual positions may be included. In other embodiments, the number of significant spatial positions may be 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 or more. For example, tens, hundreds, thousands, hundreds of thousands, or more significant spatial positions may be included. In other non-limiting embodiments, fewer or more significant gestures may be included. In other embodiments, the number of significant gestures may be 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 or more. For example, tens, hundreds, thousands, hundreds of thousands, or more significant gestures may be included.

While significant spatial and or conceptual positions 308, 310, 312, 314, 318, and 320 are illustrated using diamond symbols, significant spatial positions may correspond to any area or region, including spherical, cubic, or any variety of shapes. While significant spatial and or conceptual gestures 301, 302, 305, 306, 316, 322, and 324 are illustrated using diamond symbols with a line through them, significant gestures may correspond to any area or region, including spherical, cubic, or any variety of shapes.

Arrows 309, 311, 313, 315, 319, and 321 illustrate the potential paths that that user 101 may take to reach the corresponding significant spatial and or conceptual positions 308, 310, 312, 314, 318, and 320. Some paths that user 101 may take, such as shown by arrow 309, 311, 313, and 315 may be linear, while other paths, such as shown by arrow 319, may be curved or indirect. In some embodiments, the production of an effect when a user reaches a significant spatial and/or conceptual position may be agnostic to the path that the user takes. In certain embodiments, a significant spatial and or conceptual position may only produce an effect only if the user follows a specific path. Arrow 321 show conceptually a rotation that the user 101 may make to reach corresponding significant spatial position 320. In some embodiments, the production of an effect when a user reaches a significant spatial and/or conceptual position through rotation may be agnostic to the specific rotation or rotations that the user takes. In other embodiments, a significant spatial and/or conceptual position may only produce an effect when the user follows a specific rotation.

Arrows 303, 307, 317, 323, and 325 illustrate the potential paths that that user 101 may take to make the corresponding significant spatial and or conceptual gestures 301 and 302, 305 and 306, 316, 322, and 324. Some paths that user 101 may take, such as shown by arrows 325, may be linear and in one direction, while other paths, such as shown by arrow 317, may be curved or indirect. Some gestures that user 101 may make may take paths that move in a gesture in one direction, and then gesture back in the opposite direction afterwards such as gesture 302 that reverses with return gesture 301. User 101 may make gestures via rotations such as the gestures 306 using path 307, and then reversing in direction with the respective return gesture 305 rotating along angle 304. Rotational gestures may include but do not require return gestures. User 101 may use a gesture that is considered the same gesture in either direction such as is depicted in gesture 322 and path 323.

In certain embodiments, the position of each significant spatial position and/or the region representing significant spatial position, and/or also the path of each significant spatial and/or conceptual gesture, is fixed relative to the gaze of the user. The gaze of the user may be described using angular coordinates and/vectors. As the user's gaze moves, each significant spatial position and/or region or path of each significant spatial and/or conceptual gesture may move accordingly so that their positions are fixed relative to the user's gaze. In some embodiments, one or more significant spatial positions or each significant spatial and/or conceptual gesture may be fixed in space agnostic to the user's gaze.

The user reaching a significant spatial position and/or making significant spatial and/or conceptual gestures may produce one or more effects, or negate the production of one or more effects, as described herein.

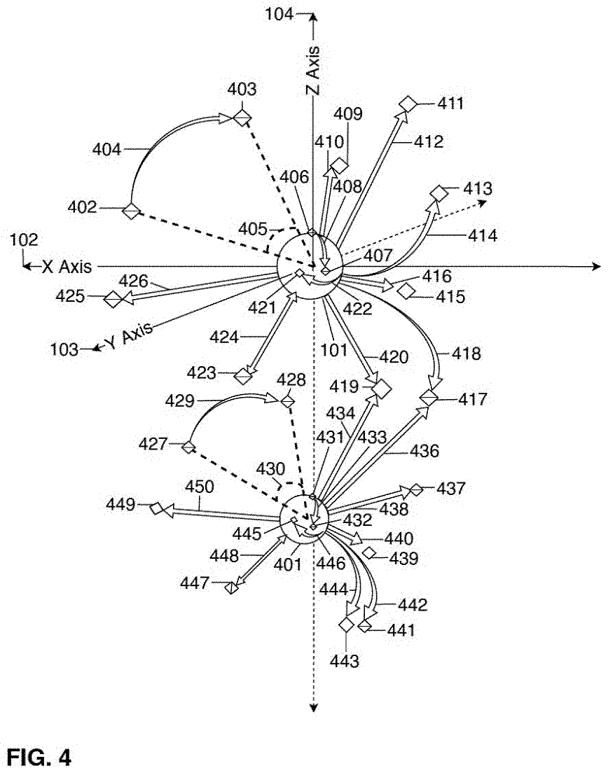

FIG. 4 further illustrates a user 401 which may represent the same user, user 101, but with another aspect of user such as but not limited to another body part of the user, or a different conceptual space that user 101 conceives of. User 401 may also be another or second user. There may be more than two users or aspects of a user for example, 3, 4, 5, 6, 7, 8, 9, or 10 users or aspects of a user, tens of users or aspects of a user, or hundreds of users or aspects of a user, or more. In some non-limiting embodiments, user 101 and or user 401 may represent one or more conceptual locations within a three-dimensional space, for example where user 101 and/or user 401 conceptualizes a location in those embodiments using a neural implant and interacts with a conceptual space using thought or the production of electrical or chemical signals from the brain. User 101 and user 401 may interact together to reach common significant spatial or conceptual positions, common significant spatial or conceptual gestures, or a combination of both significant spatial and or conceptual positions and gestures. The positions of user 101 and or user 401 may be in different orientations and/or positions or may change orientations and or positions in relation to one another. There may be movement from one or both users, including simultaneously or one at a time.

User 101 may interact with significant and or conceptual spatial positions 409, 411, 413, 415, and 419. User 101 may also interact with the Euclidean space via significant and or conceptual spatial gestures 402 and 403, 406 and 407, 423, 425, and 417. User 401 may interact with significant and or conceptual spatial positions 439, 443, 449, 445, and 419. User 401 may also interact with the Euclidean space via significant and or conceptual spatial gestures 427 and 428, 437, 441, 431 and 432, 447, and 417. User 101 and User 401 may interact together with a significant and/or conceptual spatial position 419. User 101 and user 401 may interact together with a significant or conceptual spatial gesture 417. In non-limiting embodiments, fewer or more significant spatial and/or conceptual positions may be included. In other embodiments, the number of significant spatial positions may be 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 or more. For example, tens, hundreds, thousands, hundreds of thousands, or more significant spatial positions may be included. In other non-limiting embodiments, fewer or more significant gestures may be included. In other embodiments, the number of significant gestures may be 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 or more. For example, tens, hundreds, thousands, hundreds of thousands, or more significant gestures may be included.

While significant spatial and or conceptual positions 409, 411, 413, 415, 419, 439, 443, 449, and 445. are illustrated using diamond symbols, significant spatial positions may correspond to any area or region, including spherical, cubic, or any variety of shapes. While significant spatial and or conceptual gestures 402, 403, 406, 407, 417, 423, 425, 427 and 428, 437, 441, 431, 432, and 447 are illustrated using diamond symbols with a line through them, significant gestures may correspond to any area or region, including spherical, cubic, or any variety of shapes.

Arrows 410, 412, 414, 416, 420, and 422 illustrate the potential paths that that user 101 may take to reach the corresponding significant spatial and/or conceptual positions 409, 411, 413, 415, 419, and 421. Some paths that user 101 may take, such as shown by arrow 410, 412, 416, and 420 may be linear, while other paths, such as shown by arrow 414, may be curved or indirect. In some embodiments, the production of an effect when a user reaches a significant spatial and or conceptual position may be agnostic to the path that the user takes. In certain embodiments, a significant spatial and or conceptual position may only produce an effect only if the user follows a specific path. Arrow 422 show conceptually rotation that the user 101 may make to reach corresponding significant spatial position 421. In some embodiments, the production of an effect when a user reaches a significant spatial and or conceptual position through rotation may be agnostic to the specific rotation or rotations that the user takes. In other embodiments, a significant spatial and or conceptual position may only produce an effect when the user follows a specific rotation.

Arrows 440, 444, 450, 446, and 434 illustrate the potential paths that that user 401 may take to reach the corresponding significant spatial and/or conceptual positions 439, 443, 449, 445, and 419. Some paths that user 401 may take, such as shown by arrow 434, 440, and 450 may be linear, while other paths, such as shown by arrow 442, may be curved or indirect. In some embodiments, the production of an effect when a user reaches a significant spatial and or conceptual position may be agnostic to the path that the user takes. In certain embodiments, a significant spatial and or conceptual position may only produce an effect only if the user follows a specific path. Arrow 446 show conceptually rotation that the user 401 may make to reach corresponding significant spatial position 445. In some embodiments, the production of an effect when a user reaches a significant spatial and or conceptual position through rotation may be agnostic to the specific rotation or rotations that the user takes. In other embodiments, a significant spatial and or conceptual position may only produce an effect when the user follows a specific rotation.

Arrows 404, 408, 424, 426, and 418 illustrate the potential paths that that user 101 may take to make the corresponding significant spatial and/or conceptual gestures 402, 403, 406, 407, 423, 425, and 418. Some paths that user 101 may take, such as shown by arrows 426, may be linear and in one direction, while other paths, such as shown by arrow 418, may be curved or indirect. Some gestures that user 101 may make may take paths that move in a gesture in one direction, and then gesture back in the opposite direction afterwards such as gesture 407 that reverses with return gesture 406 along path 408. User 101 may make gestures via rotations such as the gestures 403 using path 404, and then reversing in direction with the respective return gesture 402 rotating along angle 405. Rotational gestures may include but do not require return gestures. User 101 may use a gesture that is considered the same gesture in either direction such as is depicted in gesture 423 and path 424.

Arrows 429, 438, 442, 433, 448, and 436 illustrate the potential paths that that user 401 may take to make the corresponding significant spatial and/or conceptual gestures 427 and 428, 437, 441, 431 and 432, 447, and 417. Some paths that user 401 may take, such as shown by arrows 436 and 437, may be linear and in one direction, while other paths, such as shown by arrow 442, may be curved or indirect. Some gestures that user 101 may make may take paths that move in a gesture in one direction, and then gesture back in the opposite direction afterwards such as gesture 432 that reverses with return gesture 431 along path 433. User 401 may make gestures via rotations such as the gesture 428 using path 429, and then reversing in direction with the respective return gesture 427 rotating along angle 430. Rotational gestures may include but do not require return gestures. User 401 may use a gesture that is considered the same gesture in either direction such as is depicted in gesture 447 and path 448.

In certain embodiments, the position of each significant spatial position and/or the region representing significant spatial position, and/or also the path of each significant spatial and/or conceptual gesture, is fixed relative to the gaze of one of the users. The gaze of a user may be described using angular coordinates and/vectors. As that user's gaze moves, each significant spatial position and/or region or path of each significant spatial and/or conceptual gesture may move accordingly so that their positions are fixed relative to that user's gaze. In additional embodiments, such one or more positions and/or paths may be fixed relative to the gaze of each the two or more users, such that position and tracking or collision information is maintained separately for each such user. In some embodiments, one or more significant spatial positions or each significant spatial and/or conceptual gesture may be fixed in space agnostic to the one or more user's gazes.

The one or more users or aspects of a user reaching a significant spatial position and/or making significant spatial and/or conceptual gestures may produce one or more effects, or negate the production of one or more effects, as described herein.

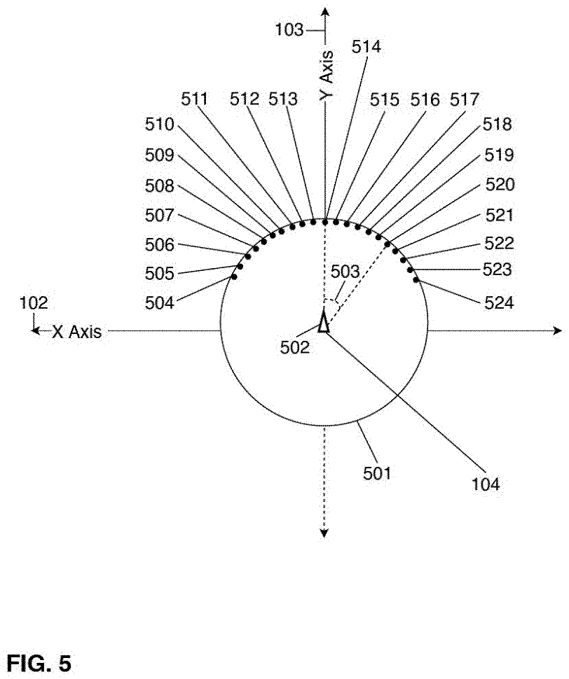

FIG. 5 illustrates conceptually an embodiment of the invention using a three-dimensional Euclidean graph with x-axis 102, y-axis 103, and z-axis 104. Z-axis 104 is perpendicular to the intersection of the x-axis 102, and the y-axis 103. User 501 is illustrated spherically, but it should be understood that user 101 may be a person or animal, and may represent the user's body, head, snout, hand, arm, leg, foot, tail, or any other appendage or body part of the user. In some non-limiting embodiments, user 501 may represent conceptual locations within a three-dimensional space, for example where user 501 conceptualizes a location in those embodiments using a neural implant and interacts with a conceptual space using thought or the production of electrical or chemical signals from the brain.

Direction indicator 502 is illustrated as a triangle with the longest point pointed perpendicularly with a flat base from the x-axis 102 and pointing towards the y-axis 103. Direction indicator 502 may indicate the direction user 501 may be facing. Direction indicator 502 may rotate in place to indicate changes in user 501's rotation. The degree from which user 501 may rotate may be varying degrees as is indicated by degree 503. Significant spatial and/or conceptual positions and or gestures are indicated by points 504, 505, 506, 507, 508, 509, 510, 511, 512, 513, 514, 515, 516, 517, 518, 519, 520, 521, 522, 523, and 524. Points 504-524 are non-limiting points, additional points may appear anywhere on the three-dimensional Euclidian graph depicted in FIG. 5 points 504-524 may represent but is not limited in representation significant phonetic sound positions such as but not limited to significant consonant spatial positions, significant vowel spatial positions, significant gestures, significant conceptual positions for phonetic sounds, significant positions that represent words and or sentences, codes, tones, music, etc. When user 501 rotates so that the longest corner direction indicator 502 points to a significant spatial or conceptual position, an output may be triggered such as audio that corresponds with the assigned meaning of that position. When user 501 rotates so that the longest corner direction indicator 502 moves to a significant spatial or conceptual direction, an output may be triggered such as audio that corresponds with the assigned meaning of that gesture.

While FIGS. 1-5 are embodiments of the invention illustrated in Euclidean geometry, various embodiments may be illustrated or understood using any conceptual representation, including but not limited to non-Euclidean geometry, spherical geometry, elliptic geometry, hyperbolic geometry, fractal geometry, mixed geometries, twisted geometries, network geometries, etc. Embodiments of the invention may also be illustrated or understood by using graphs such as directed graphs, undirected graphs, weighted graphs, etc. For example, embodiments of the invention may store or represent information relating to significant spatial positions or significant spatial and/or conceptual gesture and the position of the one or more users using nodes and connections, such as the region or area of each significant spatial position, and the position of the user. Significant spatial positions or significant spatial and/or conceptual gestures may be coded using a variety of means or data structures, including using coordinates, data structures, relationally, etc.

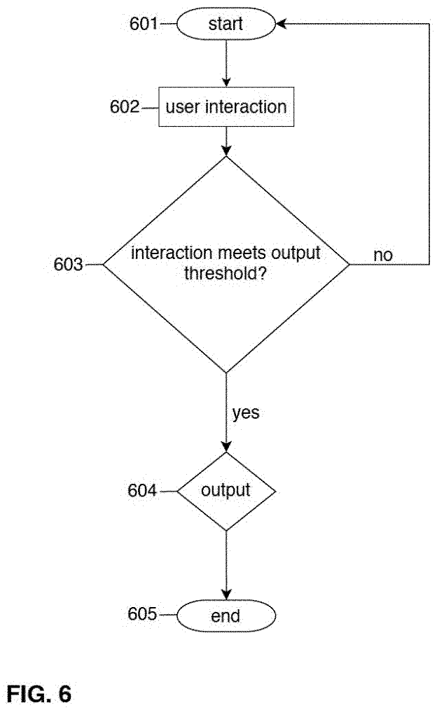

FIG. 6 illustrates a process describing conceptually an embodiment of the invention. The process begins at start 601. The process receives user interaction at step 602. The process determines whether the user interaction meets an output threshold at step 603. If yes, the process continues to an output at step 604. The process may then proceed to end 605. If the interaction does not meet the output threshold, the process may loop back to start 601.

In some embodiments of the invention, the process may use a computer and various input/output devices to construct, send, and/or receive communications via a device by reaching significant spatial positions or by using significant gestures. Some embodiments may also describe the underlying functions of a neural implant that may communicate with a brain via chemical and/or electric signals. These illustrated steps are exemplary and may change in order and content in different embodiments.

The process of outputting communication begins in 601. In some embodiments, the starting point 601 may occur before a user attempts a communication goal, and the device is powered on and active. A communication goal may be a sound, a phonetic sequence, a word made up of one or more phonetic sounds, multiple words, a sentence, multiple sentences, a code, tones, music, shorthand communication etc.

At step 602 the figure illustrates user interaction with the device 602. Step 602 may include the user's interaction reaching significant spatial positions, and/or using significant gestures, and/or communications from the user to the device via chemical and/or electrical signals from the user's brain.

At step 603, the device may determine whether user interaction meets an output threshold, and if so, the then output from the device 604 may occur. There may be more than one output threshold that a user could meet via interaction. There may be zero, one, two, three, four, five, six, seven, eight, nine, ten, eleven, twelve, thirteen, fourteen, fifteen, sixteen, seventeen, eighteen, nineteen, twenty or more output thresholds. The number of output thresholds could number from single digits, to the tens, hundreds, thousands, hundreds of thousands or more. A computer or third party may check if the interaction met an output threshold 603. The output threshold may be met via, for example, the user reaching significant spatial positions, or by the user making significant spatial gestures. Electrical and or chemical brain signals may also be means by which an output threshold may be met. If an output does not meet an output threshold, then the device and user returns to the start 601 of the process.

At step 604, the device may produce output. Output from the device, 604. may include feedback via audio, text, data, haptics, forces, smells, or other means. Haptic feedback may be substituted or augmented with other forms of feedback in different embodiments. Output 604 may result in for example, communication with a third party, interaction from the user to his/herself, and communication from the device to the user as a tool to use the device, communication from the environment creating output as the resulting process initialized by a user's interaction and device output leading the environment to respond the output (including but not limited to third parties, and non-living objects). After the output occurs at 604, the process may end at 605.

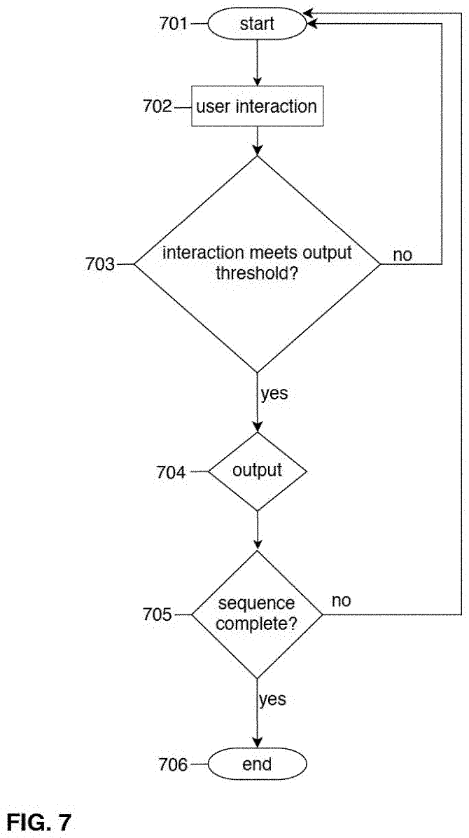

FIG. 7 illustrates a process describing conceptually an embodiment of the invention. The process begins at start 701. The process receives user interaction at step 702. The process determines whether the user interaction meets an output threshold at step 703. If yes, the process continues to an output at step 704. If the interaction does not meet the output threshold, the process may loop back to start 701. The process determines whether the user has completed a sequence at step 705. If yes, then the process may then proceed to end 705. If the user has not completed a sequence, the process may loop back to start 701.

In some embodiments of the invention, the process may use a computer and various input/output devices to construct, send, and/or receive communications via the device by reaching significant spatial positions or by using significant gestures. This embodiment may also describe the underlying functions of a neural implant that may communicate with a brain via chemical and/or electric signals. These steps are exemplary and may change in order and content with different embodiments of the invention.

The process of outputting communication begins in 701. The starting point 701 may occur before a user attempts a communication goal, and the device is set up and active. A communication goal may be a sound, a phonetic sequence, a word made up of one or more phonetic sounds, multiple words, a sentence, multiple sentences, a code, tones, music, shorthand communication etc.

At step 702, the figure illustrates user interaction with the device 702. User interaction 702 may include reaching significant spatial positions, and/or using significant gestures, and or communications from the user to the device via chemical and/or electrical signals from the user's brain.

At step 703, the device may check to see if user interaction meets an output threshold, if so then output from the device 704 may occur. There may be more than one output threshold that a user could meet via interaction. There may be zero, one, two, three, four, five, six, seven, eight, nine, ten, eleven, twelve, thirteen, fourteen, fifteen, sixteen, seventeen, eighteen, nineteen, twenty or more output thresholds. The number of output thresholds could number from single digits, to the tens, hundreds, thousands, hundreds of thousands or more. A computer or third party may check if the interaction met an output threshold 703. The output threshold may be met via for example, the user reaching significant spatial positions, or by using significant spatial gestures. Electrical and or chemical brain signals may also be means by which an output threshold may be met. If an output does not meet an output threshold, then the device and user returns to the start 701 of the process.

At step 704, the device may produce output. Output from the device, 704. may include feedback via audio, text, data, haptics, forces, smells, or other means. Haptic feedback may be substituted or augmented with other forms of feedback in different embodiments. Output 704 may result in communication with a third party, interaction from the user to his/herself, and communication from the device to the user as a tool to use the device, communication from the environment creating output as the resulting process initialized by a user's interaction and device output leading the environment to respond the output (including but not limited to third parties, and non-living objects).

At step 705 the process may determine if a sequence has been completed. A sequence may be for example a set of phonetic sounds, a text message, one or more words, a phrase, a musical note, a musical tune, code, shorthand etc. The process determines whether the user has completed a sequence at step 705. If yes, then the process may then proceed to end 705. If the user has not completed a sequence, the process may loop back to start 701. As the user goes through the process again, the sequence may potentially build from the prior process output.

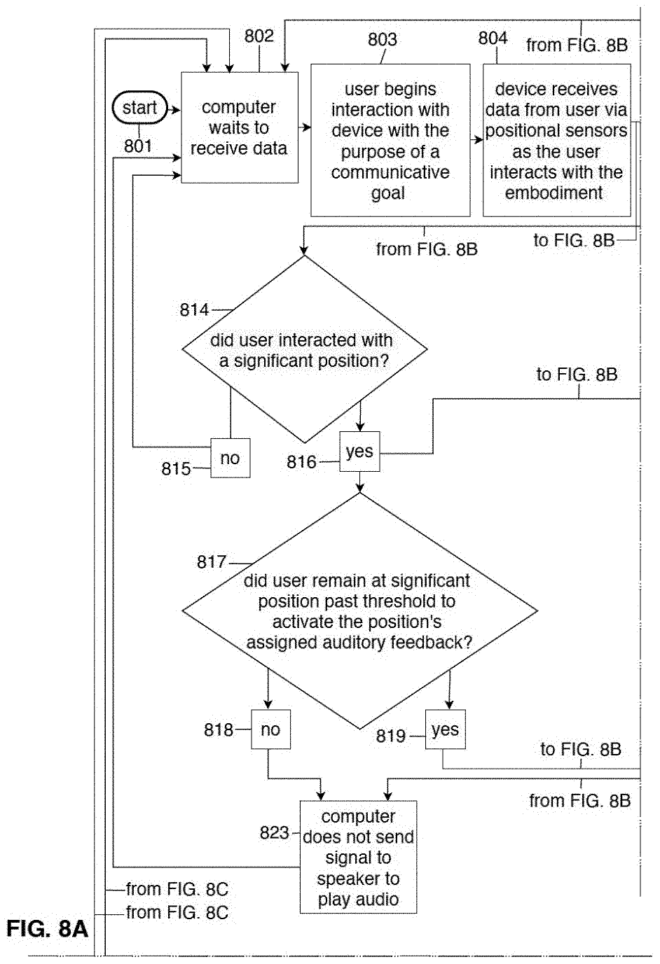

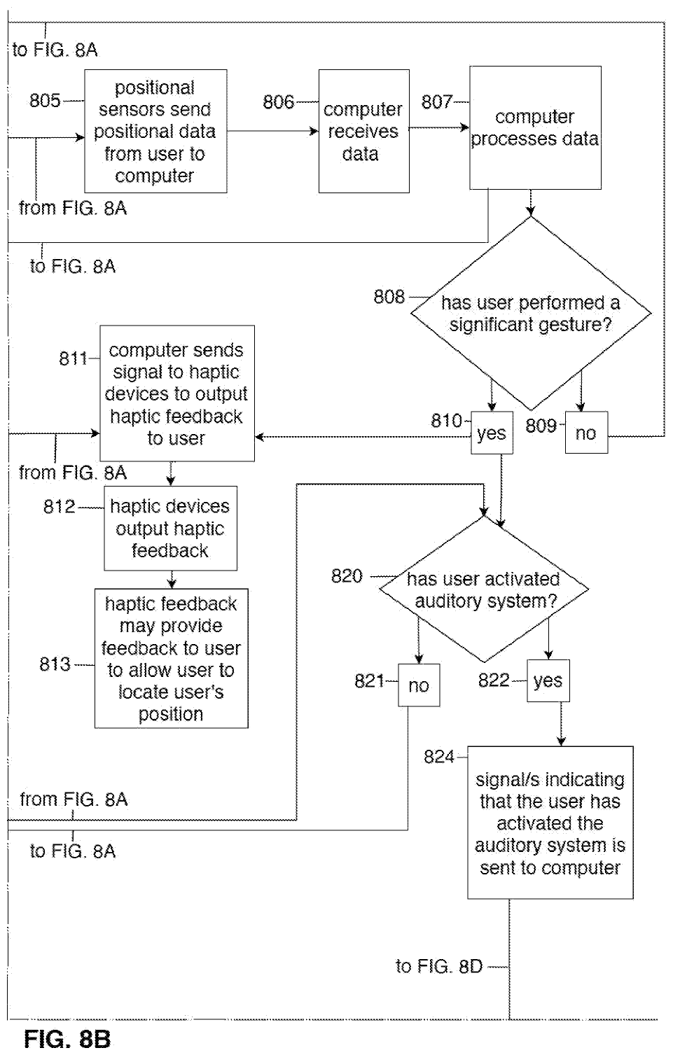

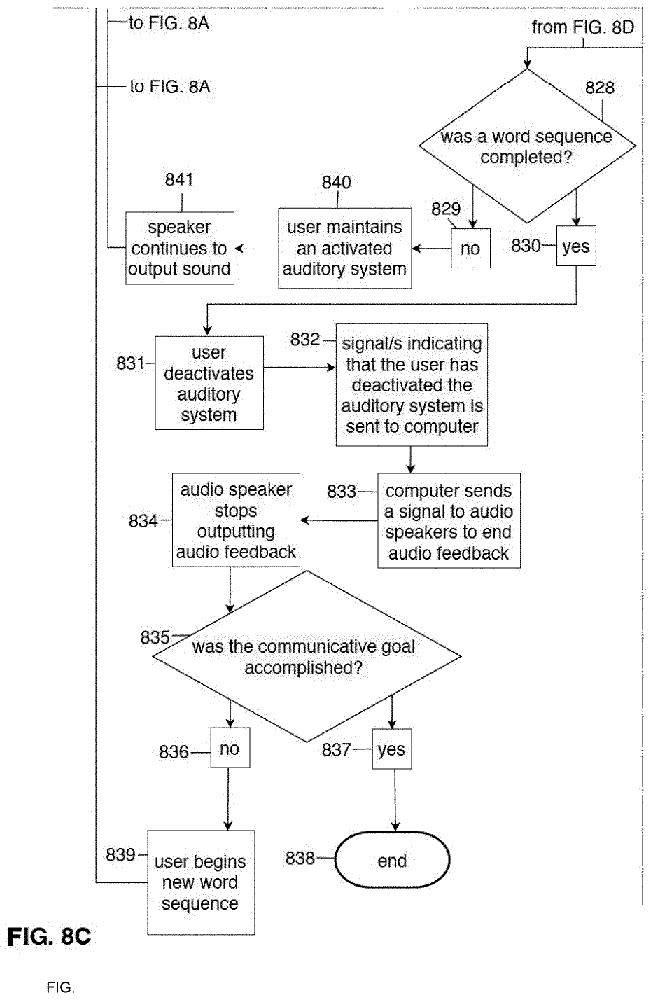

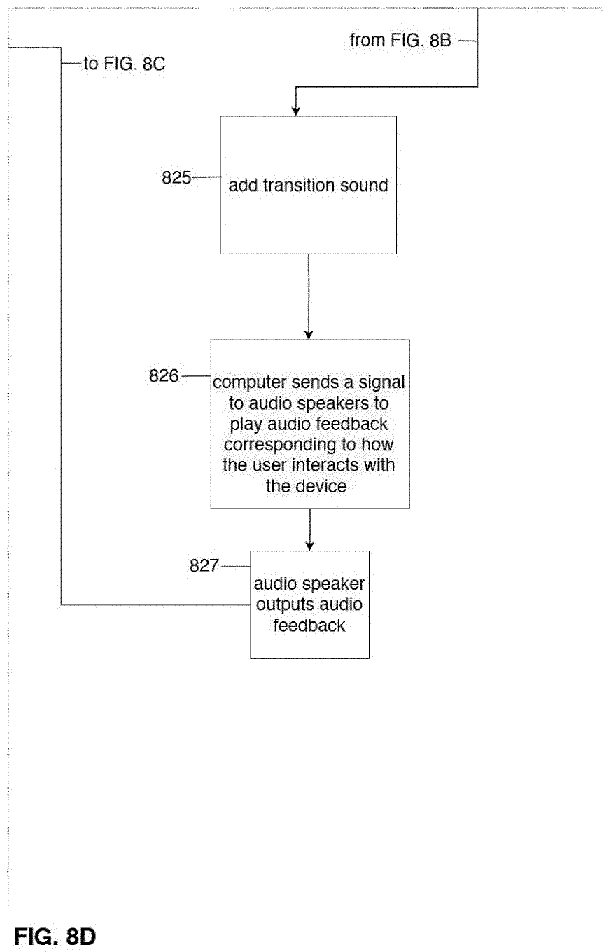

FIGS. 8A-D illustrate a process describing conceptually an embodiment of the invention where a user may use a device with a computer, haptic feedback devices, auditory feedback devices such as but not limited to speakers, positional sensors, etc. to construct, send, and/or receive communications via the device by reaching significant spatial positions or by using significant gestures. This embodiment may also describe the underlying functions of a neural implant that may communicate with a brain via chemical and/or electric signals. These steps are exemplary and may change in order and content with different embodiments of the invention.

The process of building a communicative sequence begins at 801. The starting point 801 may occur before a user attempts a communication goal, and the device is set up and active. A communication goal may be a sound, a phonetic sequence, a word made up of one or more phonetic sounds, multiple words, a sentence, multiple sentences, a code, tones, music, shorthand communication etc. The figure describes audio feedback, but feedback may also be given via text, data, haptics, forces, smells, or other means. Haptic feedback may be substituted or augmented with other forms of feedback in different embodiments.

At step 802, a computer may wait to receive data. In some embodiments, the computer may be a server, a standard computer, a virtualized computer, a microcontroller, or other logic processors. The computer also be a software, such as a computer program, an artificial intelligence, or other machine learning algorithm. An organic computer constructed of neural cells may also be used. A computer may be attached to a user, not attached to a user, attached to the device, located in a different location from the device, etc. There may be one or more computers. Data may be input from the user's interactions with the device such as but not limited to positional sensor data that derives from user interaction with the device. Data may be inputted using one or more wired or wireless connections.

At step 803, a user may begin interacting with the device with the purpose of a communicative goal. Interactions may include but are not limited to: physical motion of the user who is wearing the device; physical motion or gestures that a physical device a user is not wearing reads, such as a video camera with computer vision capabilities, or other outside tracking sensors; chemical and/or electrical signals from the brain in which a neural implant may sense; etc.

At step 804, the user's interactions may create input into one or more positional sensors. In other embodiments, other sensors and/or devices that may receive data input.

At step 805, the one or more positional sensors may have received the data inputted by the user and send the data to the computer. The data may be sent using one or more wired or wireless connections.

At step 806, the computer may receive the data from the positional sensors that the user initially inputted into the device. For example: in a non-limiting harness embodiment a user may initially input data into the positional sensors by move his/her head around while the positional sensors such as but not limited to gyroscopic accelerometers track the movement and position. The data may be collected and sent to the computer.

At step 807, the computer may process data received by the positional sensors. The computer organizes and interprets the data to determine if the input from the user has met a threshold. The threshold may be set in advance of the process, or it may be varied during the process. When that threshold is met, the computer many send a signal out to haptic sensors and/or the speaker or other device. The computer may determine what type of signal would be sent. The process may proceed to both steps 808 or 814, or it may proceed to both steps.

At step 808, the computer may interpret the data to determine if the user's input has met the threshold for the parameters that would be necessary for that user to have performed a significant gesture. If the computer has determined that the user had not, then the process may proceed to step 809 which would indicate “no.” In this case, the computer would not send out any signal to any other devices, and the process may loop back to step 802, and the computer may wait to receive data from the user. If the user's input has met the threshold for the parameters that would be necessary for the user to have performed a significant gesture, then the process may proceed to step 810, which would indicate “yes.” If “yes,” the user has performed a significant gesture, and the process may proceed to step 811 and step 820. In other embodiments, step 810 may instead progress directly to step 825 or step 826. In other embodiments, a user making one or more significant gestures may have audio automatically play whenever a significant gesture is performed.

In step 811, the computer may send one or more signals to haptic devices to output haptic feedback to a user. This could be embodied in various non-limiting ways such as haptic feedback devices on a harness embodiment, neural feedback via a neural implant that would feel like haptic feedback by the user, etc. In step 812, the haptic devices may output haptic feedback to the user. The haptic feedback that the haptic devices may output may be varied based on the type of haptic feedback the device has been instructed to release. Haptic feedback may have one or more variations that may be felt and distinguished from one another by the user.

In step 813, haptic feedback felt by the user may provide the user with a way of locating his or her position and/or orientation within the space the user is interacting and the user's relative position to various significant gestures and/or positions.

At step 814, the computer may interpret the data to determine if the user's input has met the threshold for the parameters that would be necessary for that user to have interacted with a significant position. If the computer has determined that the user has not met the threshold, the process may proceed to step 815 which would indicate “no.” Then the computer would not send out any signal to any other devices, and the process may loop back to step 802 where computer may wait to receive data from the user. If the user's input has met the threshold for the parameters that would be necessary for the user to have interacted with a significant position (and/or region), the process may proceed to step 816 which would indicate “yes.” If “yes,” the user has interacted with a significant position, and the computer may proceed to step 811, described above, and step 817.

In step 817, the computer may determine if the user has remained at a significant position past the threshold to activate the position's assigned auditory feedback. In a non-limiting embodiment, a user may pass through significant positions without activating their auditory feedback but still activating haptic feedback. This may allow a user to feel when he or she has interacted with significant positions without those significant positions necessarily activating auditory feedback. The user may orient within and travel through the significant position space and make deliberate selections of significant positions from which he or she wishes to activate audio feedback. If the computer has determined that the user has not remained at a significant position past the threshold to activate a position's assigned auditory feedback, the process may proceed to step 818 which would indicate “no.” The computer may not send out any signal/s to the audio speakers, and the process may loop back to step 802 where the computer may wait to receive data from the user. If the user's input has met the threshold for the parameters that would be necessary for the user to have interacted with a significant position (and/or region) and activated the position's assigned auditory feedback, the process may proceed to step 819 which would indicate “yes.” If “yes,” the computer may determine that a user has deliberately interacted with a significant position and proceed to step 820 where the computer may determine whether the user had activated the auditory system. There are numerous ways a user may activate and/or deactivate an auditory system. For example: the device may have sensors that may determine if the user has activated the auditory system. In a non-limiting dog harness embodiment where the user is a dog, a dog may open his or her mouth to activate the auditory system and close his or her mouth to deactivate the auditory system. When using a non-limiting harness embodiment where the user is a dog, a dog may open his or her mouth and trigger a sensor that determines that the dog's mouth has been opened. When the dog activates a significant position while his or her mouth is open, the computer may receive a signal that the mouth is open and the process may proceed so that a signal is sent to the audio speakers to play the audio assigned to the significant position with which the dog has interacted. When the dog's mouth is closed, the computer may receive a signal that the dog's mouth is closed and the audio system is deactivated. The computer will then not send a signal to the audio speakers even if the dog interacts with a significant position (though haptic feedback may be outputted). Another example may include but are not limited certain electrical signals sent from the brain that are sent to a neural implant and a computer to indicate if an auditory system is activated or deactivated. If the user has not activated the auditory system, the process may proceed to step 821 which would indicate “no.” The computer may not send out any signal/s to the audio speakers, and the process may loop back to step 802 where the computer may wait to receive data from the user. If the user has activated the auditory system, the process may proceed to step 822 which would indicate “yes.”

If a user has activated the auditory system as is indicated in step 822, the process may proceed to step 824 and one or more signals indicating that the user has activated the auditory system is sent to a computer. After a signal is sent to the computer indicating that the user has activated the auditory system as shown in step 824, the computer may determine in step 825 if the user is adding sound input to an existing sequence and/or if the first sequence consists of multiple sounds, and if so the computer may determine if one or more transitional sound are added between the old and new sound sequence and what transitional sound would are added. In a non-limiting harness embodiment, a dog may produce a single vowel sound. In that example, there is no transitional sound needed. In such a case, the process may proceed to step 826 without adding a transitional sound. In another example with the same harness embodiment, a dog may produce a sound that contains both a consonant and a vowel simultaneously by taking a significant position that combines a vowel and a consonant significant position at the same time. When both significant consonant and vowel positions are activated, the audio from the consonant may play first, followed by the vowel sound. At step 825, a transition sound may be played between the consonant and vowel sounds to mimic the transitional sounds that the human mouth makes when producing a specific consonant sound followed by a specific vowel sound. Thus, at step 826, the computer may signal that both the transition sound and the sound corresponding to the significant spatial position may be played.

As another example, where no transition sound may be played, such as at the start of a sequence, the process at step 825 may not add a transition sound. After producing a sound as described in steps 827, 828, 840, 841, the user may keep the audio system activated and return to step 802. The user may proceed through the various steps until the process returns to step 825, where the computer may determine that a transition sound occurs between the earlier and the current sound. The user may keep adding sequences through this process to construct longer and more complex sound sequences, and the computer may continue to add transitional sounds in between the sequences. In other non-limiting embodiments, significant gestures may also combine in building sequences and may also use transitional sounds if needed.

After step 825, the process may proceed to step 826 in which a computer sends a signal to the audio speaker to play audio feedback corresponding to how the user has interacted with the device. At this point, the computer has received positional data from the user, determined that a significant gesture or a significant position has been reached and what audio files correspond. Significant position and or gestures may be assigned different values, parameters, positional values, speed values, directional values, audio files, etc. The audio system may receive the signal from the computer and may output audio feedback in step 827.

The process may proceed to step 828, where the user, a trainer, and/or the computer may if a word sequence was completed. In some embodiments, a word sequence may be replaced with a sound sequence or other communicative unit. If a word sequence was not completed and more sound sequences are needed, the process may proceed to step 829 indicates “no.” Next, in step 840, the user may maintain an activated auditory system to maintain the sequence so the sequence is not ended by the auditory system being shut down, and so the sequence can continue to build. The user may choose to continue to output sound from the sequence the user just activated, as the sound from the last activated sequence played by the user may continue to play until the user deliberately deactivates the sound. The process continues to step 841, where the computer continues to direct the speaker to output the sound. The process may return to step 802 where the computer waits to receive more interaction from the user to build on the sequence already outputted.

If in step 828 the user, a trainer, and/or the computer determines that a word sequence is completed, the process may proceed to step 830 indicating “yes.” The process may proceed to step 831, where the user deactivates the auditory system, ending the word sequence. If the user ends the auditory system and then interacts with the process again, a sequence will start from the beginning and may not be building on past sequences. In a non-limiting harness example where the user is a dog, a dog may close his or her mouth to deactivate the auditory system. Any sound that may have been playing will stop playing, and if the dog interacts with a significant position or makes a significant gesture, then sound may not play until the dog opens his or her mouth again and reactivates the auditory system.

In step 832, the deactivation of the auditory system may be signaled to the computer. In step 833, the computer may send a signal to the audio speakers to end audio feedback. Next, in step 834, the audio speaker may stop outputting audio feedback. The user, a trainer, and/or the computer may determine in step 835 if the communicative goal was accomplished. A communicative goal may include but may not be limited to music, a word, a sentence, a shorthand communication, a code etc., that provides enough meaning for the user to communicate as desired. In a non-limiting embodiment using a harness where the user is a dog, a dog may wish to greet a human and output the sequence “hi.” The goal may be accomplished with one released phonetic sequence. But some goals may need longer words containing multiple phonetic sequence like “food,” or multiple words: “where mom?,” or multiple sentences: “foot hurt, where mom?” If the communicative goal is determined to be accomplished, the process may proceed to step 837 indicating “yes.” The process may proceed to step 838 which indicates that the communication has completed and ended. If the process proceeds to step 836 indicating “no,” the communicative goal was not accomplished, including, for example, where a single word was not enough to accomplish the communicative goal, the process may proceed to 839 wherein the user begins a new word sequence. The process may loop back to step 802. The user may continue the process to build towards his or her communicative goal, repeating the various steps of FIGS. 8A-D until the communicative goal is accomplished.

### 1. Phonetic Space Organizational System (“PSOS”) Embodiments

A nonlimiting embodiment of the present invention involves the use of a phonetic based system, methods, and/or devices, which may be henceforth referred to as the “Phonetic Space Organizational System” (herein referred to as “PSOS”). A non-limiting embodiment using the PSOS may allow the user to use goal-directed gestures to reach significant spatial positions that correspond with elements composing speech. For example, the user may make goal-directed gestures, including to reach significant spatial positions, towards articulatory goals to phonetically construct words or other communicative sounds. The physical or conceptual space of PSOS may be populated by phonetic sounds used in the IPA chart recognized in the field of linguistics.

In some nonlimiting embodiments, the significant spatial positions are a novel and alternative way to achieve function analogous to the “place of articulation” and the “manner of articulation.” For example, in a human, an active articulator may be the human tongue (because it is active and moves). A passive articulator may include the front teeth (because they do not move). But instead of only organic articulators, embodiments of this invention may combine both organic articulators (including those not traditionally used for articulation, such as a dog's snout) and artificial devices, systems, or methods as described further herein. As a non-limiting example, where a dog's nose moves into a position that has been assigned a specific phonetic sound, the apparatus may play the sound corresponding to that position and phonetic sound. In this embodiment, the resulting speech, sounds, and other forms of communication and/or information transfer are produced not by the unique vibrations and movement of a human tongue in the organic human instrument, but instead by the described apparatus.

Thus, a further novelty of the invention, as reflected in some embodiments, is that the complicated gestures and movements of the human mouth that produce different sound waves may be simplified by the methods, devices, and systems of this invention. For example, instead of pressing the tongue in the back of the mouth to produce the sound “K,” the device may simply note when a significant spatial position has been reached by the movements of the dog's head and then play the sound that was prerecorded (and/or produced by software) via a speaker or other sound production device. As another example, embodiments of the invention simplify the production of sound by using a prerecorded sound of B or “buh” instead of going through the process of physically producing a sound like a human traditionally does, where the lips press together and puff air out while the vocal cords vibrate to produce the sound B or “buh.”

In some nonlimiting embodiments, sounds from the IPA may be used to populate physical and/or conceptual significant spatial positions. For example, the Handbook of the International Phonetic Association exemplifies and illustrates the use of each of the phonetic symbols comprising the IPA. Extensions to this Handbook further cover speech sounds that go beyond the sound systems of languages, such as those with paralinguistic functions (e.g., the volume, speed, intonation of a voice along with gestures and other non-verbal cues) and in pathological speech (e.g., speech disorders). The Handbook also provides internationally agreed computer codings for phonetic symbols. The International Phonetic Association provides the IPA chart, which has most recently revised in 2020. The Handbook and IPA chart are incorporated by reference herein in their entirety.

In some embodiments of the present invention, the sounds that may be assigned to significant spatial positions may correspond to symbols within the IPA chart. When a symbol from the IPA is assigned to a significant spatial location, the corresponding sound that the IPA chart references may also be assigned to that significant spatial position (and vice versa). When significant spatial positions are held, interacted with, and or activated, the assigned sounds may be played audibly in some non-limiting embodiments.

Introduced herein is a term called “Phonetic Space.” A Phonetic Space may refer to a physical and/or conceptual space that may be accessed by systems, methods, and devices disclosed herein. The Phonetic Space may be populated by significant spatial positions where the dog may activate phonetic or other sounds. The embodiment described in FIGS. 1A and 2A are possible organizations of a Phonetic Space, but other embodiments using other ways of organization are evident from this description.

In linguistics, human phonetic sounds are organized by the phonetic alphabet into the categories of vowels and consonants. Introduced herein are the terms “Consonant Phonetic Space” and the “Vowel Phonetic Space.” The Consonant Phonetic Space and Vowel Phonetic Space may contain physical and/or conceptual positions, referring in particular to the positions in Phonetic Space corresponding to consonants and vowels respectively.

Consonants sounds that may be assigned (from the sounds in the phonetic alphabet) in the Consonant Phonetic Space may be referred to a “Significant Consonant Phonetic Position” (or “SCPP”). The neutral angle, where the dog's face, neck, and snout/nose are all facing directly forward neutrally which hereinafter will be described as the “Neutral Consonant Position.” At this position, if the dog were to open its mouth, no consonant sound may play. This may allow the dog to start sound sequences with Significant Vowel Phonetic Positions (or “SVPP”).

The Vowel Phonetic Space may be accessed by a series of significant spatial positions. Vowel sounds that may be assigned (from the sounds in the vowel section of the phonetic alphabet) in the Vowel Phonetic Space may be referred to as “Significant Vowel Phonetic Positions” (or “SVPP”).

Using these various systems, the user may create various phonetic sounds by combining the above listed positions. Furthermore, various embodiments PSOS may contain one or more additional features, systems, methods, and devices, including without limitation:

Significant spatial position detection systems or features, such as sensors that detect the location, orientation, and movement of a user or of an appendage of the user.

Physical feedback systems or features, including vibrations produced by haptic motors.

Biosensing systems or features, including temperature and heartrate monitors.

Scent systems or features, such as scent feedback.

Taste systems or features, such as taste feedback.

Neural systems or features, including neural feedback through the use of brain implants.

Auditory systems or features, which in some embodiments may provide auditory feedback to the user.

Consonant systems or features, including the assignment of significant spatial positions that are directed to the production of consonant sounds.

Vowel systems or features, including the assignment of significant spatial positions that are directed to the production of consonant sounds.

Neutral systems or features, which many include the assignment of significant spatial positions that produce no sound and/or that silence the production of a currently playing phonetic sound.

Transition systems or features, which may include sounds that are produced as the system and/or user transitions from one significant spatial position to another.

Activation and deactivation systems or features, which may include gestures that turn or off the other features of the system.

Intonation, pitch, and other systems or features directed to reproducing the various nuances of language.

These one or more systems or features that may be included in embodiments of this invention using PSOS may be further described throughout the present disclosures and in the drawings and descriptions of the drawings.

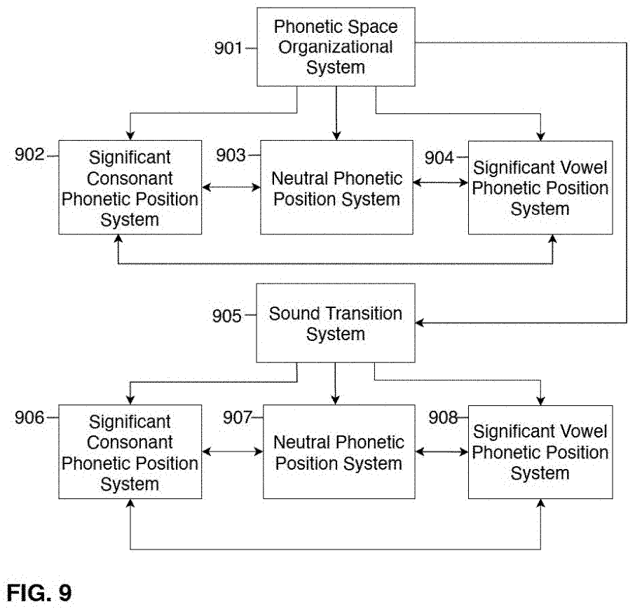

FIG. 9 is a flowchart illustrating an embodiment of the invention that uses the Phonetic Space Organizational System 901. The Phonetic Space Organizational System (“PSOS”) is an organization of phonetic and transitional sounds that may be accessed through goal directed gestures made by a user to reach significant spatial positions that correspond with elements composing speech. PSOS is populated by a variety of sounds including phonetic and transitional sounds. The phonetic sounds may be populated from the IPA chart recognized in the field of linguistics. Phonetic sounds from the IPA chart are broadly separated into two large categories: vowels and consonants.

The Phonetic Space Organizational System may include the following subsystems: the Significant Consonant Phonetic Position System 902, the Neutral Phonetic Position System 903, the Significant Vowel Phonetic Position System 904, and the Sound Transition System 905.

The Significant Consonant Phonetic Position System 902 may be populated by various consonant sounds that are assigned significant spatial and/or conceptual positions and/or gestures. When a user interacts with a significant consonant gesture, and/or significant spatial and/or conceptual consonant position via an embodiment of the device such as a non-limiting harness embodiment, the audio output, text output, or other form of output, may correspond with the assigned phonetic consonant.

The Significant Vowel Phonetic Position System 904 may be populated by various vowel sounds that are assigned significant spatial and/or conceptual positions and/or gestures. When a user interacts with a significant vowel gesture, and or significant spatial and or conceptual vowel position via an embodiment of the device such as a non-limiting harness embodiment, the audio output, text output, or other form of output, may correspond with the assigned phonetic vowel sound.

The Neutral Phonetic Position System 903 may be populated by no sound. Neutral Phonetic Positions are places where no sound is assigned or played out when a user does a significant gesture and or interacts with a significant position that is part of the Neutral Phonetic Position System. There are neutral vowel and neutral consonant positions. In a neutral vowel position no vowel positions may be activated but consonant sounds may be activated. In a neutral consonant position, no significant consonant positions may be activated but significant vowel positions may be activated.

In some non-limiting embodiments, when a significant spatial consonant position and a significant spatial vowel position are simultaneously interacted with, both sounds may play. The consonant sound may play first, followed by a transition sound and then the vowel sound. But it does not allow a single vowel or single consonant to be activated. Neutral positions may allow single consonant and or single vowel sounds to be activated individually.

Transitional sounds are sounds that may transition between two phonetic sounds. Phonetic sounds played directly one after another may sound robotic and not like human speech. This is because human mouths do not flip directly from one sound to another like flipping between two photographs. The lips, tongue, and mouth form the shape to make an initial sound, and then another added sound is formed by the lips, tongue, and mouth changing shape until reaching the shape that creates the second sound. The subtle change in the shape of an organic oral language instrument as it moves from one target sound to the next is the source of transition sounds. Without transition sounds between phonetic sounds, the resulting playback of phonetic sounds may not sound like natural speech.

In non-limiting embodiments, computers may have lists or databases of assigned phonetic sounds. For example, a list may include the phonetic sound with an audio file of the sound by itself without surrounding phonetic sounds. A list may also include a phonetic sound with a transition sound included before the phonetic sound, creating a transition sound phonetic sound sequence. There may be numerous variations of transition sounds phonetic sound sequences with the same phonetic sound ending each sequence. The different variations may correspond to different phonetic sounds that may play beforehand. A user may activate a significant position and play a sound, then move to a second phonetic sound in a continuous sequence. Based on what sound was initially played, the computer may select the variation of the second sound containing the transition sound that corresponds to the first sound that was played.

Transition sounds may differ depending on the surrounding circumstances in which the Significant Consonant Phonetic Positions System 906, the Neutral Phonetic Positions System 907, and the Significant Vowel Phonetic Position System 908 interact.

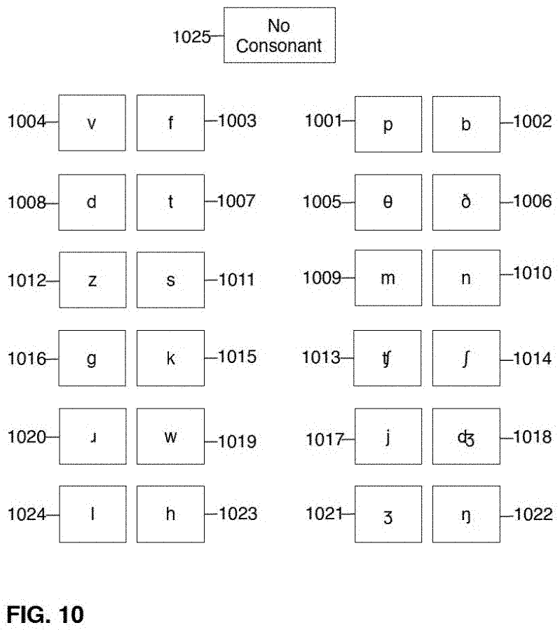

FIG. 10 illustrates conceptually an embodiment of the invention wherein significant consonant spatial and/or conceptual positions and or gestures may be organized to be accessible to a user through a device and/or system. Boxes 1001-1024 represent an arrangement of consonants from the IPA chart that are commonly used in the American English Language. In some embodiments, these consonants may be greater in number to include additional consonants, fewer in number to remove one or more consonants, or rearranged. In some embodiments, boxes 1001-1024 may include vowels, words, sentences, codes, voiced and or unvoiced phonetic sounds, tones, or other forms of communication or variations of phonetics.

The “No Consonant” at box 1025 may represent one or more neutral consonant positions. Neutral consonant positions may allow other non-consonant sounds to activate individually. In some non-limiting embodiments, the same significant consonant positions may activate multiple assigned consonant sounds with differing circumstances. For example, where a harness embodiment is used, a user such as a dog may open his or her mouth slightly to activate a significant consonant position such as a significant consonant position corresponding to consonant 1003. The dog may open his or her mouth wider to activate a second significant consonant position such as a significant spatial position corresponding to consonant 1004.

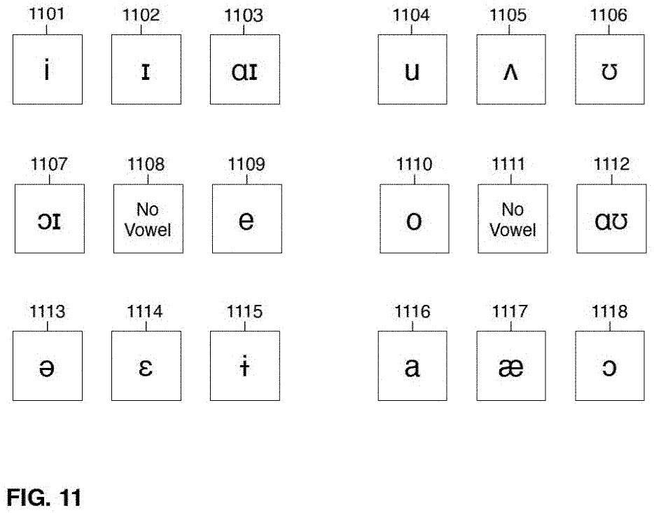

FIG. 11 illustrates conceptually an embodiment of the invention wherein significant vowel spatial and/or conceptual positions and/or gestures may be organized to be accessible to a user through a device and/or system. Boxes 1101-1118 represent an arrangement of vowels from the IPA chart that are commonly used in the American English Language. In some embodiments, these vowels may be greater in number to include additional vowels, fewer in number to remove one or more vowels, or rearranged. In some embodiments, the boxes may represent consonants, words, sentences, codes, tones, data, or other forms of communication, such as sounds, text messages, music, etc. The “No Vowel” boxes 1108 and 1111 may each represent one or more neutral vowel positions. Neutral vowel positions may allow non-vowel sounds to activate individually.

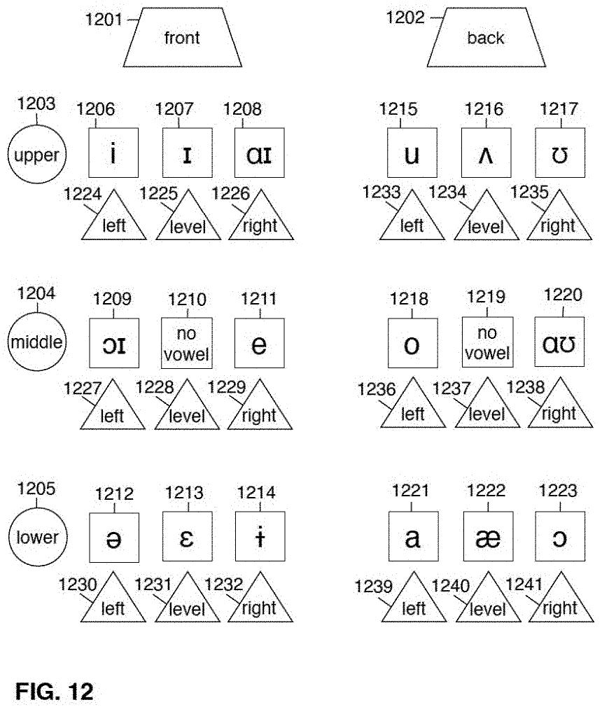

FIG. 12 illustrates an embodiment of the invention wherein vowels are conceptually arranged in certain locations and/or positions. Boxes 1206-1223 represent vowels from the IPA chart that are commonly used in the American English Language. In some embodiments, these vowels may be larger in number to include additional vowels, fewer in number to remove some vowels, or rearranged. In some embodiments, the boxes may represent consonants, words, sentences, codes, tones, data, or other forms of communication, such as sounds, text messages, music, etc. As illustrated, trapezoids 1201 and 1202, circles 1203-1205, and triangles 1224-1241 represent significant spatial positions and/or gestures. Boxes 1206-1223 are oriented in a tabular-like format illustrating conceptually their arrangement into certain positions represented by trapezoids 1201 and 1202, circles 1203-1205, and triangles 1224-1241. For example, in some embodiments, box 1206 representing the vowel “i” may be addressed where the user has oriented his or her head in all of the “front,” “upper,” and “left” positions. Significant positions may be reclassified in any number of ways, including by specifying different names describing alternative positions, or by using numerical references such as coordinates or degrees. In some embodiments, the significant positions and/or significant gestures may be rearranged. In addition, the significant positions and/or gestures may be increased or decreased in number or types.

Trapezoids 1201 and 1202 represent “front” and “back” locations respectively. In some embodiments, positions “front” and “back” may refer to the position of the user's head in three-dimensional space relative to the user's body. As illustrated, boxes 1206-1214 representing vowels may be addressed in the “front” position, and boxes 1215-1223 represent certain vowels that may be addressed in the “back” position.

Circles 1203, 1204, and 1205 represent “upper,” “middle,” and “lower” positions respectively. In some embodiments, “upper,” “middle,” and “lower” refer to the orientation of the user's gaze relative to the ground, i.e., whether that gaze is raised above the horizon, towards the horizon, or towards the ground, respectively. Boxes 1206, 1207, 1208, 1215, 1216, and 1217 represent certain vowels that may be addressed in the “upper” position. Boxes 1209, 1210, 1211, 1218, 1219, and 1220 represent certain vowels that may be addressed in the “middle” position. Boxes 1212, 1213, 1214, 1221, 1222, and 1223 may be addressed in the “lower” position.

Triangles 1224, 1227, 1230, 1233, 1236, and 1239 represent “left” positions. Triangles 1225, 1228, 1231, 1234, 1237, and 1240 represent “level” positions. Triangles 1226, 1229, 1232, 1235, 1238, and 1241 represent “right” positions. In some embodiments, triangles 1224-1241 may correspond to the tilt of the user's head “left” to “right” relative to a straight or “level” posture. For example, where a user's head tilts towards his or her right shoulder past a certain threshold, that user's head may be considered to be in a “right” position, and the user may address those vowel sounds that correspond to that position.

### 2. Exemplary Devices and Components

The systems, devices, and methods of the invention may be implemented using a variety of devices, such as one or more harnesses, vests, jackets, collars, gloves, bracelets, rings, watches, wearables, dog tags, lightboxes, headsets, base stations, etc. A device may comprise electronic components, including sensors, computer processors, microcontrollers, battery and power, wiring, electrical connectors, etc. A device may comprise physical components, such as fabric, plastic housing, handles, buckles, straps, stitching, glue, etc. The descriptions made in detail below are examples of implementations of electronic and physical components and are not intended to limit the use of electronic or physical components to any embodiment, or to the specific implementations of electronic components in any embodiments described below. Indeed, a person of skill in the art will understand that any electronic or physical components may be used for the purposes of the invention in various, alternative configurations and in different embodiments.

### 2.1. Exemplary Electronic Components

A device may comprise electronic components. One or more electronic components may comprise a housing, such as a casing made from plastic, metal, fabric, etc. that encloses the electronic components. Electronic components may be attached to the device with releasable attachments or permanent attachments. Examples of releasable attachments include using Velcro attachments to secure an electronic component to the harness. Examples of permanent attachments include stitching, glue, epoxy, and sealed fabric enclosures. Electronic components may be embedded in the device, including in between or underneath one or more layers of fabric. Wire harnesses affixed or embedded in a device may be used for integrating electronic wiring. Electronic components may be contained in one or more sealed enclosures. Such enclosures may be proofed against air, water, dust, vibration, etc.

A variety of sensors may be used to implement or perform the invention, including but not limited to one or more gyroscopic sensors, temperature sensors, infrared sensors, ultrasonic sensors, touch sensors, proximity sensors, position sensors, radar sensors, pressure sensors, level sensors, vision and/or imaging sensors, radiation sensors, force sensors, electronic sensors, contact sensors, motion sensors, photoelectric sensors, tilt sensors, smoke and gas sensors, humidity sensors, color sensors, acoustic sensors, accelerometers, speed sensors, encoders, flex sensors, angular rate sensors, shock detectors, ultra-wideband radar, magnetic sensors, magnetometers, Hall effect sensors, heart rate sensors, respiration rate, blood sugar sensors, light detection and ranging (LiDAR), time of flight, ambient light sensors, bioimpedance sensors, compass, ECG sensors, gesture sensors, ultraviolet radiation sensors, electrodermal sensors, potentiometers, rain sensors, sound sensors, microphones, flex sensor, load cells, passive infrared (PIR) sensors, chemical sensors, RFID sensors, GPS sensors, biometric sensors, vibration sensors, pedometers, piezo film sensors, etc.

In some embodiments, sensors that can detect at least six degrees of freedom (“DOF”) of the orientation of the user's head, such as rotational, translational, or positional sensors may be attached to or included in the device. The sensors may be used to track the orientation and position of the user's head and/or snout (such as roll, pitch, yaw, magnitude and direction of acceleration, and absolute and/or relative position in three-dimensional space, and others), the user's movement, or the user's position. Any type of sensor may be used, including for example, inertial measuring units (“IMUs”), gyroscopic sensors, accelerometers, magnetometers, GPS sensors, radar, encoders, lighthouse-based tracking, acoustic trackers, wireless triangulation, optical tracking, hall switch sensors, etc. An accelerometer and magnetometer may be used together to obtain both the inclination and azimuth of the user's head and/or snout.

One or more haptic feedback devices may be included on the device or placed on the user. The haptic feedback devices may produce haptic feedback such as various degrees of vibration or tapping sensations that may be sensed by the user, including when the user reaches a significant spatial position which may be assigned a sound from the phonetic alphabet, as described further herein. An accelerometer may be used to measure vibration to confirm the use of the haptic feedback devices. One or more force feedback components may be included, such as for example those that may mimic the tug of a leash or that may constrict and unconstrict areas of a device such as a harness over the user.

A processor may control the capturing of input, including data from one or more sensors. A processor may also control output, including the transfer of data or other information. A processor may comprise a logic module. A variety of microcontrollers or computer processors may be used to implement or perform the invention. For example, a system on a chip (SoC) may be used, and such SoC may include one or more: processors, random access memory (RAM), read only memory (ROM), flash memory, input/output ports, analog to digital converter, and/or oscillator for timing. The microcontroller structure may include a data bus, address bus, control bus, and/or instruction bus. Voltage may be supplied that provides power to the microcontroller. As another example, conventional computer hardware may be used, such as a computer processor, graphics processors, computer motherboard, RAM, storage, power supply, etc. An application specific integrated chip (ASIC) may be used. Additional modules or daughter boards may be included, including without limitation one or more: graphics adapters, expanded memory, RAID board, Bluetooth board, WIFI board, UHF or VHF board, Near Field Communications (NFC) board, modem board, network board, serial ATA board, speech or voice synthesizer, etc. Processing may also be performed externally using a server locally or over the Internet.

Computer hardware for storing and/or transferring information may be used. For example, flash storage, external storage, optical storage, input/output ports, physical layer (PHY) interface, fiber optic communication, memory card, etc. may be used to store or transfer information. Exemplary memory cards include Secure Digital (“SD”), microSD, and CFexpress memory cards. A card reader or optical drive may be included to transfer or retrieve information from removable media, including to copy or move information from the removable media to fixed storage. Exemplary input/output ports include USB, Thunderbolt, and Ethernet. A dedicated hardware bus for transferring information may be included, including using one or more interfaces supporting the PCI Express, IEEE, or MIPI (Mobile Industry Processor Interface) standards.

One or more batteries may be provided as a power source for the device and/or the various components included on the device. Examples of batteries include alkaline, lithium, or silver oxide batteries. A battery may be rechargeable, including nickel-cadmium, nickel-metal hydride, nickel-zinc, and lithium-ion polymer, or lithium-ion batteries. A harness may include battery charging components, including a charging port and charging circuitry, for charging the battery. Battery charging components may also be used to power the device from an external power source rather than from an internal battery. In some embodiments, power may be provided by connecting the device to an external outlet. Components may be included to transform the input alternating current to a direct current and/or to reduce voltage. Power may also be provided from capacitors. Power may be provided by other means, such as using heat exchange from the user's body, extraction of power from the motion of the user, and/or solar power including using solar cells, etc.

A device may include one or more components directed to the production and/or recording of sound, including without limitation speakers, PC speakers, sound generator chips, microphones, digital to analog converters, amplifiers, and sound cards. Audio playback may be synthesized or from prerecorded sounds. Sound hardware may be capable of playback and/or recording any audio codecs, including without limitation MP3, WAV, AAC, ALAC, aptX, FLAC, Ogg Vorbis, or WMA.

A device may include one or more components capable of wireless communications, including without limitation components for: WIFI, Bluetooth, BLE, near field communication (“NFC”), UHF, VHF, radio, ultrawideband, satellite, ZigBee, WiMAX, and cellular.

Various input buttons or interfaces may be included on the device, such as one or more buttons, switches, knobs, encoders, touchpads, joysticks, trackpads, pointing sticks, or trackballs. Trackpads may use capacitive sensing or be resistive. In some embodiments, an “on off” switch may be included. In other embodiments, logic may be incorporated to automate power on and power off based on use of the device.

Lights or LEDs may be included on the device that may provide visual indication of status. For example, an LED indicator may provide information on power state, battery level, error state, function of the computer hardware, etc. A device may also include one or more displays or screens. A display may display information, including concerning for example the status of the harness and electronic components, including battery or power status, logic status, user training information, usage statistics, or debugging. Any display technology may be used, including for example e-ink, e-paper, OLED, PMOLED, AMOLED, TFT, LED, QLED, mini LED, micro LED, CRT, laser, or projection. Displays may be static, low refresh rate, high refresh rate, or variable refresh rate. Displays may be any size, resolution, pixel density, and aspect ratio. Displays may be touch enabled, including resistive or capacitive sensing. Displays may provide for digital pen input, including by implementing a WACOM layer, conductive screen, surface acoustic wave, or infrared touch.

A device may also include one or more cameras or other components that may be used to capture images and/or video. Such cameras may be used to supplement sensors to track position and/or motion. In addition, cameras may be used to interact with the user or track the user's environment.

In some embodiments, a device may comprise flexible and/or wearable electronic components. For example, a device may comprise electronic and/or smart textiles, including those where passive electronics such as conductors and resistors or active components such as transistors may be used. Conductive polymers may also be used. Textiles may be touch sensitive, including by using embedded in the fabric or straps of the device an array of electromagnetic sensors that are conductive to human touch.

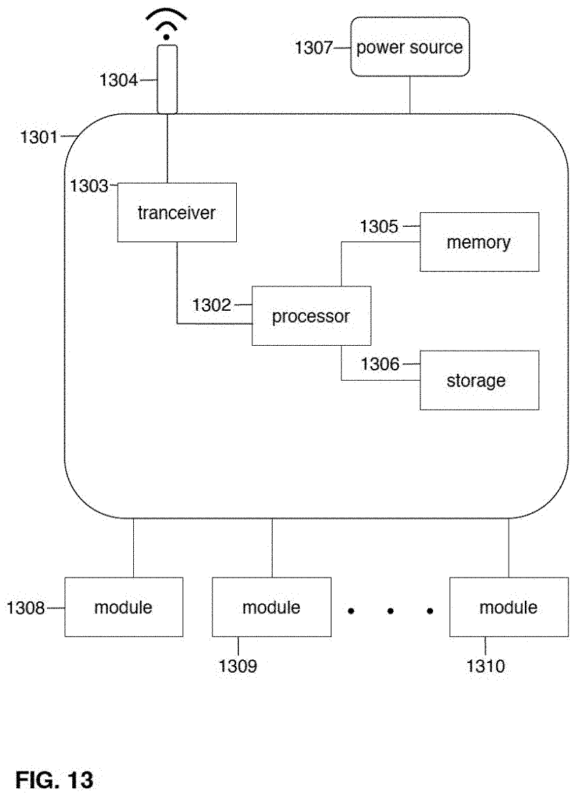

FIG. 13 depicts a exemplary and non-limiting schematic of electronic components that in some embodiment may be operably connected to perform the system, methods, and processes of the invention. Electronic components may be attached to a physical apparatus, such as a harness. The apparatus may include more of fewer components than what is illustrated.

Housing 1301 may be made of varying materials, metal, plastic, cloth, leather, etc. The housing may serve to protect the electronic components.

Processor 1302 may provide logic functions and/or instructions, and may send or receive input or data to and from other components.

Transceiver 1303 may allow the apparatus to interact with cloud, servers, routers, and other computers and components wirelessly. Transceiver 1303 may be operably connected. to antenna 1304. The transceiver may support one or more communication protocols and technologies, including but not limited to cellular communications, such as 4G LTE and 5G, WIFI, TCP/IP, ultrawideband, WiMax, GPS, etc.

Memory 1305 may allow the processor 1302 to store data such as audio files, sensor inputs, output signals, etc., on a short term or long term basis. The processor many also store computer readable instructions in memory. Memory may include RAM, ROM, or other storage means.

Storage 1307 any provide for storage of data such as audio files or other data. For example, storage may be used to store training statistics, such as trends in behavior of the user. Storage 1307 may be RAM, ROM, or other storage means.

A power source 1307 may be a battery, a power outlet, or other power source such as solar power. The power source may provide voltage for the device allowing components to function.

Modules such as 1308, 1309, and 1310 may be various input or output devices, include haptic devices, audio speakers, vibrations feedback devices, positional sensors, temperature sensor, tension sensors, tilting sensors, etc. Modules may also be other electronic components that are operably connected to Processor 1302, such as additional transceiver, memory card and memory card readers, displays, speakers, etc. Many more or fewer modules than those illustrated may be included in some embodiments.

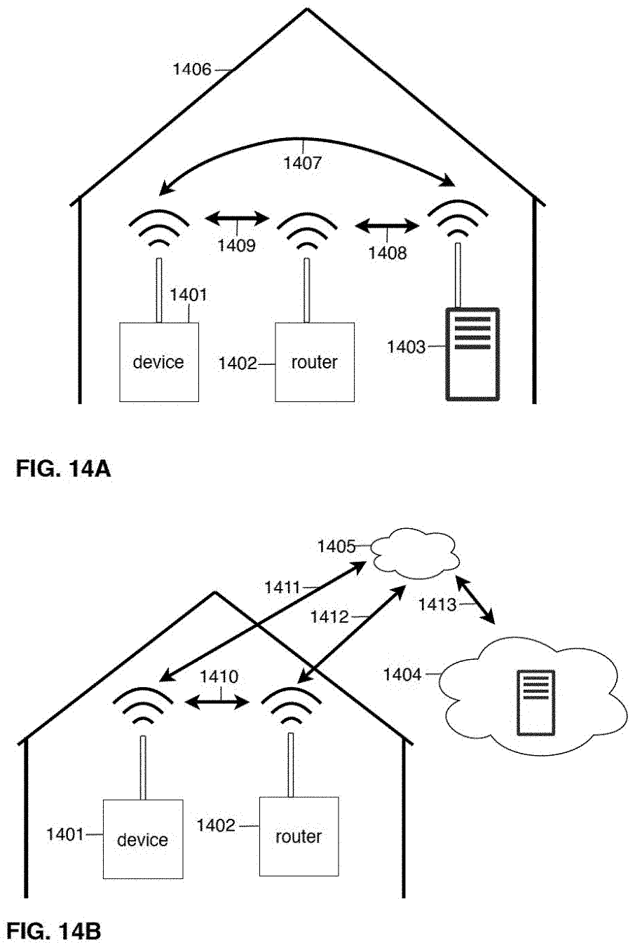

FIGS. 14 A-B depict the various ways a non-limiting device embodiment may interact with routers and servers allowing communication of data and connectivity to the internet, interactions with phones and other devices.

FIG. 14A depicts an embodiment in an environment located in structure 1406 which may be a house or other building comprising device 1401, router 1402, and server 1403. Connections 1407, 1409, and 1408 depict device 1401, router 1402, and server 1403 networking, connecting, and communicating via wired and/or wireless technologies. Server 1403 and/or router 1402 may be configured to provide a local area network (“LAN”).

FIG. 14B depicts an embodiment where device 1401 and router 1402 may interact with cloud 1405 via connections 1411 and 1412 respectively. Connections 1411 and 1412 may be wired or wireless connections. In addition, the device 1401 and router 1402 may form a direct, peer-to-peer connection or form a LAN. The device 1401 may communicate with a cloud server via either router 1402, that interacts with cloud 1405 via connection 1412, which in some embodiments may be wireless communication between router 1402 and cloud 1405. Device 1401 may also communicate with cloud server 1404 via connection 1411 by routing such communications through cloud 1405, or the device may communicate with server 1404 via the server's connection to cloud 1405. Cloud 1405 may comprise a wide area network, and connections 1411 and 1412 to cloud 1405 may be accomplished via an internet service provider.

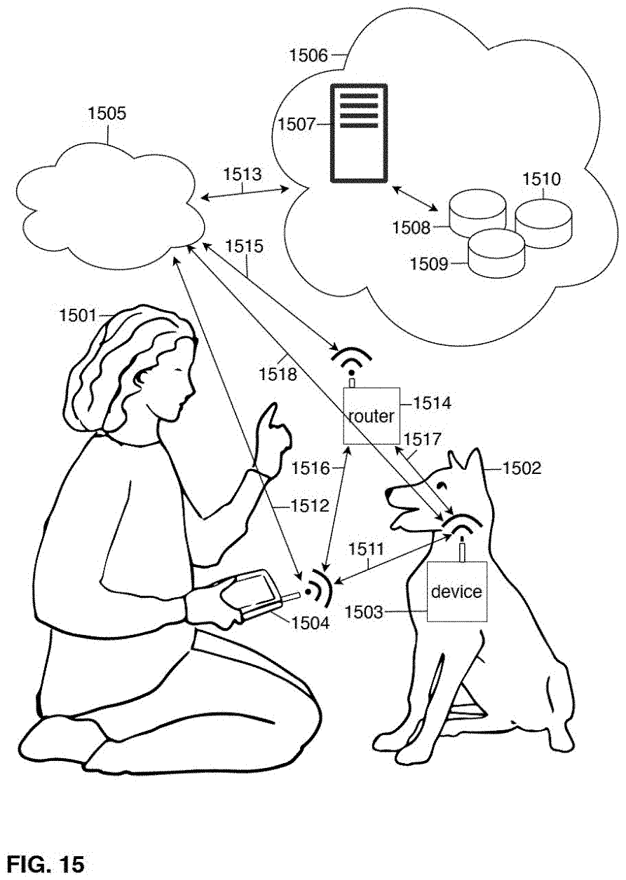

FIG. 15 depicts a non-limiting embodiment illustrating human trainer 1501 using a smartphone 1504 to communicate with the device 1503 that is attached to a dog 1502. Device 1503 may communicate wirelessly with a smartphone 1504, the cloud 1505, a cloud server 1507, and storage 1509, 1509, and 1510. There are many paths that device 1503 may use to communicate with cloud 1505 including direct connection 1518, via router 1514 using connections 1515 and 1517, and via smartphone 1504 via connections 1511 and 1512. Cloud 1506 may be connected to cloud 1505 via connection 1513, which may comprise some part of a wide area network. Smartphone 1504 and device 1503 may comprise wireless transceivers for wireless communication. Device 1503 may send output to smartphone 1504 via connection 1511, Such output may be data. Such data may be uploaded to the cloud 1506 and stored in storage 1508, 1509, and 1510. Data may also be retrieved from storage in cloud 1506 as directed by server 1507 and may use the same connections to send the data to device 1503 or smartphone 1504. Cloud 1506 may comprise server 1507, and storage 1508, 1509, and 1510. In some embodiments, device 1503 may connect to other devices not illustrated via router 1514.

### 2.2. Exemplary Physical Components

A device and its components may comprise one or more natural and/or synthetic materials. Exemplary materials include nylon, plastic, acrylics, latex, rubber, leather, alternative or synthetic leather, polyester, silicone, Kevlar, neoprene, resin, closed and open cell foam such as cross-linked foam, anti-static foam, anti-flame foam, ethylene vinyl acetate (“EVA”) foam, Phylon, polyurethane foam, polyethylene foam, and/or latex foam, elastic or stretchy materials, cotton, mesh fabrics, and metals such as aluminum, copper, brass, magnesium, titanium, zirconium, steel, zinc alloy, gold, and/or silver. Metal elements such as buckles, rings, or D rings may include a finishing or plating, including gold or silver plating, colors from physical vapor deposition (PVD) process over aluminum or other forms of paint, chrome, and stonewashing as examples. Materials may be resistant or proofed against water, shock, dirt, dust, weather, ultraviolet radiation, vibration, etc. Such resistance or proofing may be applied to the materials, such as by the application fabric protector, wax, or stain repellent as examples. Elastic or viscoelastic materials may be used. Reflectors or light reflective coatings may be applied to or integrated with a device, including to increase safety of the user during the nighttime.

A device may be made of a material providing increased elastic properties, such as elastic or materials containing elastics including to provide stretch for the harness to fit snugly to the dog's head or body, or to add comfort for the user. Elastic components may be elastomers, elastane, springs, rubbers (including natural and synthetic), including rubber bands, gums, Spandex or lycra, nylon, vinyl, silicone, neoprene, EVA, resin, foams, latex, etc. Certain parts or areas of a harness may be designed to be more flexible than others. A device may use one or more materials of different elasticities, including where parts of the device are designed to have stiffer stretch requiring more force, and where other parts of the device are designed to offer easier stretch (i.e., less force is necessary to stretch the material as compared to the stiffer part). For example, the stiffness of the elastic material may be varied by increasing or decreasing the number of elastic materials woven into a material, and/or may varying the length of the incorporated elastic materials.

A device many comprise one or more straps, webbing, padding, lashing points, tie downs, clamps, buckles, fabric, etc. Components of a device may be affixed to one another in a variety of ways, including by using stitches, glue, rivets, ties, buttons, zippers, epoxy, etc. A harness may include releasable attachments or fasteners such as buckles, zippers, clips, carabiners, latches, rings, D rings, locks, pins, hooks, and/or Velcro.

For example, an exemplary collar embodiment may comprise a strap made from a nylon material with a buckle attachment on both ends of the strap such that the strap may form a loop when around the user's neck. Such collar may include Velcro attachments sewn to the nylon for attaching a housing containing electronic components, and the collar may include a D ring sewn in the middle of the strap for a leash attachment.

The foregoing electronic and physical components described to be included in the device are merely exemplary. Embodiments of the device may additionally include other, known components that are not presently described.

### 3. Exemplary Harness Embodiments

Non-limiting embodiments of the invention may be implemented using a harness. For example, one or more sensors and feedback devices may be located on a harness that may be attached to a user's (such as a dog's) head and snout. Harnesses in nonlimiting and variable configurations may extend to the neck, chest, legs, and/or other parts of the body. In some nonlimiting embodiments, the harness may be fastened around the dog's snout and head. While the discussion below focuses on embodiments of the invention used by a dog, a person of skill in the art will understand that these embodiments are not limited to a dog as a user, and may be used by other types of users such as humans and other animals, such as cats, dolphins, or horses.

### 3.1. Exemplary Physical Characteristics

In some nonlimiting embodiments, a harness may include one or more straps. Using a dog as an example, one or more exemplary straps may fit around the dog's snout and may wrap around the dog's head and/or neck. Where a harness has both a strap wrapping around the dog's head and neck, the harness may include additional straps extending across the dog's body to connect the straps wrapping around the dog's head or neck together. A harness may be designed in various shapes and sizes to better accommodate different breeds or sizes of dogs, including different head shapes.

A harness may be adjustable to accommodate different sizes. Straps may be adjustable by length. Adjustments may be possible by placing the strap through two adjusting slides and/or buckle slides. A harness may include one or more O or D rings, including as lashing points to tie down straps, or as a connecting or tethering point for straps or a leash. A harness may include slideable clamps. A harness may include releasable fasteners. A harness may include four-point adjustments, including four adjustable straps around the body of the dog. A harness may be adjustable at the animal's neck, shoulder, chest, legs, snout, tail, face, head, or belly.

A harness and its components may comprise one or more natural and/or synthetic materials. Exemplary materials include nylon, plastic, acrylics, latex, rubber, leather, alternative or synthetic leather, polyester, silicone, Kevlar, neoprene, resin, closed and open cell foam such as cross-linked foam, anti-static foam, anti-flame foam, ethylene vinyl acetate (“EVA”) foam, Phylon, polyurethane foam, polyethylene foam, and/or latex foam, elastic or stretchy materials, cotton, mesh fabrics, and metals such as aluminum, copper, brass, magnesium, titanium, zirconium, steel, zinc alloy, gold, and/or silver. Metal elements such as buckles, rings, or D rings may include a finishing or plating, including gold or silver plating, colors from physical vapor deposition (PVD) process over aluminum or other forms of paint, chrome, and stonewashing as examples. Materials may be resistant or proofed against water, shock, dirt, dust, weather, ultraviolet radiation, vibration, etc. Such resistance or proofing may be applied to the materials, such as by the application fabric protector, wax, or stain repellent as examples. Elastic or viscoelastic materials may be used. Reflectors or light reflective coatings may be applied to or integrated with the harness, including to increase safety of the user during the nighttime.

A harness may be made of a material providing increased elastic properties, such as elastic or materials containing elastics including to provide stretch for the harness to fit snugly to the dog's head or body, or to add comfort for the user. Elastic components may be elastomers, elastane, springs, rubbers (including natural and synthetic), including rubber bands, gums, Spandex or lycra, nylon, vinyl, silicone, neoprene, EVA, resin, foams, latex, etc. Certain parts or areas of a harness may be designed to be more flexible than others. For example, where the user is a dog, using elastic material in the right and left side of the parts of the harness covering or wrapped around the snout may allow the dog to more easily open and close its mouth. A harness may use one or more materials of different elasticities, including where parts of the harness are designed to have stiffer stretch requiring more force, and where other parts of the harness are designed to offer easier stretch (i.e., less force is necessary to stretch the material as compared to the stiffer part). For example, the stiffness of the elastic material may be varied by increasing or decreasing the number of elastic materials woven into a material, and/or may varying the length of the incorporated elastic materials.

Components of a harness may be affixed to one another in a variety of ways, including by using stitches, glue, rivets, ties, buttons, zippers, epoxy, etc. A harness may include releasable attachments or fasteners such as buckles, zippers, clips, carabiners, latches, rings, D rings, locks, pins, hooks, and/or Velcro. For example, a harness may include Velcro material such that the one or more straps and fabrics comprising the harness may be connected. Furthermore, a harness may include one or more attachment and bracing points. A harness may also include one or more handles. Handles may be removable, including by using releasable fasteners or attachments. A harness may include one or more attachment points for one or more leashes. A harness may include one or more hand holds.

In some embodiments, a harness may further comprise fabric, including such that it may form a jacket over the user. A harness may include a chest piece. A harness may include a saddle blanket. Fabric may be fleeced to increase temperature regulation, including where the user will be exposed to colder climates. Fabric may be waterproofed. Fabric padding may be used in the harness to increase the comfort of the dog for extended wear. For example, the harness may include fabric padding comprised of mesh honeycomb. Fabric padding may also avoid chaffing by the harness. The harness may also include non-slip features.

A harness may include a pack that may hold items, including for example electronic components, and various other items such as animal treats, medication, water bottles, etc. The one or more packs may hang over either side of the dog. A pack may be secured to the body of the harness using releasable fasteners or attachments.

A harness may be designed to distribute weight and reduce of the force applied to more sensitive areas of the dog, such as the neck. In addition, a harness may be designed to reduce the force of leash movement, including the forces felt by a dog from the pulling force from the leash held by the dog's handler.

In certain exemplary embodiments, a harness for a dog may comprise two vertical straps encircling the dog's body (one towards the head, and the other towards the rear), each strap having a buckle placed underneath the dog's belly. Two horizontal straps connect the two vertical straps. The harness may further comprise a vertical strap encircling the dog's snout. Two horizontal straps may extend from the forward vertical strap to the sides of the dog's face, connecting with a vertical strap encircling the dog's snout. The straps encircling the snout may include electronic components such as wiring, gyroscopic and positional sensors, haptic feedback components,

Some harness embodiments may comprise adjustable straps that circle around forward and backward positions of the dog's body, connected by two adjustable straps that go along the top and bottom of the dog's body.

### 3.2. Exemplary Applications of Harness Embodiments

A user's body may consciously or unconsciously by goal-directed gestures activate sensors which may send signals to a processor for further logic. Logic functions may determine whether a significant spatial position has been reached by the user. Significant spatial positions may include vowel, consonants, and other designated sound positions from the phonetic alphabet that may be located in three-dimensional space. Significant spatial positions may be accessed by the user's body in various positions. For example, the user's may position his or her head in a specific location and angel in order to access a significant spatial position. Accessing the one or more significant spatial positions may trigger speaker or other sound producing device which may then play the phonetic alphabet sound. In order for the user to better locate the spatial positions assigned to phonetic sounds, haptic feedback may be provided to the user.

A harness may include a number of position or location sensors, and/or a number of haptic feedback components. The harness may include a computer or other similar logic or processing hardware. The harness may also include a battery or other means for power. The harness may include a speaker or other sound generator. In some embodiments, the harness may include a networking component, such as for Wi-Fi, cellular data including LTE or 5G, or Bluetooth. The networking component may, as an example, provide connectivity with a mobile smartphone, with a server, or with a computer, or other device. The harness may also include a radio component. The harness may also include other components that allow for wireless or wired communication with other devices. The various components of the harness may be connected together wirelessly or by using wired connections.

Switches or other sensors may be placed on the harness to turn the power to the device on and off. The switches may be buttons or physical sensors. The sensors may be placed on the sides of the harness. Where the user is a dog, the dog may paw at the sensors or switches to turn the device on and off, or the dog handler may turn the harness off manually.

In some embodiments, software and a computer may be used to handle the processing of receiving location, positional, tension, and other data from sensors on the harness. Data from one sensor may be used to augment another. For example, data from an internal motion sensor may be augmented with data from an accelerometer to augment the movement detection. The processor may be programmed to perform sensor and/or data fusion. The software may include logic to play a prerecorded sound assigned to a signal and/or data corresponding to inputs from sensors. The computer or logic processor may be programmed to perform the process illustrated in FIG. 6. In some embodiments, a voice or speech synthesizer may be used, including as an alternative to the use of prerecorded sounds. Speech may be programmed using a speech synthesis markup language. Pitch conversion may be performed by the computer or by speech or voice synthesizer hardware.

The devices, systems, and methods of this invention may be used for data tracking. For example, data about how the harness is used may be monitored and analyzed to understand progress the dog may have made in learning to communicate. The data may be sent to a smartphone, computer, or other third party using wired or wireless communications.

The position and/or orientation of the user's snout or head may be tracked in three-dimensional space via inside-out tracking, outside-in tracking, or a combination of those techniques. Sensors placed on the user or on the harness may aid in tracking the position and/or orientation of the user's snout. In other embodiments, data capturing devices in the environment may track or, in conjunction with sensors placed on the user and/or harness, may assist tracking the position and/or orientation of the user's snout. For example, vision-based sensors such as cameras may be used. Furthermore, in some embodiments, sensors may track of the location and or position of the user's body and/or specific parts of the user, which may include but is not limited to the head, nose, and neck. A harness may include material located around the user's mouth that may allow sensors to detect movement in the user's mouth, for example, if the user opens and closes his or her mouth.

The harness may include one or more calibration functions. A calibration module, feature, system, or function may be included to assess and calibrate various aspects of the harness and included electronic components, including the one or more sensors. For example, the harness may include a calibration function to establish null coordinates.

In some embodiments, one or more six-axis gyroscopic accelerometers sensors may be used to find location and position of the user's head, neck, or other body parts. An additional positional sensor, such as an additional six-axis gyroscopic accelerometer, may be located on the collar or another fixed location on the user to aid in determining the relative location of the user's head in three-dimensional space.

The user may be a dog. One or more six-axis gyroscopic accelerometers may be attached at the location in the harness where the dog's snout is wrapped by the harness band. One of these sensors may be located on the top of the snout, and this sensor is herein referred to as Gyroscopic Accelerometer Top or “GAT.” Another six-axis sensor may be located beneath the chin, and this sensor is herein referred to as Gyroscopic Accelerometer Bottom “GAB.” Additional position or location sensors may be used. In some nonlimiting embodiments, tension or pressure or other sensors may be used to sense when the dog's head moves position.

In some embodiments, additional six-axis gyroscopic accelerometers or other position or location locating sensors may be attached to the dog via a collar, vest, or other attachment. There may be 1, 2, 3, 4, 5, 6, 7, 8, 9, or more six-axis gyroscopic accelerometers. The additional six-axis gyroscopic accelerometers on these other attachments may allow a stable point of reference for the sensors on the collar.

In some embodiments, one or more haptic feedback components may provide haptic feedback to the user. This haptic feedback component may allow the user to receive feedback about the position and location of the dog's head, neck, or other body parts). There may be 1, 2, 3, 4, 5, 6, 7, 8, 9, or more haptic feedback components. In addition to the haptic feedback, other forms of feedback to the user may be employed, such as singular or multiple sequential phonetic sounds produced audibly. The user may adapt better to the new input of having an artificial communication instrument by using feedback mechanisms, such as haptic or auditory feedback.

These haptic feedback components may be in locations that may activate and provide haptic feedback, aiding in indicating to the dog when its head, snout, and neck position has reached a significant spatial position. In such an embodiment, there may be a number of significant spatial positions corresponding to the vowels and consonants in the phonetic alphabet. These significant spatial positions may be used to trigger consonant, vowel, or other sounds or data. As the user, such as a dog, passes through various significant spatial positions in the system, the haptic feedback devices may activate and provide feedback even if the user does not settle and stop in a particular significant spatial position. The feedback may aid the user in feeling the locations of a significant spatial position, and may aid the user in locating more than one significant spatial position so that the user may navigate through the various positions in the system, whether the user activates a significant spatial position or not. Haptic feedback components may be programmed to continue to activate irrespective of whether the user's mouth is open or closed, which may allow the user to choose a significant special position before activating the auditory components of the system, for example, when the user does open his or her mouth. When reaching and settling into a significant spatial position, such as by halting movement and holding position past a programmed threshold of time, the haptic feedback component may provide stronger feedback. For example, if the haptic feedback component produces vibrations, the vibration at a significant spatial position that the user has settled into and halted at may be stronger than the vibrations felt at significant spatial positions the user has moved through but has not halted or settled.

In a non-limiting embodiment, the Consonant Phonetic Space may not be visible but may be “felt” by the dog through haptic sensors vibrating at each point (different points may have different forms of vibration to help differentiate between points) and may be “heard” via audio feedback through a speaker or other audio feedback device. Consonants may be found by the dog by turning its head left and right on a horizontal axis. This change in angle of the dog's head may change the angle of the GAT and GAB with different consonants being located at different angles. When the dog's head moves, this may not trigger the phonetic points, when the dog's head stops moving then the point may be triggered and the consonant may be played. The horizontal axis may move with the dog's head as it moves in 3D space.

The consonants in the phonetic space may be unaffected by other movements in other axis (unless combined with another vowel significant spatial position at the same time, in which case the consonant may take precedence and will play before the vowel sound, which may avoid interference between the vowel and consonant systems.

In some cases, over time and with practice, the user may navigate through the Phonetic Space without conscious thought, analogous to a muscular routine like walking. In this way, the use of the harness to access significant spatial positions may become “second nature” to a user.

In some nonlimiting embodiments, the user's head or snout may turn left or right at various angles to indicate consonant sounds. The significant spatial positions for consonant sounds from the phonetic alphabet may be located at various angles to the right or left that the user's head may turn along on a horizontal axis. For example, if the user is a dog, the dog's head may be conceptualized as resting, with the chin flat on the edge of a table, without lifting the head and snout up or down or rolling it to its side. The snout and head may turn in angle either to the right or left, or may be facing straight ahead, to access the significant spatial positions for consonant sounds. To aid in consonant sound position haptic feedback to the user, the haptic feedback devices may be located on the right and left side of the head or the snout and may be located right and left of the GAT. The center position, where the snout may be facing forward, may be a no sound producing position for consonant sounds.

The user may turn its head to the right and reach one of a single or multiple significant spatial positions that may activate one or more corresponding consonant sounds. The positional sensors such as GAT or GAB, or other sensors, may produce a signal to a haptic feedback device located on the right of the user's head or the snout. A haptic feedback device located on the right side of the head or the snout may produce haptic feedback. The user may feel a vibration or a tapping sensation or other forms of haptic feedback. The GAT or GAB, or other sensors, may send a signal to a computer or logic process. The process may trigger the playback of a consonant sound on a speaker attached to the harness. In some embodiments, the process may send a signal to another device or transmit data. or another signaling device or send data to a third party.

When the user's head or snout turns left, it may trigger haptic feedback via a haptic feedback component located in the left side of the head or snout in a process similar as was described in the paragraph above.

For producing vowels, in embodiments where the user is a dog, the dog may have haptic feedback devices located in other places of the harness which may give feedback depending on the position of the dog's head, neck, snout, and or body. In one embodiment, significant spatial positions assigned to vowels may be indicated through three general forms of movement: the snout moving up and down, the head and neck moving forward or being in a neutral position, and the head rotating or tilting to right or left. An analogous movement of tilting in humans may be a human moving his or her left ear to his towards her left shoulder with his or her chin tilting to the right or moving his or her right ear towards his or her right shoulder, with his or her chin tilting to the left.

In other embodiments, other motions and positions that may be made or taken by the dog's body may be used to create the significant spatial positions assigned to vowel and consonants. In embodiments where haptic feedback devices may be attached to a harness, haptic feedback devices may vary in both number and where they may be attached to the harness. Many such variations according to the user's position or pose and corresponding haptic feedback may be possible.

As an example, in one nonlimiting embodiment, haptic feedback components may be triggered when significant spatial positions assigned to vowels sounds from the phonetic alphabet are reached via conscious or unconscious goal-directed gestures that the dog may take to reach those significant spatial positions. Vowel assigned haptic feedback components may be attached to the harness and may provide feedback to the dog. In this embodiment, haptic feedback components may be placed on the harness at the top of the snout (next to the GAT) and, if needed, another haptic feedback component may be located on the harness at the chin. The haptic feedback components may provide haptic feedback when the dog lifts his or her snout up or down, or when he or she reaches a neutral position. Even where there is only one haptic component device used for these significant spatial positions, the haptic feedback component may produce multiple forms of haptic feedback. For example, if the haptic feedback device produces vibrations, then different vibrations or number of vibrations released may be produced to indicate different significant spatial positions being reached. For the forward and returning to neutral from forward position motions, the dog may begin with his or her head positioned neutrally, and may stretch his or her head, neck, and snout to extend forward. Haptic feedback components may be attached on the harness in the area that wraps around the head or near the lower jaw. Haptic feedback may be produced when the head, neck, and snout are extended forward, or when the head, neck, and snout return to a neutral position.

For the head rotating and tilting positions, haptic feedback components may be attached to the harness at the cheeks of the dog. Haptic feedback from these haptic feedback components may be produced when the dog tilts or rotates his or her head to the right or left. The one or more haptic feedback components located on the dog's right cheek may produce feedback when the dog tilts its head to the right. The one or more haptic feedback components located on the dog's left cheek may produce feedback when the dog tilts its head to the left. Both the left and right cheek haptic feedback devices may produce feedback simultaneously when the dog's head returns to a neutral position.

The user may combine different consonants and vowels together, for example to form words, sentences, or other sounds, or may trigger vowels or consonants individually. Significant spatial positions for consonants and vowels may be combined by holding two or more significant spatial positions at the same time or by moving from one significant spatial position to the next in sequence. For example, the dog may have its head turned on the horizontal axis to the left (indicating a significant spatial position for consonants) while at the same time lifting its snout upward (indicating a significant spatial position for vowels). Thus, with one gesture, the dog may reach multiple significant spatial positions and produce combined units of sound. For instance, the dog may individually trigger the sound “n” and “oh” by hitting the significant spatial positions separately in sequence, or the dog may combine the two significant spatial positions and producing “Noh” which the dog may then follow with the significant spatial position for the vowel “ooh,” forming the word we hear as “No.” In this embodiment, when multiple significant spatial positions indicate both a consonant and a vowel, the consonant sound may be played before the vowel in the sequence or “string” of sounds. By combining gestures, a user may produce the word “no” with two movements. A user may create various phonetic sounds by combining various positions corresponding to one or more significant spatial positions.

In some embodiments, the harness may be fastened around the snout and may be constructed to allow the user to open and close his or her mouth. Two sensors, such as six-axis gyroscopic accelerometers, may be attached to the harness at either the top and bottom or the sides of the harness so that the sensors many determine if and when the user opens or closes his or her mouth. When the user opens his or her mouth, a change in position may be sensed by the GAT and/or GAB. The GAT and/or GAB may signal to a computer that audio feedback in the system may be active (if the dog's mouth is open) and may be nonactive (when the dog's mouth is closed). The dog may be able to open its mouth to make phonetic sounds and may close its mouth to halt sounds. This action may allow the system to reset between phonetic sequences.

The dog move into a neutral position at which no SCPP or SVPP may be triggered. The neutral location may be located where the dog is facing forward and the head and snout and neck are positioned such that the neck is not stretching, the head is level, and the dog's snout is not upwardly or downwardly turned. This position may provide a starting neutral point for the dog from which he or she may activate other sounds, such as consonants or vowels. This neutral vowel position may be referred to as Neutral Vowel Position (“NVP”).

In a nonlimiting embodiment, haptic feedback components may be used on the device to indicate when a significant phonetic position has been reached within the phonetic space. For example, when a significant consonant phonetic point is reached, the haptic feedback component may release a vibrating tap. As the dog moves from one consonant phonetic position to the next on the horizontal axis, the haptic feedback component may produce a tap to indicate when each position has been reached. The haptic feedback component may release multiple types of vibrations to differentiate between different consonant points.

Single or multiple haptic feedback components may be used. Haptic feedback components may be located on top of the dog's snout or attached to straps of the harness extending over the dog's snout. Haptic feedback components may be attached to the left and right regions of the top of the snout. In this embodiment, the left region haptic feedback component may produce a vibration when a significant SCPP position is located at an angle that may require the dog to turn its head left to activate it. The right haptic feedback component may produce a vibration whenever a SCPP is located at an angle that may require the dog to turn its head to the right to activate it. This configuration of multiple haptic feedback components on the top of a dog's snout may allow the dog to differentiate between the different consonants locations more easily and may help the phonetic space feel more tactile and easier to map in the dog's brain, and the dog may find it easier to find positions corresponding to consonants.

In some embodiments, haptic feedback components may also be located on other parts of the user's body. For example, haptic feedback components may be attached to a vest or other means of connecting the component to the user's body. Such components may be located near the user's chest, back, legs, arms, tailbone, etc.

The word “No” may be a combination of the linguistic sounds “N,” “Oh,” and “Ooh.” Spoken together, the linguistic sounds may produce the sound we recognize as “No.” But if one were to simply record those three sounds individually and play those three individual sounds one next to another “N”, “Oh”, and “Ooh,” the resulting output may not sound similar to how “No” is commonly spoken in English. The resulting output may sound like three different disjointed sounds being played next to one another and may not sound like a word. The reason may be due to how human mouths may produce sound. When a person produces one sound and starts shifting to the next sound, for example from “Oh” to “Ooh,” his or her mouth may not proceed immediately from one position to another. Instead, the mouth transitions in a change of shape from the “Oh” sound to the “Ooh” sound over a brief period of time. That small period of transition may affect the resulting sound.

Some embodiments may integrate the shifting sounds that occur in an organic mouth into the phonetic sounds played automatically and based on context, including a consideration of what phonetic sounds may have been played before and or after the current phonetic sound in a sequence. This process may be achieved invisibly to the user, i.e., not requiring the user to pose in or reach additional spatial positions in order to make out transitional sounds.

The Phonetic Transition Sound Organization System (or “PTSOS”) is a system that includes transitional sounds that take place between different phonetic sounds. In some cases, the first sound may play, and the following sound may then play a version of that second sound including a transition sound. PTSOS may include many different recordings of the same sounds.

In PTSOS, a SCPP or SVPP when reached may produce one of many potential sounds depending on the context of which that the SVPP or SCPP was triggered. Many variations of the PTSOS are possible, and it may be organized in other ways as will be evident.

In an embodiment using a transitional sound system, the sound “oh” may include a different transitioning sound when it follows the sound “guh” than when following the sound “n.” When “oh” is played after “guh,” the system may play a prerecorded version of “oh” that includes the transition sound that may naturally take place between “gu” and “oh” when spoken by a human. When “oh” follows “n,” a version of “oh” may play that includes the transition sound that naturally takes place between “n” and “oh” when spoken by a human Each consonant and vowel sound may have numerous versions that are context specific.

In some embodiments, no SVPP sounds may be triggered. The dog may turn his or her head left and right, and when it opens its mouth, it may trigger only the SCPP. In this case, the sound of only the triggered consonant may play. This is described elsewhere herein as NVP.

In the earlier described and nonlimiting neutral consonant position no SCPP may be triggered. This may be described as the Neutral Consonant Position (“NCP”). In this position, the dog may trigger and start sequences from just the SVPP. The dog may start sequences at these positions to construct words with vowel sounds.

At the start of a sequence, where a dog may select significant positions corresponding to a consonant and a vowel, the consonant begins the sound sequence. In human speech and phonetics, consonant sounds are often paired with vowel sounds because they are enunciated. “Tea” is not said “T . . . EEE,” they are rather said fluidly together “Teee.” When a consonant begins a sound sequence triggered by a dog moving into a combined SCPP and SVPP, the sound for that combined position may include the Consonant and Vowel and the transitional sound corresponding to those two sounds. For example, the transitional sound “Tah” may be used. This transitional sound may be activated when the consonant and vowel sounds are combined. In certain embodiments using pre-recorded sounds, where a particular transition sound may be played, that the transition sound may already be incorporated into the prerecorded vowel or consonant sound. For example: A “T” sound may play. Next, a recording of a version of the vowel “ah” may play in which the transition between the “T” and “Ah” sound would be included at the start of the sound.

Where a vowel begins a sound sequence, a vowel sound may be triggered by a SVPP. The dog may then select the significant spatial position corresponding to a consonant sound. The consonant sound may be played with the transitioning sound of the SVPP that occurs right before the SCPP because when the vowel sound was played a neutral consonant position was also held. No consonant played along with the initial vowel. In addition, when shifting from one consonant vowel phonetic sequence to another, this type of vowel transitioning into consonant event may also occur. For example, the word “At” may be composed of the phonetic sound “a” (the a sound in “cat”, or “trap”), and “t”, the sound of “t” in “tiger”. The word “At” begins with a vowel, and ends with a consonant. But when the sound “At” is in the middle of a sequence the phonetic vowel “a” in “At” may change from a “a” sound to an “a” sound that is influenced at the phonetic sound's start. The phonetic sound that is played before the “a” phonetic sound in “At” does not skip from the last sound straight to the “a” sound. The phonetic sound starts with the prior sound and slowly merges to the next sound (human lips changing and shifting in positions between phonetic sounds they produce are responsible for this).

When the At the middle of a sequence, the following sequences may affect the sounds produced depending on what vowel or consonant came before the previous sequence, and what vowel or consonant is triggered to come afterwards: C+CV+V; CV+V+CV; C+V+VC; Vowel+Vowel. The “t” phonetic sound may be a different depending on what surrounds the phonetic sound “t”. “t” may influence the following and or previous sound.

The end of a sequence may include a stop that may be triggered when the dog closes its mouth for a vowel, or when it goes to a neutral vowel position while triggering a consonant vowel position.

In another embodiment, there may be one or more magnetic sensors attached to one or both sides of the harness located where the dog's mouth opens and closes. A magnetic sensor may be a magnetic or electromagnetic switch. For example, the components of a magnetic switch may be located where the band around the snout of the dog is located, one component aligned with the dog's lower jaw, and another aligned with the dog's roof of mouth. The magnetic sensors may be connected to a computer. The magnetic sensors may detect when the dog's mouth is closed or open. For example, where the magnetic sensor is a magnetic switch, the components of that switch may be sufficiently close together when the dog's mouth is closed such that a circuit is closed. When the dog's mouth is closed, the auditory system may be deactivated. When the dog opens its mouth, the auditory system may be activated. Where the magnetic sensor is a magnetic switch, as the dog's mouth is opened, the circuit may be opened as the components of the switch are pulled apart. When the auditory system is active, the dog's interactions with significant spatial positions may produce phonetic sounds. Thus, the dog may be able to open its mouth to make phonetic sounds and may close its mouth to halt sounds. By controlling the activation of the auditory system, the dog may also reset the system between phonetic sequences, such as words, by closing and opening his or her mouth. This control may also aid in the dog's belief that the sound is produced directly by them and may aid in the adaptation of the dog to this system, including because the control may mimic natural dog behavior where a dog must open his or her mouth to make a sound such as a bark. Instead of control of an auditory system, other embodiments of this aspect of the invention may control other forms of output, such as text, data, codes, tones, etc., such as data that may be input into a computer or smartphone.

In some embodiments, sound output may be influenced by the user's other body parts, such as: the user's turning of his or her body, including spine moving and body shifting right or left; movements of appendages, such as paws, feet, hands, legs, etc.; quick nod motion; holding a certain position for a period of time; or posture, such as sitting or standing. Influences on sound output may be used to add nuances to the phonetic system such as intonation or other linguistic subtleties in language and phonetics. The user many also influence the creation in the auditory system of nuances observed in linguistic phonetics, such as the tap used in rolling R's and other additional sounds.

In some embodiments, regardless of whether the user's mouth is open or closed, haptic feedback components may continue to provide feedback to the user. The user may receive haptic feedback to “feel” the significant spatial positions and may use that feedback in order to orient his or her position when activating a phonetic sound or new “string” or sequence of sounds.

In some embodiments, volume or intonation of played audio feedback may be adjusted corresponding to changes in the user's mouth position sensed by the GAT and/or GAB. For example, the dog opening its mouth wider may make the sound louder. Or for example, opening the dog's mouth a certain amount may change the intonation of the sound so that the pitch rises, like when a question is asked in English.

In some embodiments, the opening and closing of a dog's mouth may be detected using one or more tension sensors attached to points of the harness around the snout that may sense increased tension when the dog's mouth is opened and less tension when the dog's mouth is closed. A threshold value of tension may be set for the sensor to determine open versus closed position. In some embodiments, when the dog's mouth is detected to be open, the dog using goal-directed gestures may now both trigger haptic feedback components and the playing of phonetic sounds.

In some embodiments, when the dog reaches a significant spatial position and keeps its mouth open as it switches position, the sound output may continue until the next significant spatial position is reached by the next goal-directed gesture, and so on. The “string” or sequence of phonetic sounds being built may halt when the dog closes its mouth. A new “string” or sequence of phonetic sounds may begin when the dog next opens its mouth. When moving from one significant spatial position to the next, the next sound may not play unless the dog stops and settles at the next significant spatial position.

One or more additional sensors may be placed on other parts of the dog's body, such as the torso, paws, tail, ears, etc. The additional sensors may also access one or more significant spatial positions. Accessing these positions may correspond to phonetic sounds or alter tone, intonation, linguistic stress, pitch, etc. In some embodiments, other types of physical positions or poses may be used to access significant spatial positions. For example, eye blinking, eye movement, tail wagging, or pawing may be detected and used to access significant spatial positions. In other embodiments, a brain implant may be used to detect brain signals corresponding to goal directed movements to significant spatial positions.

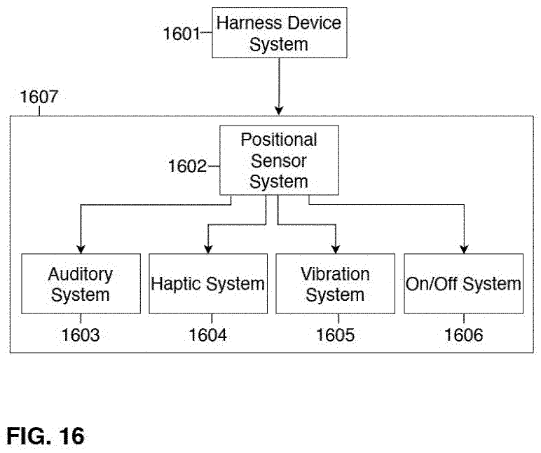

FIG. 16 illustrates a block diagram representing a nonlimiting harness system embodiment of the invention. While a harness is used as an example for the purposes of illustrating this embodiment, other physical formats may be used, such as collars, wearables, dog tags, neural implants, etc. Harness Device System 1601 comprises subsystems 1607. Subsystems 1607 may comprise systems, which may represent physical or electronic components of the harness, software or logic processing, or functions.

Positional Sensor System 1602 may receive and process input and may control, send, or receive input/output from and to subsystems such as the Auditory System 1603, the Haptic System 1604, the Vibration System 1605, and the On/Off System 1606. Positional Sensor System 1602 may control, send, or receive input/output with PSOS system 901 or other systems for communications, such as systems directed to producing text, prerecorded words or phrases, musical sounds, tones, code, shorthand, etc. In other embodiments, additional systems, different systems, or fewer systems may be present. Positional Sensor System 1602 may include component such as processors or other components that provide logic processing, input/output components, or control components, etc.

Positional Sensor System 1602 may receive input from one or more sensing components such as accelerometers or position sensors, for example a six-axis gyroscope or an IMU. Sensing components may be included on a physical apparatus, such as an apparatus worn by a user such as a harness or a collar. Sensing components may be in the environment, such as visual sensing components used for outside-in tracking. A user may interface with sensing components to produce or vary input.

The Auditory System 1603 may comprise one or more components such as speakers. Auditory System 1603 may be operatively connected with Positional Sensor System 1602 and play one or more sounds. For example, where Positional Sensor System 1102 further interfaces with PSOS system 901, Auditory System 1603 may play phonetic sounds when the user activates a significant spatial and/or conceptual position and or significant gesture (physical and or conceptual). In some embodiments, Positional Sensor System 1602 may direct Auditory System 1603 to produce other forms of audio, including prerecorded sounds, tones, music, etc. Auditory System 1603 may also be activated and deactivated. For example, Positional Sensor System 1602 may detect that a user's mouth is closed, and thus may deactivate Auditory System 1603 so that no sound is produced. Where the Auditory System 1603 is deactivated, the user in some embodiments may interact with significant spatial positions and/or gestures without activating audio feedback, allowing the user to intentionally select when audio feedback shall be produced. Where Positional Sensor System 1602 detects that the user's mouth is open, it may activate Auditory System 1603. In some embodiments, Auditory System 1603 is never deactivated, but may be instructed by Positional Sensor System 1602 to produce no sound output. In some embodiments, Positional Sensor System 1602 may direct the production of sounds such as short tones when the user reaches certain significant spatial positions. Positional Sensor System 1602 may instruct which audio feedback is produced and at what time based on the input provided by the user that is sensed by the Positional Sensor System.

The Haptic System 1604 may comprise one or more components such as haptic feedback components. The Haptic System 1604 may be operatively connected to Positional Sensor System 1602 and may produce haptic feedback, including taps. Haptic System 1604 may produce haptic feedback when the user activates a significant spatial and/or conceptual position and or significant gesture (physical and or conceptual). Haptic feedback may provide the user reference points to assist navigating and locating the various significant positions and/or gestures.

The Vibration System 1605 may comprise one or more components such as vibration mothers. Vibration System 1605 may be operatively connected to the Positional Sensor System 1602 and may produce vibration. In some embodiments, vibration may provide the user reference points to assist navigating and locating the various significant positions and/or gestures. In some embodiments, vibration may notify when the Positional Sensor System 1602 has detected changes in whether the user's mouth is open or closed. In embodiments where Auditory System 1603 is deactivated where the user's mouth is closed, such feedback may assist the user in determining whether Auditory System 1603 is active or inactive. Among other uses, Vibration System 1105 may also provide vibration feedback to the user when the user produces a sound using Auditory System 1603, such as when the user activates a significant spatial position and/or gesture, providing the user feedback from both sound and vibration.

The On/Off System 1606 may comprise one or more components including switches and on buttons that maybe operatively connected to Positional Sensor System 1602. When the Positional Sensor System 1602 determines that a user interaction corresponding to a power on or power off event has occurred, Positional Sensor System 1602 may send a signal to On/Off System 1606 to power off components associated with the Harness Device System 1601. However, in some embodiments, Positional Sensor System 1602 and On/Off System 1606 may remain powered. Correspondingly, when a user interaction associated with a power on instruction occurs, Positional Sensor System 1102 may send a signal to On/Off System 1606 to power on deactivated components of Harness Device System 1601.

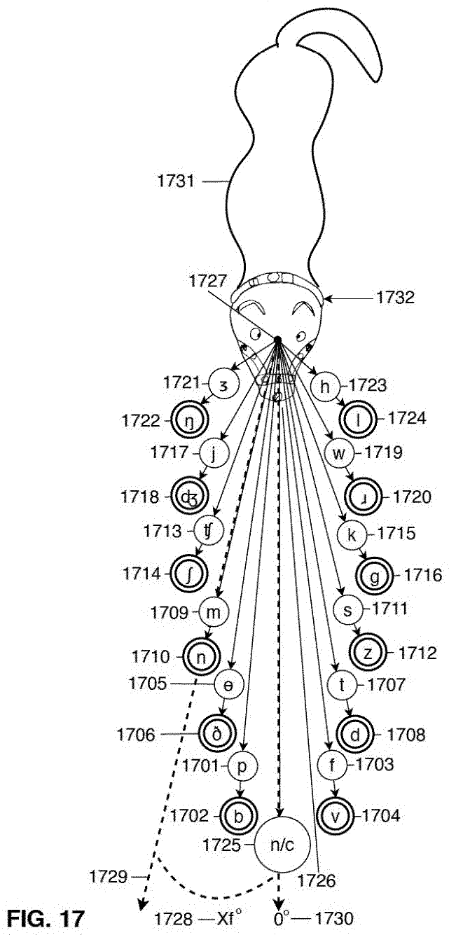

FIG. 17 illustrates a nonlimiting harness embodiment of the invention wherein significant consonant spatial and/or conceptual positions and/or significant gestures may be organized to be accessible to a user 1731 through a harness device 1732. FIG. 17 is further illustrates a system and method by which significant spatial positions may be reached by a dog.

In this non-limiting embodiment, consonants from the IPA chart are arranged along a horizontal axis. This non-limiting arrangement and location of these consonants form a “phonetic space” which may be accessed by the user to use spatial position and/or goal-directed gestures towards articulatory goals in order to construct words or other communicative sounds. A dog wearing a harness with sensors that may sense the location and orientation of the dogs' head may turn his or her head right or left at different significant spatial positions, such as but not limited to different angles, to access the illustrated significant spatial positions that have different consonant sounds assigned to them. The consonant sounds may be those from the IPA chart used in the linguistics field of study.

FIG. 17 illustrates an arrangement of consonants commonly used in the American English Language. In other embodiments, significant positions and/or gestures may include different arrangements and/or number of the consonants and/or vowels from the IPA chart in linguistics. The number of positions may be greater in number to include additional consonants, fewer in number to remove some consonants, or rearranged, include vowels, words, sentences, codes, voiced and or unvoiced phonetic sounds, tones, stenographer shorthand, or other forms of communication or variations of phonetics. In non-limiting embodiments, some phonetic consonants including but not limited to “b,” “y,” “w,” “m,” “s,” and “p” may be excluded as these phonetic consonants are sometimes excluded by ventriloquists. Even without these sounds, the dog or user using the system may still be understood. Voiced and silent sounds in phonetics may also be added. For example, the sounds “s” and “z” use the same place of articulation. The tongue goes to the same place and position in the mouth. The only difference is that one sound is voiced and one sound is silent; that is, “s’ is silent, and “z” is voiced. The way the body makes one voiced and one silent is by activating the voice box. When the voice box vibrates, the sound becomes voiced, when it is not activated the sound is silent. “s” is constructed by the position and location of the tongue and mouth. Air blows through and produces the sound. With “z,” the voice box vibrates.

One non-limiting embodiment may include a process by which the dog and/or user may choose a voiced or unvoiced version of a the consonant, such as “k” and “g.” This process may be accomplished by recognizing different gestures. For example, the dog may wear a band that wraps around its paw that includes one or more sensors that may determine the paw's location, movement, and orientation. When the dog lifts the paw, the sensed motion may trigger the change between voiced and unvoiced. In another non-limiting embodiment, the dog may dip its nose up and back up down quickly, the motion and position of the “dip” of the nose may be sensed by one or more six-axis gyroscopic accelerometers operatively connected to a processor that may determine whether a “dip” gesture has taken place. The “dip” gesture may trigger a voiced and/or unvoiced version of the sound. In some nonlimiting embodiments, a nose dip may lead to access to a voiced version of the sound, in others it may lead to access to an unvoiced version of the sound.

In another non-limiting embodiment, a neural implant may sense an electric signal from the brain that denotes “voiced” or “silent.” The user may use the system to learn how to make voiced and silent sounds. The user may train to use “voiced’ or “silent” sounds using a physical embodiment such as but not limited to a harness, skin attached system, frame system, or surgically imbedded system of sensors and/or haptic feedback components, or the user may train with a neural implant.

The dog's head 1727 may turn at various angles so the head aligns with various angles that are each assigned a corresponding significant spatial position and phonetic consonant sound from the IPA chart. In different embodiments, there may be other phonetic sounds corresponding to these angles.

The “n/c” 1725 may represent one or more neutral consonant positions where no consonant sound may play. There may be no phonetic consonant assigned at “n/c” 1725. Neutral consonant positions may allow other non-consonant sounds to activate individually. Individual activation of non-consonant sounds may allow the dog to begin a phonetic sound string with a vowel sound. When sound strings (or sequences) may activate and a vowel and consonant may both activated together (with the dog's head in both a consonant and vowel significant spatial position), the consonant sound may take precedence and begin the sound string, followed by the vowel sound. The “n/c” 1725 may allow for vowels to begin, as no phonetic consonant positions are activated along with the vowel.

Consonants 1701-1724 depict consonants from the IPA chart that are commonly used in the American English Language distributed left and right from the horizontal gaze of the dog at varying degrees. In different non-limiting embodiments, the same significant consonant positions may activate multiple assigned consonant sounds under differing circumstances. For example, a user or dog wearing a harness that may include sensing components may open his or her mouth slightly to activate a significant consonant position such as a significant consonant position corresponding to consonant 1003. The dog may open his or her mouth wider to activate a second significant consonant position such as a significant spatial position corresponding to consonant 1004. Other means for triggering the differing consonant sounds are possible. For example, a dog may wear a positional sensor on a band that wraps around its paw. When the dog lifts the paw, he or she may trigger the change between the phonetic sounds depicted in the single border circles (consonants 1721, 1717, 1713, etc.) and the phonetic sounds depicted in the double border circles (consonants 1722, 1718, 1714, etc.). In another non-limiting embodiment, the dog could dip its nose up and back up down quickly, the motion and position of the “dip” of the nose may be sensed by one or more six-axis gyroscopic accelerometer. The “dip” gesture of the dog may trigger whether the dog may access the significant positions corresponding to consonants illustrated within single border circles or the consonants illustrated within double border circles.

In a non-limiting embodiment, for example, “n/c” 1725 may be accessed if the dog's snout is facing straight ahead in front of the dog. That position may be seen as a neutral “n/c” (no consonant) significant spatial position. The dog may turn its snout (to the right or left at various angles. In this embodiment, sensing components may sense the change in position. As an example, consonant “p” 1701 may be located 10 degrees to the right of the “n/c” no consonant neutral position. Consonant “k” 1715 may be located 40 degrees to the left of the “n/c” no consonant position. To access significant spatial positions corresponding to these consonants, the dog may simply turn its head to the right and left at those angles respectively, illustrated in one example as angle Xf 1728. By accessing those significant spatial positions, the sounds for consonants “p” and “k” may be played. Many different angles may correspond to different consonants, including as illustrated in FIG. 17, and this arrangement may vary depending on the embodiment.

As illustrated in FIG. 17, “n/c” 1725 may be located in the front of the dog when the dog's head is facing straight forward. The other consonant positions may be accessed by the dog turning his or her head right and left at varying directions varying degrees. The arrow 1730 corresponds to the forward gaze of the dog and may be marked as 0 degrees. The dog may turn his or her head, and for example may orient his or her gaze towards in the direction of arrow 1729 at angle Xf 1728. By turning his or her head, the dog's gaze turns from the neutral “n/c” 1725 no consonant position to the position corresponding to both consonants 1709 and 1710, which are assigned to the phonetic consonant sounds “m” and “n” respectively. In other embodiments, the arrow 1729, arrow 1730, and angle 1728 may be varied so the dog may start and stop at different spatial positions and/or gestures other than the positions illustrated in the FIG. 17.

The arrangement of consonants 1703, 1704, 1707, 1708, 1711, 1712, 1715, 1716, 1719, 1720, 1723, and 1724 in FIG. 17 illustrate significant spatial positions assigned to those consonant symbols and sounds from the IPA chart that the user may turn their head left at various angles to reach. These assignments of symbols and their relative order and organization are nonlimiting and the significant spatial position and assigned consonants may be organized differently depending on the embodiment.

Similarly, the arrangement of consonants 1701, 1702, 1705, 1706, 1709, 1710, 1713, 1714, 1717, 1718, 1721, and 1722 in FIG. 17 illustrate significant spatial positions assigned to consonant symbols and sounds from the IPA chart that the user may turn their head right at various angles to reach. These assignments of symbols and their relative order and organization are nonlimiting and, and the significant spatial position and assigned consonants may be organized differently depending on the embodiment.

The single border circles representing various phonetic positions and/or gestures illustrated for consonants 1701, 1703, 1705, 1707, 1709, 1711, 1713, 1715, 1717, 1719, 1721, 1723 may be accessed by the dog turning his or her head so it aligns with the angle corresponding to one of those positions, and opening his or her mouth slightly. To access the double border circles representing various phonetic positions and/or gestures for consonants 1702, 1704, 1706, 1708, 1710, 1712, 1714, 1716, 1718, 1720, 1722, and 1724, the dog may turn his or her head to the corresponding position, and open his or her mouth more widely. Opening the mouth slightly verses widely may be sensed by the harness 1732 sensors and determine which of the two sounds at each consonant location may be activated.

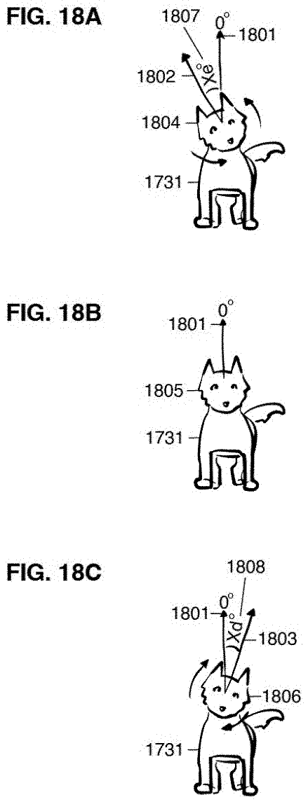

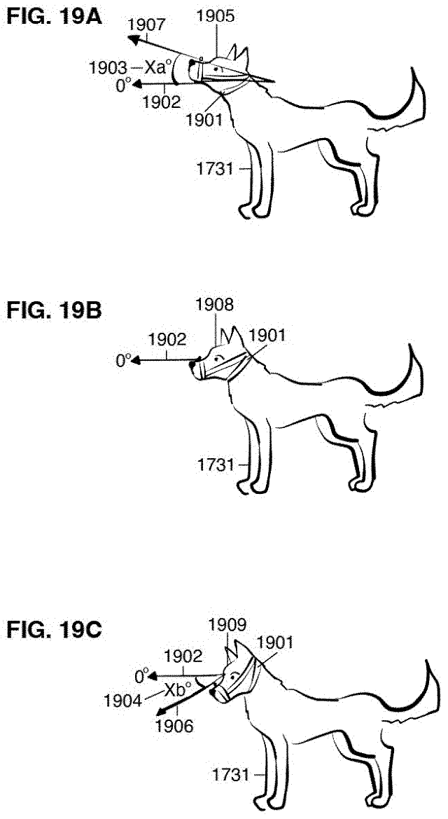

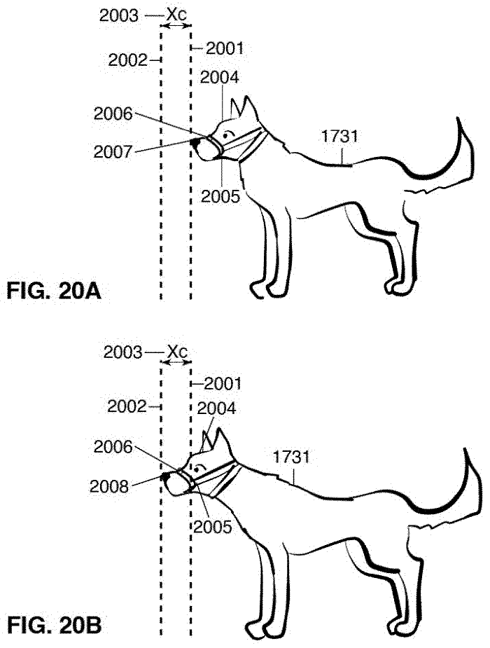

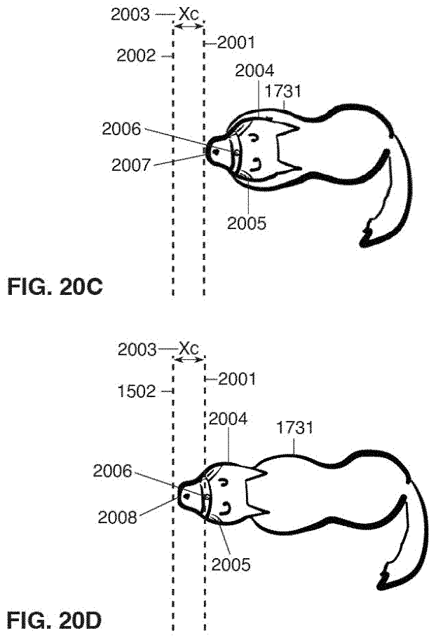

FIGS. 18 A-C illustrate non-limiting significant spatial and/or conceptual positions and/or significant gestures, which may be conceptual or virtual in different embodiments, where the user's head may tilt to the left, where the user's head tilts neither to the left or right with the user's head remaining level, and where the user's head may tilt to the right, respectively. Different embodiments may include additional significant positions and/or significant gestures, including beyond those illustrated in FIGS. 18 A-C. In a non-limiting example, there may be a significant spatial position that may be accessed by tilting the head Xe degrees 1807 to the right or a significant spatial positions that may be accessed by tiling the head Xd degrees 1808 to the left. Additional significant spatial positions may be assigned to various tilting angles that are not illustrated in FIGS. 18 A-C. The user 1731 may be a dog, but in different embodiments, the user may be a pig, horse, human, dolphin, or other animal.

The user may tilt its head to the left, to the right, or may keep its head in a neutral position. In a human, a significant position and/or significant gesture may accessed by that human moving his or her left ear towards his or her left shoulder with his or her chin tilting to the right (head left tilt), or moving his or her right ear towards his or her right shoulder with his or her chin tilting to the left (head right tilt), or keeping the head and chin level and tilting neither ear to either shoulder nor tilting the chin as illustrated in FIG. 18B.

User 1731 may tilt his or her head right (from the perspective of the user) into position 1804 by tilting his or her head into the significant spatial position corresponding to arrow 1802, Xd degrees 1807 to the right of neutral “level” position as illustrated by arrow 1801 (zero degrees). User 1231 may tilt his or her head left (from the perspective of the user) into position 1806 by tilting his or her head into the significant spatial corresponding to arrow 1803, Xe degrees 1808 to the left of neutral “level” position as illustrated by arrow 1801 (zero degrees). The user's head is in a neutral “level” significant spatial position 1805 as illustrated in FIG. 18B.

In some embodiments, a harness that user 1731 wears may provide haptic feedback when the user reaches, activates, or interacts with each significant spatial positions and/or performs each significant gesture.

FIGS. 19A-C illustrate non-limiting significant spatial and/or conceptual positions and/or significant gestures (which may be conceptual or virtual in different embodiments) where the user's head position is angled upwards 1905, is angled downwards 1909 and where the user's head neither upwards nor downwards with the user's head remaining level 1908. Some embodiments may include additional significant positions and/or significant gestures at various head angles. Multiple significant spatial positions and/or gestures are possible in addition to the three depicted in FIGS. 19A-C.

In a non-limiting harness 1901, an attached sensor that may sense position, orientation, and/or motion, such as but not limited to a six-axis gyroscopic accelerometer, may be used to determine the orientation of the user's head upwards or downwards, and whether such movements or positions activate a significant gesture or significant spatial position. User 1731 may be a dog, but in other embodiments, different users such as pigs, horses, humans, dolphins, and other animals, etc., may also be users.

In FIG. 19A, the dog's head is angled upwards aligned with arrow 1907, angled Xa degrees 1903 upwards from the neutral position illustrated as arrow 1902, such that the head has performed a significant gesture and/or is in a significant spatial position 1905. In FIG. 19B, the dog's head is angled at neutral level at zero degrees, as illustrated by the arrow 1902, such that the head has performed a significant gesture and/or is in a significant spatial position 1908. In FIG. 19C, the dog's head is angled downwards aligned with arrow 1906, angled Xb degrees 1904 downwards from the neutral position illustrated as arrow 1902, such that the head has performed a significant gesture and/or is in a significant spatial position 1909.

In other non-limiting embodiments, additional significant spatial positions may be possible at various additional upward and or downward angles that are not illustrated in FIGS. 19A-C. For example, additional significant spatial position that may be accessed by moving the user's head upward or downwards greater than or less than Xa degrees 1903 or Xb degrees.

In some embodiments implementing the significant spatial and/or conceptual position and or significant gestures illustrated in FIGS. 19A-C, user 1731 may wear a harness. The harness may include one or more sensors that may sense position, orientation, and/or movement, and may also include one or more haptic feedback devices. When the user reaches each significant position and/or significant gesture illustrated in FIG. 19A-C, haptic feedback devices may provide haptic feedback. For example, when the user 1731 lifts his or head and snout from the neutral position to an upwards angle so that it is in position 1905, the user may pause, settling into the new position. The harness's sensors may detect both the change in position and the user's pause at that position, and a process or logic function may determine that the dog/user has moved into a significant spatial position and/or made a significant gesture. The processor or logic function may send a signal to an audio speaker that may play a phonetic sound assigned to that significant spatial position and/or significant gesture.

FIGS. 20A-D illustrate non-limiting significant spatial and/or conceptual positions and/or significant gestures (which may be conceptual or virtual in different non-limiting embodiments) where the user's 1731 head position is at a neutral “back” position 2007, and where the user may move his or her head to a front position 2008. For example, when the user 1731 moves his head to neutral position 2007, the front of user's snout may be located at location 2001. User 1731 may move or stretch his or her head at a distance of Xc 2003 so that the snout is at location 2002, and the user's head is now in position 2008. Distance Xc 2003 may be measured using any unit, such as millimeters or centimeters. Distance Xc 2003 may be one of numerous lengths, including but not limited to 2 millimeters, 5 centimeters, or others. Distance Xc 2003 may be calibrated according to the breed or size of the dog. For example, distance Xc 2003 may be a larger value for a larger dog or a smaller value for a smaller dog, and these values may be varied based on the values that may be more effective when considering the size and other physical attributes of the dog. Other embodiments may include additional significant spatial positions and/or significant gestures beyond the two depicted in FIGS. 20A-D, including at longer or shorter distances than Xc 2003. In some embodiments, user 1731 may stretch his or her neck forward to reach multiple positions defined at increasing distance from the neutral position 2001. There may be multiple significant spatial positions of “forward”, in increasing distances forward.

In a nonlimiting harness embodiment 2005, an attached sensor 2006 such as but not limited to a six-axis gyroscopic accelerometer, may identify dog's head's significant spatial and/or conceptual position and/or whether the user has performed a significant gesture. User 1731 may be a dog, but in different non-limiting embodiments, different users such as pigs, horses, humans, dolphins, or animals, etc., may also be users.

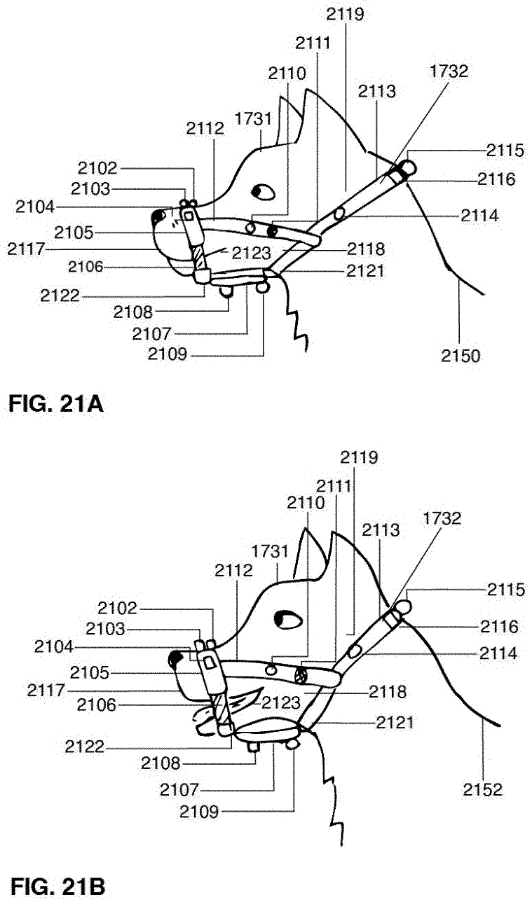

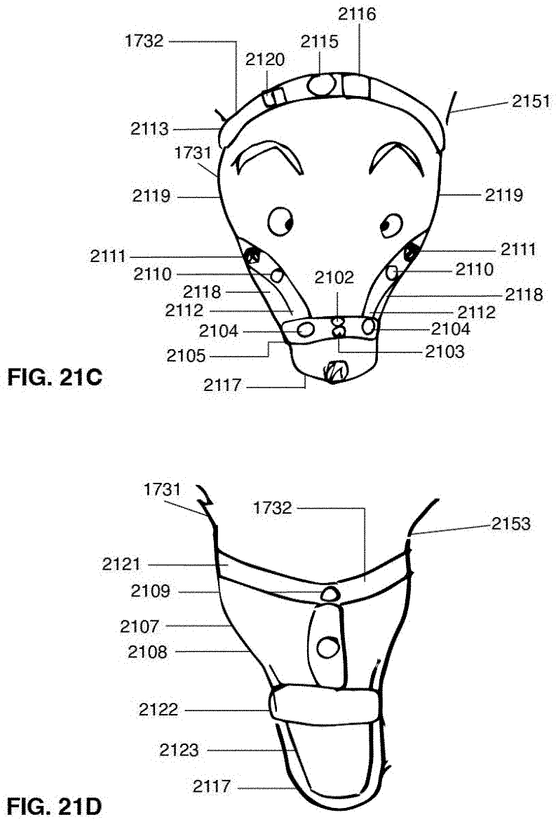

FIGS. 21A-D illustrate a nonlimiting embodiment harness 1732 worn by user 1731 with components including but not limited to sensors 2103 and 2108 capable of sensing location, position, and/or movement, such as six-axis gyroscopic accelerometers, haptic feedback components 2102, 2109, 2104, 2110, 2114, battery component 2115, computer 2116, buckle 2120, harness 1732, and speakers 2111. There are four viewpoints of the embodiment. In other embodiments, the components and arrangement of the components, along with materials and design may be varied. Although the user depicted in FIGS. 21A-D is a dog, other animals and/or humans may be the user.

Views 2150 and 2152 illustrate a profile perspectives of the harness 1732. View 2150 illustrates a profile view of the user 1731 wearing a non-limiting harness embodiment with the user's mouth 2123 in a closed position. View 2152 depicts a profile view of the user 1731 wearing a harness embodiment 1732 with the user's mouth 2123 in an open position. View 2151 illustrates a top-down perspective of user 1731 wearing harness 1732. View 2153 depicts a bottom-up perspective of the user 1731 wearing harness 1732.

A battery 2115 may be a power source. Battery 2115 may be rechargeable in some embodiments and may be replaceable in others. In other embodiments, a wall outlet may be used as a power source, or both a wall outlet and battery may be used.

Computer 2116 may be operably connected to receive signals from sensors 2103 and 2108. When significant spatial positions (and in some embodiments, significant gestures) are detected, computer 2116 may send signals to other components. For example, computer 2116 may send one or more signals to haptic feedback components 2102, 2109, 2104, 2110, 2114 to activate in order to provide feedback to user 1731. Computer 2116 may send such signals to the haptic feedback components when it determines that user has activated one or more significant spatial positions and/or gestures.

Bands 2112 on harness 1732 may connect the strap on the snout to the strap that wraps around the head, throat, and behind the ears. The bands may be located on both the right and left side of the user's head, and the bands may be located near the cheek of the user. On these bands, computer 2116, battery 2115, and buckle 2120 may be attached along with haptic feedback components 2110 and 2114, as examples. In an embodiment, additional components such as sensors or speakers or others may be located on this band.

Speakers 2111 attached on the harness 1732 may be located on the side of the head at or near user's cheek 2119. In other embodiments, the speakers may be located on other locations on and not on the harness. When activated, the speaker may produce sound output. In some embodiments, sound output may be prerecorded phonetic sounds. In other embodiments, sound output may be prerecorded words or phrases. The speaker may be operably connected to computer 2116 and powered by battery 2115. When computer 2116 detects a significant spatial position being taken by the user from data received from positional sensors 2103 and 2108, the computer may send a signal to the speakers to play one or more phonetic sound assigned to that significant spatial position.

In an embodiment, a user may open his or her mouth to activate the audio speakers 2111 to play audio corresponding to one or more significant spatial and/or conceptual positions and/or significant gestures (and/or conceptual gestures) that the user has interacted with and/or activated. A strap 2107 connecting the chin band 2122 to the part of the harness that wraps around the head behind the ears holds a positional sensor 2108, such as a six-axis gyroscopic accelerometer or other positional sensor, and an additional haptic device component 2109, such as a haptic motor. The positional sensor 2108 may detect when the user has reached one or more significant spatial positions. Sensor 2108 may also detect direction and/or movement. When the user opens his or her mouth, sensors 2103 and 2108 may detect whether and the amount that the relative distance between the two sensors has increased or decreased. When a threshold value of distance is reached, the user activated the system's audio playback. The user may deactivate the system's audio playback when it closes its mouth, thereby decreasing the distance between sensors 2103 and 2108 below the threshold value for activation.

Various haptic device components on the harness may activate to provide feedback to the user. Haptic device components 2102 are located at the top of the user's snout 2117. This component may be activated and provide feedback when positional sensors 2103 and 2108 detect that the user's 1731 position has interacted with and/or activated significant positions and/or significant gestures such as but not limited to “upper” 1905 and 1203, “middle” 1908 and 1204, and “lower” 1909 and 1205 positions.

Haptic feedback components 2109 may also activate when, for example, the dog moves into the positions 1905, 1908, and 1909 described in FIGS. 19A-C. In a nonlimiting embodiment, the haptic feedback components 2102 may activate and produce haptic feedback when the user takes the “upper” significant spatial position 1905. The haptic feedback component 2109 may activate and produce haptic feedback when the user takes the “lower” significant spatial position 1909. Both haptic feedback components 1203 and 2109 may activate together when the user moves and settles into significant spatial position 1908. This may allow the user to distinguish between the three significant spatial positions illustrated in FIG. 19 A-C more easily.

Haptic feedback components 2104 straddling haptic device components 2102 and sensor 2103 as arranged on snout band 2105 may activate when the user moves between significant positions and/or significant gestures described in FIG. 10 and FIG. 17. The haptic feedback component located on the left side of the snout may activate when the user turns its head to the left and settles into a significant spatial position on the left, as illustrated in figure FIG. 17. The haptic feedback component on the right may activate as the dog reaches and settles into significant spatial positions on the right such as illustrated in FIG. 17. Haptic device components 2104 are attached to snout band 2105 strapped around the snout 2117 of the dog. The harness embodiment has a flexible and or movable part 2106 that allows the user to open and close his or her mouth.

Haptic feedback components 2110, such as one or more haptic motors or other devices, may be located on either right or left side of the user's head around the cheek, and may activate as the user moves between significant spatial positions 1804, 1805, and 1806. The haptic feedback component located on the left side of the head/cheek may activate when the user tilts its head to the left and settles into a significant spatial position on the left position 1806. The haptic feedback component on the right side of the head/cheek may activate when the user tilts its head to the right and settles into a significant spatial position on the right position 1804. Both haptic feedback components may activate at the same time when the user moves into the “level” significant spatial position 1805. This may allow the user to more easily distinguish between the three significant spatial positions illustrated in FIGS. 13A-C.

Haptic feedback components 2114, such as one or more haptic motors or other devices, on harness 1732 may be attached on either side of the head of the user, and may activate as the user moves between significant spatial positions 2007 and 2008, and 1201 and 1202. In this embodiment, the haptic feedback components may use two unique vibrations. When the user moves his or her head forward into a “front” significant spatial position 2008, one of the two vibrations may be activated in both haptic feedback components. A second, unique vibration may be activated when the user moves its head back into a “back” neutral significant spatial position 2007.

In an embodiment of the invention, significant vowel spatial and or conceptual positions and/or gestures may be organized to be accessible to a user 1731 through a harness device 1732. As shown in FIG. 12, the vowel chart may be arranged to show the system and methods (which may be accessed through a device) by which significant positions may be reached through specific gestures and/or significant gestures. In some embodiments, varying phonetic vowels may be organized in different combinations. In Japanese language, for example, some vowels may not be included that may be included in an English based embodiment. Phonetic sounds may be added or excluded in various combinations including phonetic vowels and phonetic consonants. Neutral positions may be added or excluded in various combinations. In non-phonetic based embodiments, different sounds may be used. Movements used other embodiments may access significant spatial positions and gestures in the place of those illustrated and may involve different appendages. For example, instead of “front” and “back” (which refers to nose, head, and neck position), the user may lift a limb up and down. Instead of phonetics, auditory feedback may include complete words or sentences, or other forms of communication may be used such as codes, shorthand, tones, music, etc.

For the purposes of describing an organization of phonetic sounds to significant spatial positions, 1201 and 1202 are labeled “front” and “back” respectively and may represent the two positions FIG. 20 A-D “Front” position 2008 and “Back” position 2007. In the “Back” position 2007, the user's head, neck, and snout are not stretched forward distance Xc 2003, and the user may be in a relaxed position. In the “Front” position 2008, the dog's head and neck and stretched out forward. These positions may be accessed using the harness embodiments illustrated in FIGS. 21A-D. Sensors 2103 and 2108 may detect that the dog's head position is moved forward distance Xc 2103 relative to the user's relaxed position.

In this nonlimiting embodiment of an organized phonetic system, phonetic sounds corresponding to significant spatial positions “Front” may include vowels 1206, 1207, 1208, 1209, 1210, 1211, 1212, 1213, and 1214. Phonetic sounds corresponding to “Back” or “Neutral” significant spatial positions may include vowels 1215, 1216, 1217, 1218, 1219, 1220, 1221, 1222, and 1223.

In this nonlimiting embodiment, the circles 1203, 1204, and 1205 labeled “Upper,” “Middle,” and “Lower” respectively may refer to the dog head positions of: angled upwards along arrow 1907, being level along arrow 1902, and being angled downwards along arrow 1906, also respectively, as depicted in FIGS. 19A-C. Sensors 2103 and 2108 may sense when the user's head angle, including when the user is at a neutral angle by reaching zero degrees along arrow 2102, or has angled upwards by Xa degrees 2103, or has angled downwards by Xb degrees 2106.

Different embodiments may include other additional significant positions and/or significant gestures. The triangles 1224, 1227, 1230, 1233, 1236, and 1239 labeled “left” may correspond to phonetic sounds such as vowels 1206, 1209, 1212, 1215, 1218, and 1221 where the dog's head is tilting left along arrow 1803 by Xd degrees 1806 from the level position of zero degrees 1801 as depicted in FIG. 18C. The triangles 1226, 1229, 1232, 1235, 1238, and 1241 labeled “right” refer to the dog's head tilting right along arrow 1802 by Xe degrees 1807 from the level position of 0 degrees along arrow 1801 as depicted in FIG. 19A. The triangles 1225, 1228, 1231, 1234, 1237, and 1240 labeled “Level” refer the dog's head being at a level position of zero degrees along arrow 1801 and not tilting left or right as illustrated in FIG. 18B.

By reaching for a significant position and/or performing a significant gesture such as “Front,” “Back,” “Left,” “Level,” “Right,” “Upper,” “Middle,” and “Lower” positions, the dog may access, interact, and/or activate the phonetic sounds that may be assigned to that significant spatial position and/or significant gesture. These positions may be further varied as illustrated in FIG. 17, allowing phonetic combinations of consonants and vowels to be accessed together in combined spatial positions, and or in sequence. The dog may also access multiple phonetic positions and/or gestures, by taking and holding a combination of significant spatial positions and/or significant gestures and then moving to another, different combination of significant spatial positions and/or significant gestures.

In some embodiments, in addition to significant spatial positions illustrated in FIG. 18, other significant spatial positions such as those depicted in FIG. 19 and FIG. 20 may be taken simultaneously to reach a final significant spatial position that corresponds to a specific phonetic sound. For example, the sound “i” for vowel 1206, may require the combined significant spatial positions of “front” 1201 and 2008, “upper” 1203 and 1907 at Xa degrees 1903 from arrow 1902, and “left” 1224 and 1803 at Xd degrees 1808 from arrow 1801, taken simultaneously to reach and activate the significant spatial position that corresponds to “i” vowel 1206. The positional sensors may detect that the combined significant spatial position and/or combined significant gestures corresponding to “i” has been interacted with and/or activated. The positional sensors may send a signal to a computer that the user has interacted with the significant position and/or significant gesture for “i.” The computer may then send a signal to a speaker to play an audio sound “i.”

Additionally, in a non-limiting example, a consonant may be added using the significant spatial positions illustrated in FIG. 10 and FIG. 17. The significant spatial position for the phonetic sound “s” consonant 1011 and 1711 may be further combined with the combined significant spatial positions described previously for vowel “i.” When a vowel and a consonant significant position and/or gesture are interacted with or activated simultaneously, consonants may be given precedence and play first before the vowel. In embodiments using transition sounds, the transition sound is played second, and the vowel sound played third. When the significant spatial positions corresponding to “s” and “i” are activated together, the sound “s” and “i” may be played in sequence. The sound played may be the sound of the word “see.” Additionally, a transitioning sound may be automatically played before “i” because it is following “s,” allowing the sequence of phonetic sounds to smoothly transition from one phonetic sound to the next.

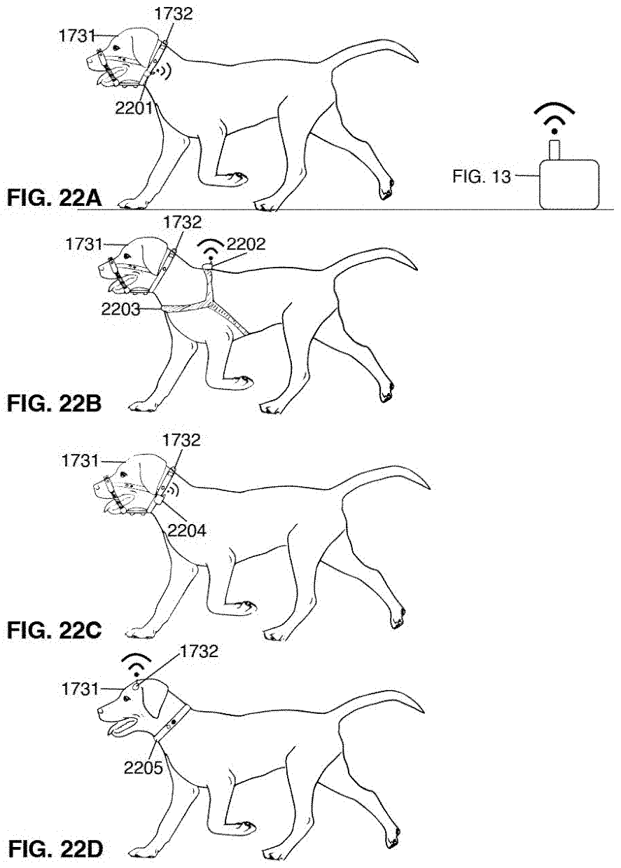

FIGS. 22A-D illustrate additional exemplary and non-limiting harness embodiments where computer, embodiments as illustrated in FIGS. 13, 2202, 2204, and 1732, may be located at varying locations both attached and not attached to a user 1731. There are numerous ways that a computer may be placed and interact with an embodiment. Some examples include as a computer wrapping around a dog's leg, dog's snout, being placed on the dog's back, or being placed at a location external to a dog. FIG. 22A depicts a dog/user 1731 wearing a non-limiting harness embodiment 1732 where the computer is not attached to the dog. The harness 1732's components communicate to a computer located separately from the dog. Components such as transceivers may allow for computer data networking, including using WIFI, Bluetooth, or other wireless communication technologies or protocols.

FIG. 22B depicts a user 1731 wearing a harness embodiment 1732 and an exemplary vest embodiment 2203. A computer 2202 is attached to the vest and may communicate with the harness embodiment 1732 via wire or wirelessly.

FIG. 22C depicts a dog/user 1731, wearing a non-limiting harness embodiment 1732 with a computer 2204 attached to the harness. The computer may interact with the components of the harness either via wire and or wirelessly.

FIG. 22D depicts a dog 1731 wearing an exemplary collar embodiment 2205. A computer may be imbedded in a neural implant 1732, and/or the neural implant may be connected to a computer located elsewhere via wireless connection.

### 4. Training

Disclosed herein are novel methods of training users to use certain embodiments of the invention. The exemplary training methods and examples below are nonlimiting. The methods below are described using nonlimiting embodiments of the invention, and it shall be evident to a person of skill in the art that these exemplary training methods may be used with other embodiments of the invention. In several of the training examples below, the user may be a dog, but other users such as humans, horses, pigs, dolphins, etc. may be trained using these methods. Furthermore, within the scope of the invention, the steps of any training method disclosed herein may reordered, or steps from different training methods may be combined. The number of trainers and users described below is also exemplary. There may be multiple trainers with one user, multiple users with one trainer, one trainer and one user, only one user without a trainer, etc. The techniques, methods, and systems described below may be applied to various stages of training and are not limited to the examples below. Training one or more animals may be done with one step or multiple smaller steps that build towards a goal/trained behavior. A more complex trained behavior may be comprised of a combination of numerous simpler trained behaviors. Training may include but is not limited to a user gesturing to facilitate communication and or moving and or gesturing to significant positions to facilitate communication. In some nonlimiting embodiments, gestures themselves may be used to communicate.

In some aspects of the invention, a trainer may use a training device such as a tool or an aid. When a user reaches a significant spatial position, a training device may trigger feedback or output to a trainer. Output may be haptic, visual, audio, or data. Using this output triggered by the user's interactions, a trainer may quickly learn that a user has reached a significant spatial position, when a user has reached a significant spatial position, and whether one or more significant spatial positions were triggered. The trainer may use techniques described herein to aid in training of the user to use an embodiment to the invention by connecting the triggered output with a meaning such that the user may understand the meaning of the output. The trainer may repeat sounds, such as but not limited to words or phonetics, many times to help pair the sound with an assigned meaning for the user. The trainer may interact with the user and or facilitate interactions with other third parties and/or the environment to aid in the user's understanding of meaning attributed to the various interactions the user may choose to make.

A training device may be connected to other devices or systems, including a harness incorporating a PSOS system and supporting electronic components. The connection may be wired or wireless.

As an example, the user is a dog wearing a harness embodiment of the invention, the harness may output training “tones” that the trainer may hear as the user reaches one or more significant spatial positions. The tones may be uniquely varied in pitch or tone based on the identity or classification of the significant spatial position that is reached. Instead of tones, the audio output may be clicks or other sounds. While the user moves among significant spatial positions, the user may continue to feel the feedback from the haptic devices on the harness. In some embodiments using PSOS, where the dog has opened its mouth, the harness may also provide audio output from attached speakers when the dog has reached certain significant spatial positions, constructing words phonetically as described herein. The trainer may evaluate the dog's movement through phonetic space using the tones while also hearing the dog's construction of words phonetically.

A trainer may also wear a training device that may allow the trainer to feel using haptic feedback or other tactile means when the user has reached one or more significant spatial positions. For example, the device may include gloves, a facemask, piece of clothing, handheld controllers, and/or other apparatuses that provide haptic feedback. Haptic feedback that the trainer feels may correspond with haptic feedback that the user feels. Based on this haptic feedback, the trainer may train the user. For example, the trainer may guide the user to a significant spatial position, region, sequence, etc., including according to the goals of a particular training session. For example, the goal of a training session may be to train the user to phonetically construct the word “out” by reaching the corresponding significant spatial positions.

In other embodiments, a dog may be trained to taught to read, for example by using cards with words written on them. Trainers may also use written symbols, including letters, words, sentences, symbols, drawings, etc., as supportive aids to learning or training. Written cues such as but not limited to flashcards with words or stick figures on them may also include additional feedback mechanisms. For example, a flashcard with a word “sit” written on it may have a small speaker attached to it with an activating device, such as but not limited to a button, that releases additional feedback when triggered. A trainer may press a small button on the card with the word “sit” written out on it and the small speaker may play the sound “sit.” Reading training may reinforce and support training the user to produce phonetic or other output by reaching significant spatial positions. For example, electronic devices such as screens may show different words or sentences that a trainer may use to support the user's understanding of the output from reaching one or more significant spatial positions. Picture books may be used as a guided training tool.

### 4.1. Positive Reinforcement Training

In positive reinforcement training, training techniques may include but are not limited to capturing, shaping, targeting, luring, clicker training, cues, etc. Positive reinforcement training techniques may be used to train a user to use devices, systems, or methods disclosed herein, including the user's interaction with or reaching of significant spatial positions.

### 4.1.1. Rewards

Rewards may be used to train a dog. Some dogs may respond to different rewards in different ways. For example, toy driven dogs love and are motivated most by toys, food driven dogs love and are motivated most by food or treats, and people motivated dogs may be most motivated by praise from a human Some dogs may have multiple strong drives or may be more strongly motivated by multiple forms of rewards. For example, some dogs may ignore a bouncing tennis ball, a toy reward, but may thrive on praise from a human, motivated by praise from a human Some dogs may ignore human praise but may be motivated by food or treats, such as a dog treat. Training may be tailored to the dog's personality and needs. Identifying effective rewards may lead to better outcomes while training.

Edible treats may be used as rewards. Edible rewards may be high or low value and/or higher or lower number. Trainers may use varying numbers of treats as tools to train. Using a smaller or larger number of treats may be seen as a smaller or larger reward by a dog. Five treats may be seen by the dog as a bigger reward compared to one or two treats. Lower numbers of treats may be used as a reward for behaviors that a dog already knows. Higher numbers of treats may be used more for learning new things, for challenging situations, and for difficult tasks.

Low value treats may be treats that a dog is used to, and/or are less enticing or interesting to the dog. Examples may include but are not limited to pieces of fruit, dry dog biscuits, dry dog food, a piece of carrot etc. Low value treats may also have lower calorie content. High value treats may be treats that a dog does not get very often and desires more, and/or are more enticing or interesting to the dog. Examples may include but are not limited to cheese, peanut butter, freeze-dried meat, sausage or hot dog, pieces of chicken. High value treats may be moist, freeze dried, smelly, or tasty to the dog. High value treats may contain more calories. High value treats may be used for learning new things, for challenging situations, or for difficult tasks.

As an example, a trainer may give a user a high value or high number of treats when a user, wearing an embodiment of the invention using a harness, opens its mouth the first time, triggering audio output. Later, when a user has opened their mouth for the fiftieth time, a trainer may use a low number and or low value treat.

### 4.1.2. Cues

A cue may be a name or label for a particular behavior. A trainer may create a cue for a newly learned behavior in order to signal to the dog to do the behavior. Cues may include but are not limited to hand signals, flash cards, verbal commands, etc. The dog may initially perform trained behaviors in response to assigned cues that the trainer has chosen. Eventually, the dog may not require cues to perform the trained behaviors. For example, a guide dog in training may be taught a cue to halt and use an apparatus to produce audio output (the verbal word) “stairs” via verbal command whenever the trainer has the dog encounter stairs. Through training, the dog may no longer require a cue and may halt and communicate the word “stairs” to its trainer or visually impaired handler whenever it encounters physical stairs. A visually impaired handler may be protected from falling downstairs by the guide dog's halt and understand the reason the guide dog halted through the guide dog's communication of the word “stairs.”

### 4.1.3. Clicker Training

Clicker training is a form of positive reinforcement training that uses clickers to condition and train a dog. The clicker operates as a conditioned reinforcer used in conjunction with a primary reinforcer, like food. For example, when training a new behavior, the trainer may use the clicker to help the dog identify the behavior that results in the treat. The technique may be used beyond dogs, including domestic and wild animals, and also small children.

Instead of or to supplement a click to mark the desired behavior, other distinctive sounds many be used, such as a finger snap, tongue click, whistle, or a word. Instead of an auditory signal, haptic or visual signals may be used, such as a vibrating collar or a hand sign.

In some embodiments, a trainer may use clicker training with a user to mark and/or reinforce the successful reaching of a significant spatial position. In other embodiments, the trainer may use clicker training to reinforce a positive association with a harness. For example, the trainer many hold a harness in his or her hands, and then reward a dog and reinforce that reward with a click when the dog approaches the harness.

### 4.1.4. Capturing

Capturing may refer to capturing the behavior of a user, including the behavior that the user performs naturally and/or spontaneously. A trainer may reward the user when the user performs the behavior to “capture” the behavior. A trainer may reward the user whenever he or she performs the behavior that the trainer seeks to capture. One or more cues may be used to aid in capturing. The capturing method is also based on the concept of operant conditioning, in that the user may associate his or her behavior and its consequence, for example, a reward.

In one example, a trainer may wait for a user to perform a desired behavior and then instantly reward the user. The trainer may time the reward to the behavior so that the user may connect the reward to the behavior. Each time the trainer sees the user perform the desired behavior, the trainer may reward the user. The trainer may also use cues, which may include verbal commands, hand signals, clicker noises, cue cards, etc. With repetition, consistency, and timing, the user may learn to perform the behavior consistency with or without the trainer's signals or cues.

In a capturing method where a dog wears a harness for accessing significant spatial positions, the trainer may wait to see the dog perform a head tilting behavior. Dogs tilt their heads to one side when they are processing meaningful stimuli such as but not limited to hearing a unique and unusual sound. When the dog tilts his or her head to one side, the trainer may reward the user. The dog with repeated capturing may associate the reward with tilting his or her head to the side. The trainer may add a cue to the captured behavior. When the dog wears the harness, the trainer may cue the dog to use the head tilting behavior. The dog may perform the behavior and encounter haptic feedback from the harness when one or more significant spatial positions are reached. The dog may learn how to locate the significant spatial positions based on the signals it received from the trainer's cue and/or the haptic feedback from the harness.

### 4.1.5. Targeting

Targeting may refer to a technique where a trainer uses a designated target, such as a post-it note, a hand, a mat, or a clicker stick, that the user is trained to target or aim at. The trainer may reward the user for touching the target, including where the user touches the target with a nose or a paw.

The trainer may use a wand-like stick with a small rubber ball attached to one end. The small rubber ball is the target that the trainer may train the dog to touch with the dog's nose. The dog may then wear a harness for reaching or interacting with significant spatial positions. The trainer holds the stick so the rubber ball is placed in a significant spatial position relative to the dog. The dog may touch the target with the dog's nose and thus move his or her head into the one or more desired significant spatial positions the trainer was targeting. The trainer may reward the dog the moment it reaches the desired position, teaching the dog that this behavior leads to positive consequences. The trainer repeats this training with the dog. The trainer may add a cue such as a verbal command Over one or more sessions, the dog may learn to reach the targeted significant position without the targeting stick, and may rely on haptic feedback from the haptic devices in the harness, in order to locate the targeted significant position. Additional positions may be targeted separately or in a sequence with the first.

### 4.1.4. Luring

The lure and reward method uses a treat to lure the user into different behaviors. For example, the trainer may hold a treat in front of a dog's nose. As the trainer moves the treat in three-dimensional space around the dog, the dog may move its snout to continue pointing at the treat. Luring uses the treat as a reinforcer of the dog's behavior. The lure action may be deliberately faded and used less and less by the trainer who may introduce a cue for the behavior.

Where a dog wears a harness for accessing significant spatial positions, the trainer may have a treat in the trainer's hand and use the treat to guide the dog's head to a significant position. The trainer may then feed the dog a treat, the dog may open its mouth to eat the treat. By opening its mouth, the dog may trigger the output of sound from that significant position. The trainer for example, may use this technique to have the dog trigger the output of the sound “foo,” as shorthand for “food.”

### 4.1.7. Shaping

Shaping methods involve building a more complex behavior through smaller and or less complex steps. Smaller steps and behaviors may build into larger steps and behaviors. A trainer may gradually teach a user a new action or behavior, rewarding the user during each step. By taking what may be a more complicated action/behavior into smaller parts, the dog/user may find learning faster and easier.

Where a dog wears a harness for accessing significant spatial positions, a trainer may break up a complex task of producing the greeting word “hi” into smaller parts. The trainer trains the dog in smaller steps and combine the steps, building to the complex behavior over time.

### 4.2. Model-Rival Training Methods

The model-rival training technique may involve the use of two trainers. One trainer may provide instructions, and the other may act as the user's rival for the trainer's attention, modelling correct or incorrect responses. The trainer and the trainer acting as a model may exchange roles from time to time for the benefit of the user. The user may learn to produce the correct behavior.

This method may be used to teach output to a user the meanings of words and/or forms of communication such but not limited to questions, object names, material an object is made from, color of an object, shape of an object, concepts, emotions, etc. These techniques could also be used to demonstrate how to interact with an embodiment to create communication output.

In an example, where a trainer is training puppies to use a harness for accessing significant spatial positions, another trainer may model the role of a user who is already trained. Alternatively, instead of a model trainer, these techniques may be used where the trained, model user is another trained dog or animal. For example, a puppy may observe the already trained dog answer questions and observe how the dog's head is moving. A puppy may try to mimic the trained dog's actions. Observing another dog using an embodiment may reduce the fear or apprehension for puppies and other dogs of wearing and using a harness for accessing significant spatial positions. These techniques may be applied in a smaller learning context with a single puppy and a trained dog/and or human or other animal as a rival, and a trainer. In other cases, the techniques may be applied in larger learning contexts with one or more trainers and one or more users.

### 4.3. Bond Based Training

Bond-based methods of training, such as the bond-based choice teaching method, may eb adapted and applied towards teaching a user how to use the systems, methods, and devices of the present disclosures. Bond based training focuses on teaching a dog, for example, to make his or her own choices rather than being trained to obey direction from their human, such as with positive reinforcement training. This school of training focuses facilitating cooperation between the human and the dog. Obedience is not as important as the bond and in fact can cause the bond to be sacrificed. In bond-based training, a bond may be mutually beneficial, require consistent training, and/or considers the health and well-being of both the dog and its human owner.

Where a dog wears a harness for accessing significant spatial positions, the trainer may build a bond with the dog in order to teach it to interact with the harness to reach significant spatial positions. The trainer may show the dog the harness and request if the dog will wear the harness. If the dog indicates “yes,” the trainer may place the harness on the dog and turn the electronics in the harness to a powered or on state. When the dog explores and interacts with the harness, the trainer may praise the dog and say “speak.” The trainer may feed the dog treats throughout training sessions at random times. The trainer may fix tape on his or her hand that the dog has learned to touch and may move the tape around while asking, “can you touch the tape?” The dog may touch the tape. The trainer may praise the dog and say “yay you!” The trainer may treat the dog and as the dog opens his/her mouth, the trainer may praise the dog and may say “you said (the word the dog said). Yay you! Wonderful!” The trainer may be patient with the dog as the dog interacts and learns to use the harness on their own. The trainer may repeat the word for an object such as a ball repeatedly.

The trainer may ask “Can you say what this is?,” and hold an object up such as a ball. If the dog attempts or successfully says “ball,” the trainer may praise the dog “Wow! Wonderful!” The trainer encourages the dog to make his or her own choices as he or she continues to learn, and the trainer only asks rather than commands the dog to attempt phonetic sound sequences, word sequences, and sentence sequences. The trainer may attempt to teach words with frequency and environmental context such as social context, vocalizations, gestures, etc.

### 4.4. Punishment and Negative Reinforcement Training Methods (not Recommended)

Other forms of training may use punishment or negative feedback techniques, such as negative words, physical discipline, the use of a pinch collar. Punishment may be used to teach behaviors to interact with the harness, but this is not recommended or encouraged. For example, a trainer may hit a dog's nose with a rolled-up newspaper to train a dog to interact with a harness for accessing significant spatial positions, but this is a technique that is discouraged.

### 4.5. Training Examples

### 4.5.1. Training User to Communicate the Word “Hi”

In some nonlimiting examples, where a harness is used to access significant spatial positions, a trainer may break up a complex task of producing the greeting word “hi” into smaller parts. At the conclusion of the disclosed training steps, a user such as a dog may say the word “hi” by moving his/her head to one or more significant spatial positions and opening its mouth. The steps used to train the phonetically constructed word “hi” may in this non-limiting example be produced using the following smaller steps.

A harness may be used to interact with significant spatial positions, such as the exemplary harness illustrated in: FIG. 10 (depicting IPA consonants), FIG. 11 and FIG. 12 (depicting IPA vowels), FIG. 17 (depicting an above view of a user wearing a non-limiting harness embodiment, with significant spatial positions for consonant sounds the user may interact with), FIG. 12, FIGS. 18A-C, FIGS. 19A-C, FIGS. 20A-D (depicting a possible significant spatial positions for vowel sounds), and FIG. 16 (depicting a way for a user to activate and deactivate audio output generated by a non-limiting harness embodiment).

Phonetically, the word “hi” consists of the sounds “h,” “ah,” and “ee.” The phonetic symbol for “h” is “h”, the phonetic symbol for “ah-ee/ai” is “aI”. Together the sound “h”+“ai” form the sound of the greeting word “hi” depending on the dialect and region. In IPA symbols/letters this is: “h” and “aI,” together forming the sound “h aI.”

Activating a consonant sound and a vowel sound at the same time may result in the consonant sound playing first, the transition in sound, mimicking the sound morphing and transitioning as human lips moves from one sound to another which changes the sound, playing second which bridges to the vowel sound that plays third.

The trainer's goal is for the user to interact with the harness g so that the user locates the significant spatial positions for both the consonant sound “h” and the vowel sound “aI” and activates them (playing audio output of those sounds in sequence as mentioned above) together by the dog opening its mouth (FIG. 16). The degrees of movement in a non-limiting embodiment may be negative, zero, and one or more from a neutral position.

### 4.5.1.1. Step 1: Train the User or Dog to Open his or her when Cued

An example of how a trainer may train a dog to open his/her mouth when cued may be by capturing the behavior of a dog opening his or her mouth, such as when yawning or barking, or silently opening its mouth, by treating and praising them the moment they display the behavior. When the dog does the behavior more often the trainer may repeat a verbal cue such as “speak” and when the dog responds to the verbal cue the trainer may treat the dog. The dog over time learns that the verbal cue or command “speak” means the behavior of opening the mouth. The trainer may encourage the dog with targeting or other method to open its mouth while in various physical positions, including sitting, standing, lying down, turning its head to the side, etc., in order for the dog to learn that the command or cue “speak” may occur in numerous physical positions and is not set at just one position.

### 4.5.1.2. Step 2: Train User to Locate and Move to Significant Consonant Position “h”

The trainer may train a user to seek out the significant consonant position corresponding to consonant “h,” 1723. With his or her mouth closed, the dog may turn its head towards the significant spatial position corresponding to “h.” Haptic devices releasing haptic feedback at each significant position may provide the dog with a way to locate the significant position correspond to “h.” In this example, the significant spatial position corresponding to “h” is located 15 degrees to the left of the neutral position (including as depicted in 1723). To reach it the dog may turn its head left fifteen degrees. There are various non-limiting ways the trainer may train this behavior, for example luring with a treat, or targeting with a clicker stick that has a target at the end, etc. The trainer may assign a cue for the significant consonant position “h.”

### 4.5.1.3. Step 3: Training a User to Locate and Move to Significant Spatial Position that Combine to Form Significant Vowel Position “aI”

The trainer may train a user to locate and move to significant spatial position corresponding to “aI,” including depicted in 1103, 1208. 1208 shows the sound “aI” in this non-limiting embodiment to be located at significant spatial positions “Upper,” “Front,” and “Right.”.

### 4.5.1.3.1. Training Significant Vowel Position “Upper”

The position “Upper” may be depicted in FIG. 19A. The user's head and snout is trained to angle upwards. In this example, the angle Xa in 1903 is 5 degrees upwards from the neutral position depicted in 1902. There are various ways the trainer may train this behavior, including luring with a treat, or targeting with a clicker stick that has a target at the end, etc.

### 4.5.1.3.2. Training Significant Vowel Position “Front”

The position “Front” may be depicted in 1201 and FIG. 20B The user's head is trained to move forwards from the neutral “back” position depicted in FIG. 20A and 1202. The trainer may assign a separate cue to each significant position.

Ways to train this may include but is not limited to, a trainer holding a dog's body in place, while the dog's body is in a “Back” neutral position such as may be depicted in FIG. 20A 2007, so the dog cannot step forward. A second trainer may lure the dog's head forward with a treat until the dog's head reaches the significant position “Front,” such as what is depicted in FIG. 20B and front position 2008. In this example, the distance Xc 2003 may be 20 mm. The dog may need to move his or her head and neck forward by 20 mm in order to trigger the significant positions “Front.”

### 4.5.1.3.3. Training Significant Vowel Position “Right”

The position “Right” may be depicted in FIG. 18A and spatial position 1804. The user's head tilts to an angle right, with chin tilting left. In this example, the angle Xe 1807 is 10 degrees to the right from the neutral position depicted in FIG. 18B and spatial position 1805. There are various techniques that the trainer may use to train this behavior, including capturing the natural behavior of head tilting, luring with a treat, placing a tug toy in the dog's mouth and physically moving the dog's head so that the head tilts to the right, etc.

### 4.5.1.4. Step 4: Training the Dog to Hold all Three Significant Vowel Positions

“Upper”, “Front” and “Right” simultaneously in order for the user to locate and move to the significant vowel position “aI”

The trainer may train the dog to hold all three vowel positions simultaneously, including through the use of cues, targeting, etc. The trainer may start with one cue and add a second. Once the dog learns to train two positions together, the trainer may add a third. Once the dog can master holding three positions together, the dog has reached the significant vowel position “aI.” The trainer may assign a cue to this position and train the dog to move to the position when the trainer uses the cue. There are various techniques that the trainer may use to train this behavior, including luring with a treat, or targeting with a clicker stick that has a target at the end, etc.

### 4.5.1.5. Step 5: Training the Dog to Hold Significant Vowel Position “aI” and Significant Consonant Position “h” Simultaneously to Reach the Significant Spatial Position for the Phonetic Sequence “h aI”, or the Sound of the Greeting Word “hi”

The trainer may use a cue they assigned to significant vowel position corresponding to “aI” and significant consonant position correspond to “h” so that the dog may hold both positions. There are various techniques that the trainer may use to train this behavior, including luring with a treat, or targeting with a clicker stick that has a target at the end, etc. The dog now has reached the significant spatial position for the phonetic sequence “h aI,” or the sound of the greeting word “hi.”

The trainer may cue this new behavior of triggering the sound “h aI” with a variety of different options, such as a hand signal, a verbal command, a notecard with the word “hi” written on it, etc. For the purposes of this example, the trainer will use the verbal command “hi” as the cue.

### 4.5.1.6. Step 6: Train the Dog to Open its Mouth while Holding Both Significant Consonant Position “h” and Significant Vowel Position “aI”, Triggering the Sound Sequence “h aI” (the Sound of the Word “hi”)

The trainer may cue the dog to reach the significant spatial positions that are associated with producing the word “Hi.” Once the dog has reached the significant position corresponding to “h aI,” the trainer may cue the dog to open its mouth with the cue verbal command “speak.” The dog may open its mouth while holding the “hi” position, triggering the sound “h aI.” The trainer may continue to cue and reward the dog for triggering the embodiment to output “hi” by holding the “h aI” position (“hi” verbal command) and opening his or her mouth (“speak” verbal command).

### 4.5.1.7. Step 7: Train the Dog to Move to the Position that Plays the Audio Output “hi” Consistently

The trainer repeats giving the commands “hi” and “speak” over time. The dog may practice the new behavior. As the dog becomes more consistent with the new behavior, the dog may begin to anticipate opening its mouth after holding the “h aI” position and eventually automatically open its mouth whenever the dog is prompted to say “hi.”

### 4.5.1.8. Step 8: Teach the Dog to Greet People by Saying “hi.” the Dog Receiving Positive Feedback from Other Humans Who May Greet the Dog Back

The trainer says “hi” to the dog and then gives the command for the dog to say “hi:” “hi” “Speak.” The dog may automatically open his or her mouth when doing the command “hi.” The trainer repeats the training saying “hi” to the dog and the dog replying back with “hi.” The trainer may bring other trainers, non-training humans, other trained dogs, or other trained animals, and instruct the dog to say “hi.” The dog may say “hi” and receive a response of “hi” from the third parties. The dog may be rewarded by the trainer. Repeating these training sessions may result in the dog via cue or command or on their own saying “hi” to others.

The trainer may train the dog to say “bye” by replacing the consonant “h” with “b” at significant position 1002 and 1702.

### 4.5.2. Training User to Communicate the Word “Hi” Using Luring Methods

Step 1: The trainer wears training earphones that allows the trainer to hear phonetic sounds assigned to significant spatial positions as a user wearing a device allowing access to significant spatial positions moves through corresponding significant spatial positions in real time. The dog's mouth may be closed or open, depending on the way the dog prefers learning. The dog may not hear audio feedback while his or her mouth is closed but may feel the various haptic feedback that the haptic devices output when the user triggers corresponding significant spatial positions. Different spatial positions may be assigned different variations of haptic feedback, aiding the dog in distinguishing between different significant spatial positions and locating or orienting themselves within the Phonetic Space Organizational System's significant consonant and vowel spatial positions.

Step 2: The trainer holds a piece of treat in their hand. The dog's torso may be held in place by another trainer so that the dog's torso does not move. The trainer lures the dog to the desired significant spatial position for “h aI,” which may be comprised of a combination of both consonant and vowel significant spatial positions as described above. The trainer is aided in locating this position by listening for the sound “h aI” via training earphones as they lure the dog from one position to the next.

Step 3: The trainer feeds the treat to the dog. The dog's mouth opens and the phonetic sound “h aI” is outputted by the harness embodiment's speaker.

Step 4: The trainer praises or rewards the dog for saying the greeting word “hi.” The dog may learn how to locate the significant spatial position for “h aI” via the specific feel the haptic feedback at that position, and also may learn location and orientation via haptic feedback at significant spatial positions located around and near the significant spatial position for “h aI.”

Step 5: The trainer repeats the training over multiple short sessions until the dog learns the positions and becomes proficient at triggering the word “hi.” The trainer may teach the dog to greet other humans and or other embodiment wearing trained animals who may respond with their own greetings, reinforcing the word's communicative meaning for the user.

### 4.5.3. Training User to Communicate the Word “Hi” Using Model-Rival Methods

A dog wearing a device allowing access to significant spatial positions may watch a trainer and a second trainer, or trained dog who already knows how to say “hi,’ demonstrate speaking the word “hi.” The trainer praises the second trainer (or trained dog) for demonstrating the word. The dog may get jealous and feel motivated to also perform the task correctly. The dog may attempt to mimic the gestures and or motions that trigger the output “hi.” The dog may practice and successfully learn the word “hi” and learn the meaning through frequency of hearing the word and seeing the contexts the word is used in. The frequency of practicing the word may also aid the dog in learning “hi.”

### 4.5.4. Training User to Communicate Using Harness

An exemplary method of first introducing and training a dog to use a harness allowing access to significant spatial positions for phonetic output is described below. The user, such as a dog, may be introduced to the harness in a way that results in the user feeling positive, such as confident, curious, trusting, etc., rather than negative, such as fearful, nervous, untrusting, etc., regarding the harness.

### 4.5.4.1. Exemplary Harness Functions and Capabilities

Exemplary components of a harness embodiment of the invention as illustrated in FIG. 21 include but are not limited to: harness and/or vest that can strap or clip on, or wrap around, or otherwise attach to a user such as a dog; one or more computers; one or more haptic feedback device; one or more vibration feedback device; one or more speakers; one or more sensors, such as position sensors, a sensor that may detect whether the user's mouth is opened or closed, heart rate sensor, or GPS locator; one or more batteries; or an on-off switch for powered on or off the device.

The physical components of the harness may be programmed to function with the following systems: Positional Sensor System (PSS); Phonetic Space Organizational System (PSOS); Neutral Phonetic Position System (NPP); Significant Consonant Phonetic Position System (SCPP); Significant Vowel Phonetic Position System (SVPP); Auditory system (AS); On/Off system; Haptic system (HS); or Vibration System (VS).

These systems may function and interact with the physical components of the device. For example, the harness may have a computer component (connected wired or wirelessly) that may connect to other components (wired or wirelessly). The computer may process information, make decisions based on data, and send and receive signals to and from other components of the harness embodiment, or receive and send instructions to and from components and/or devices not physically connected to a harness. The harness may be powered via a battery, which may be single use, rechargeable, or the harness may be connected to an external power source, such as a wall outlet.

The harness may be turned on or off via an on/off switch, which may include but are not limited to embodiments such as a physical switch, a touch sensitive pad, a smartphone app function, etc. When the power is turned off, and/or the harness goes into sleep mode or standby, the systems are offline. When the power is turned on, and/or the harness wakes from sleep mode or leaves standby, the systems are active and many the user many interact with the components of the harness. For example, the dog or user may interact with active sensors, haptic devices, and other components to access and interact with the systems listed above. The harness embodiment may make a noise that indicates that it has been turned on, and/or a light may blink or turn on. The harness embodiment may have haptic devices located on it that may be programmed to trigger haptic feedback when the harness and/or the dog's head are in specific significant positions while the harness is turned on. But if the harness is turned off, these functions will be turned off and be non-functional. In some embodiments, when the harness is turned on, the dog may open his or her mouth to trigger audio feedback corresponding to a significant spatial position. When the harness is turned off, the dog may open his or her mouth, but the system will be non-functional and audio feedback may not play. A dog and or trainer may use the on/off switch to turn the harness on and off. For example, the trainer may press an on/off button on the harness, or the dog may paw at the harness on his/her face to touch an on/off switch. Switching the power may allow the user or dog to decide when the system is active. The user may not want the system to provide auditory feedback when the user or dog opens its mouth to eat or drink. The user may desire to power on the system when he or she wishes to communicate, including with a trainer, etc.

With respect to PSS and POSS, the user may sense an embodiment of PSOS constructed of significant spatial positions in the space made accessible by a harness embodiment. The user may sense significant spatial positions, regions, directions-via-gestures, or audio as a result of the user's input via interactions with a harness embodiment or other forms of input. The user or dog's position and/or the harness's position may be tracked via positional sensors. The tracked position may allow the embodiment to determine if, when, and how the user intersects and or interacts with PSOS. The harness and/or part of a dog's body's position may be tracked relative to other parts of the dog's body. The head and neck of the dog could, for example, be tracked relative to the rest of the dog's body, such as the torso, shoulders, specific position on the back via a positional sensor attached to a vest, etc.

In exemplary forms, the Phonetic Space Organizational System (PSOS) may be located at significant spatial positions relative to the dog's main body. The PSOS includes the following subsystems: the Significant Consonant Phonetic Positions System (SCPP), the Neutral Phonetic Position System (NPP), the Significant Vowel Phonetic Position System (SVPP), and the Sound Transition System (STS). The Significant Spatial Positions may be accessed by gestures that move the dog's head and/or harness to the physical locations of the significant spatial positions. Significant Spatial Positions may be points or regions in three-dimensional space. Significant Gestures may be gestured directions. For example, significant positions 1701 maybe located between angle X which would be located in the angle direction of “n/c” 1725 and arrow 1730 corresponding to the forward gaze (zero degrees) and angle Y located in the angle direction of 1705 from 1730. The dog may feel haptic feedback as they “enter” a region's boundary such as the user 1731 in FIG. 17 moving from the angle of 1726 crossing the angle of direction 1225 and turning his/her heads right towards to 1701. For the purposes of this example, the whole region between 1230 and the angle of direction 1205 would be assigned the phonetic sound “p” and audio of the sound “p” would play at any place within the region just described if user 1731 opens his/her mouth and activate audio sound. This embodiment may allow the dog to access significant positions more easily as they do not have to be as “exact” in their positioning. In some non-limiting embodiments, other body parts of the user may be trained (e.g., paws, legs, tail, torso, eyes, etc.), or the user's gaze may be used, to reach significant positions.

Audio feedback may be outputted via a speaker. Audio output may be controlled by whether the dog has opened his or her mouth, e.g., if the dog's mouth is closed, no audio output may be produced, but where the dog's mouth is opened, audio output may be produced. Positional sensors may identify if and/or when a dog opens its mouth or closes its mouth. When a dog opens his or her mouth, a signal may be sent to a computer. The computer many determine that the user has opened its mouth. The computer may send a signal for the one or more speakers to output prerecorded audio files that may be assigned to certain one or more significant positions from the PSOS that the dog may have reached. In other non-limiting embodiments, computer programs or hardware that may synthesize sounds in real time may also be used instead of pre-recorded sounds.

When opening their mouth, and/or causing input in other ways, such as moving a paw, a leg, etc. the user may trigger the harness embodiment to produce output (such as audio). Output may differ depending on what position, region, directions-via-gesture, or other forms of input that the dog has reached, for example, when the dog's head reaches a specific spot assigned to a specific phonetic sound. The dog inputs physical motion, such as deliberate, unconscious, accidental, etc., using the harness and may trigger output through those physical motions. When the dog closes his or her mouth, the harness may stop audio output.

A Phonetic Sound Sequence is a sequence of one or more phonetic sounds. For example, in American English, the word “I” may be represented by the phonetic symbol “aI,” which may make the same sound of the word “I” or “eye.” That is a phonetic sequence comprising one phonetic sound. The word “am” may be represented by the two phonetic symbols “æ” and “m” combined consecutively: “æm.” The word “am” may be represented by a phonetic sequence comprising of two phonetic sounds. A Word Sequence is a sequence of words such as “I am”. That is a sequence of two words. A Sentence Sequence is a sequence of sentences such as “I am Max. Hello new friend. Do you have treats?” That is a Sentence Sequence containing three sentences.

With respect to Consonant+Vowel or Vowel+Consonant sequences, if both a significant consonant position and a significant vowel position is held at the same time, both the audio output assigned to the significant consonant position and the significant vowel position may play. The sounds may play in a three-part sequence with the significant consonant position playing first, a transitional sound, which may be assigned to the specific combination of consonant and vowel positions being played, may play second, and the vowel may play third.

For Consonant+Consonant sequences, if a dog triggers a significant consonant position (A) and then moves to a second significant consonant position (B) while keeping his/her mouth open, then the assigned audio output for A may play first. After that the assigned audio output for B may play a sequence of a transitional sound, which may be assigned to the specific combination of consonants being played in an A to B sequence, playing second and the audio output assigned to B playing third.

For Vowel+Vowel sequences, if a dog triggers a significant vowel position (C) and then moves to a second significant vowel position (D) while keeping his/her mouth open, then the assigned audio output for A may play first. After that the assigned audio output for D may play a sequence of a transitional sound, which may be assigned to the specific combination of consonants being played in an C to D sequence, playing second and the audio output assigned to D playing third.

No playback of audio may be assigned to neutral significant positions. There may be a neutral consonant significant position and multiple neutral vowel significant positions. If the dog is at all Neutral positions at the same time and opens his or her mouth, no audio output may be played. If a neutral consonant significant position is held while a vowel significant position is held then the audio output assigned to the vowel significant position will play on its own. No consonant audio will play. If all vowel significant positions are neutral and a significant consonant position is held, then the audio output assigned to the consonant significant position may play on its own. No vowel audio may play.

In some embodiments, vibration devices may produce vibration when the dog's mouth is open. This may signal to the dog when the audio output system is activated. When the dog's mouth is closed, the vibration feedback may stop. This may signal to the dog when the audio output system is inactive. Vibration devices may be used to serve other functions.

A heart rate sensor may provide feedback to a trainer such as through a smartphone application to allow the trainer to monitor the heartrate of the user. This may give additional data on the use while training. A GPS locator may be used to help locate the dog or may be used in combination with positional sensors to locate the dog's position.

The user may receive feedback, including but not limited to haptic feedback, auditory feedback, pressure feedback, olfactory feedback, etc. Haptic devices may activate to indicate regions or locations of significant positions, which may in some embodiments maintain their relative position to the dog. For example, the dog may still turn its head right by a certain number of degrees to reach a significant position even when walking. The significant positions may remain in place relative to the dog even if the dog's body is walking, running, being transported, etc. One or more haptic devices, or other feedback producing devices, may provide feedback to the user to help the user orient and find his or her location within the framework of significant spatial positions.

Haptic feedback devices may output haptic feedback to the user when the user's position intersects with one or more significant spatial positions. Different haptic devices may be assigned to different aspects of the PSOS system, such as haptic devices assigned to: SCPP, SVPP, NPP, etc. A Haptic device may produce multiple forms of haptic feedback, for example different physical sensations. Different significant positions may be assigned different variations of haptic feedback.

Haptic feedback may feel “different” depending on the various positions the haptic devices are assigned to output feedback to the user. There may be different taps, heaviness, number of taps etc., that feel different to the user. This may help the user more easily distinguish between significant positions, regions, etc., and allow the user to navigate through various sequences of sounds. For example, SCPP significant positions may use two different haptic feedback devices. The SCPP significant positions to the right of the Neutral Position may be assigned a haptic device on the right side of the harness, while the SCPP significant positions to the left of the Neutral Position may be assigned a haptic device on the left side of the harness. FIGS. 21A-D illustrates an example. The different significant consonant positions to the right side of the harness may trigger the same haptic device, but the haptic feedback sensation may be different for each position. The different significant consonant positions to the left side of the harness may trigger the same haptic device, and the haptic feedback sensation may be different for each position.

Neutral significant position for consonants may trigger both haptic feedback devices (described above and illustrated FIG. 21) at once, clearly distinguishing the significant consonant neutral position. In other non-limiting embodiments, the Neutral Significant position for consonants may be signaled by no haptic feedback.

Haptic devices may trigger feedback when a dog gestures or its movement intersects significant spatial positions that are assigned to generate haptic feedback. Haptic devices may not provide feedback when a dog's gestures or movement does not intersect with a significant spatial position. In this example, the one or more haptic devices assigned to a single significant position may output once each time the dog intersects with that significant position. In some embodiments, the one or more haptic devices may output haptic feedback multiple times or repeatedly until the dog moves away from the significant position assigned to the haptic device.

### 4.5.4.2. Introductory Training

To establish a positive training environment, the trainer may start training a dog while the trainer is in a positive mood or mindset, or at least in a place of mind where the trainer may not quickly feel stressed, impatient, irritated, nervous, or in another state of mind that is not conducive to training or learning.

The trainer and dog may train in parts of the day where they are not too tired. Sessions may be kept to an appropriate length of time depending on the user or the training situation. The training session may benefit from being shorter or longer. The species of the user, the aptitude, the mood, the behavior to be trained, the personality of the user, etc., may result in different training session time lengths. The user or trainer may benefit from training sessions being shorter or longer in length depending on varying factors (mood, topic of training, etc.). The user may use a device allowing access to significant spatial positions without a trainer present for longer periods of time.

A trainer may determine what rewards motivate a user such as a dog. For example, a dog may be toy driven, food driven, people driven, etc. If the trainer chooses to use treats they may assess the dog's reaction to different treats. Dogs may prefer certain treats more as high value or low value. High value rewards may be used when a user is learning something new, or doing something difficult or challenging. Low value or lower number rewards may be used when the user is doing something that they have already done before. For example, once the user acclimates to the use of an embodiment they are interacting with, they may require fewer high value treats than the user initially may have received from the trainer.

The trainer may reward the user when the user, such as a dog, acts towards a set goal or behavior. Examples of goals may include but are not limited to: approaching an apparatus allowing access to significant spatial positions, such as a harness, that is on the floor; opening the mouth while wearing an embodiment; interacting with a non-limiting embodiment so that the embodiment outputs an audio output such as the word “Yes.” Goals may be various with some goals being larger and or more complex or smaller and simpler and or less complex, etc. A large goal may be made up of a series of smaller goals that lead to a larger goal.

If the dog makes an action that does not lead to the desired outcome, the trainer may respond with no response. There may be no reward given to the dog for actions that are not productive towards a desired goal. The dog is not punished but is not encouraged to continue to act in a way that is not productive towards the goal. If the dog may acts in a way that may hurt the dog or trainer or third party, and/or is destructive to the environment, then the trainer may choose to intervene and set a boundary. For example, the trainer may say “no” or “leave it,” or the trainer may pick up the dog to move it away from danger.

A comfortable and confident user may result in more curiosity and openness when using an apparatus allowing access to significant spatial positions. Such comfort and confidence may increase speed and depth of learning to interact and use an embodiment and lead to longer periods of wearing the embodiment. For example, the harness embodiment (or other embodiments) may feel unusual and/or novel for the user when they encounter the embodiment for the first time. While encountering an embodiment, a user may feel positive, neutral, and/or negative about the embodiment. There is a risk as with any novel element that the user may be introduced to that the user reacts with worry or fear. The trainer may aid in training the user to feel more confident and trusting when initially encountering an embodiment.

Wearing an embodiment for longer periods of time may increase a user's exposure to interacting with an embodiment. The more exposure that a user has may result in more opportunity for the user's brain to adjust, rewire, and/or adapt to an embodiment. With more use of the embodiment, the more the embodiment will feel natural for the use, and the user may begin to feel that the apparatus is an extension of the user's own body.

If the dog shows any signs of fear and uncertainty at any point of the training, the trainer may slow down the training and move to the prior step. For example, if the dog is demonstrating fear, uncertainty, or dislike towards the harness, the trainer may revert to a prior step of the training. For example, the trainer may return to the step of showing the dog a harness embodiment and allowing interactions with rewards without putting a harness embodiment on the dog. After the dog begins to feel more confident, the trainer may continue to proceed to the next steps of the training.

There are numerous ways an apparatus allowing access to significant spatial positions, such as a harness, may be introduced to a user, including but not limited to the steps described below:

Step 1: The trainer obtains a device embodiment of the invention, such as a harness, and sets up a training space where a dog the trainer is going to train may encounter the embodiment. The trainer will not place the device on the dog or have the dog wear the device at this time.

Step 2: A trainer may place an embodiment on the ground, may hold an embodiment in the trainer's hands, or may make other choices that allow a dog to investigate and interact with a device on their own if they decide to.

Step 3: The trainer allows the dog into the room that contains the embodiment.

Step 4: The dog may be allowed an opportunity to interact with a device according to the dog's own choice, which may help the dog to feel confident around the device, for example, the dog may feel less afraid or nervous around the device.

Step 5: The trainer may use positive verbal feedback, treats, or other rewards to encourage the dog to investigate a device.

Step 6: If the dog approaches, sniffs, smells, gazes on, or otherwise shows some interaction, attention, and or interest with the embodiment the trainer may reward the dog. The reward may be high value or be a larger number of treats. Treating may help establish in the dog's mind that the device is a good thing. The dog may be encouraged to develop positive feelings about the device and interacting with it.

Step 7: Each time an interaction occurs that the trainer believes is progress, such as the dog not showing fear or uncertainty, the dog being curious or investigating, and/or having a positive reaction to the device such as wagging the dog's tail, then the trainer may reward the dog.

Step 8: After the initial positive interaction, the trainer may look for a moment where the dog is feeling very positive about the device, such as when the dog is excitedly interacting with the device and wagging their tail, opening its mouth in a “dog smile,” showing excited body language, etc. Once this “high point” in the training exercise is found, that may be an optimal time to end the session. The trainer may reward the dog and end the training session. This may leave the dog with positive feelings towards the device.

The trainer may continue to repeat these positive and brief interactions one or more times a day for a few days to a week, or longer, and for longer or shorter periods of time, depending on the dog's personality and learning skills. For example, individual sessions may be a few seconds, a few minutes or longer, as it may depend on the dog's temperament. Eventually, the trainer may develop a strong positive response to the device from the dog.

The trainer may train the user to investigate and explore significant positions and output functions of the device more confidently. For example, with respect to increasing confidence to powering on a harness embodiment:

Step 1: The trainer may wait to start the session until the positive association training for a user wearing a harness embodiment has been completed.

Step 2: The trainer may put a harness on the dog and praise or reward the dog.

Step 3: The trainer may switch the harness device's power on.

Step 4: The device may activate, make noises, provide haptic feedback to the dog via the haptic devices on the device, play audio if the dog's mouth opens, etc. Any of those interactions and/or experiences may be novel to the dog.

Step 5: The trainer may reward, such as providing praise or a treat, the dog the moment the dog notices anything new from the worn harness embodiment being turned on. This may help the dog view the novel experience as positive and associate the feedback from haptic devices and/or sound feedback or any other novel interactions as positive.

Step 6: After a brief period with the worn harness being turned on, and if possible when the dog is feeling positive and the session is at a high point, the trainer may turn off the worn harness embodiment and reward the dog.

Step 7: The trainer may take off the harness from the dog, or may leave it on the dog but turned off.

Step 8: The trainer may reward the dog and end the session. This may leave the dog more confident the next time they experience feedback from a harness embodiment.

The trainer may continue brief sessions of turning on the harness embodiment while rewarding the dog. Gradually, the trainer may increase the time that the dog wears the harness embodiment while the embodiment device is turned on.

The trainer may encourage interactions and reward the dog when the dog chooses to interact with an active harness embodiment, which may build the dog's confidence. When the trainer has determined the dog is comfortable enough to interact with the device, for example, because the dog does not show fear or uncertainty, the trainer may begin encouraging the dog to interface with the harness. This includes the dog moving its head around and exploring the phonetic space via the haptic devices while opening the mouth to allow sound to play. Any interaction the dog performs may be rewarded by the trainer. Initially, the trainer may keep these training sessions brief with plenty of positive rewards. Gradually, the trainer may lengthen sessions.

If the dog has not opened its mouth on its own, the trainer may encourage the dog to open its mouth a variety of methods. Some methods include but are not limited to: giving the dog a treat, as the dog may open his or her mouth as the dog attempts to eat it; offering the dog a toy, as the dog may open his or her mouth to grab the toy; or giving a pre trained verbal command for the dog to open its mouth etc.

Repeated exposure to an apparatus allowing access to significant spatial positions and investigation or exploration of such apparatus's functions may allow the user's brain to rewire and adapt to its use. Eventually, as the brain adjusts, a user may begin to effortlessly use the apparatus as if it were a natural extension of the user's body.

### 4.5.4.3. Communication Training

When the user is confidently using and exploring the functionality of an embodiment, the trainer may begin to encourage more deliberate communications. For example, where the user is a dog, the trainer may reward the dog as he or she makes progress towards training goals. Training goals include, but are not limited to: a dog his or her mouth and triggers a non-limiting embodiment to produce sound output; a dog moves his or her head around and feels haptic feedback from the embodiment; when a dog attempts to construct a sequence of sounds such as “yes” or “no,” including by feeling haptic feedback from an apparatus to orientate himself or herself to significant positions that correspond to the sounds that he or she is attempting to produce, and receiving auditory feedback as the result of opening his or her mouth while holding those significant positions. The trainer may also provide feedback to the user, including by repeating words; providing context to a word, including so that the dog may learn the meaning of the word; or by providing positive reinforce that the dog performed a behavior that the trainer liked or desired the dog to perform, including so that the dog may be more willing to perform the behavior again.

With respect to training starting and stopping sound outputs, a dog may naturally, through his or her own experimentation with a harness, determine how to start and stop audio output. A trainer may also train the dog to perform this behavior. For example, a trainer may train the dog to open the dog's mouth with a verbal command or other cue. The trainer may also train the dog to keep the dog's mouth open until the trainer gives a cue for the dog to close the dog's mouth. The trainer may train the dog to close the dog's mouth with a verbal command or other cue.

Clicker training techniques may also be adapted to train a dog to start and stop audio output. For example, the following steps may be followed to train a dog to open his or her mouth:

Step 1: The trainer may use clicker training and carry a clicker tool.

Step 2: The trainer may approach dog and offers a treat. The dog may open his or her mouth to eat the treat.

Step 3: The trainer may click the clicker in order to “mark” the behavior.

Step 4: The trainer repeats the treat giving with clicking and marking.

Step 5: The trainer may stop offering the treat to the dog, and instead hold a treat in his or her hand, including by closing the trainer's palm to keep the dog from accessing the treat.

Step 6: The dog may move and attempt to nose at or grab the treat with their mouth. The trainer does not let the dog eat the treat.

Step 7: Any time the dog opens his or her mouth, the trainer may click and mark the behavior and then reward the dog with a treat.

Step 8: The trainer may repeat the clicker marker training until the dog learns that each time he or she opens his or her mouth, he or she gets rewarded.

Step 9: The trainer may add a cue to the newly trained behavior such as the verbal command “open mouth.” The trainer may repeat the training until the dog can reliably perform the behavior when cued.

As another example, the following steps may be following to train a dog to open his or her mouth for longer periods of time:

Step 1: The trainer may repeat the cue “open mouth” to solidify the trained behavior. When the dog opens its mouth, the trainer may mark and reward the behavior.

Step 2: The trainer may click and mark the open mouth behavior when the mouth is open for a little longer time. The trainer rewards the dog with treats.

Step 3: The trainer continues to repeat this training. Each time the dog opens its mouth for a little longer period, the trainer gives a higher value treat or a larger number of treats.

Step 4: Repeat until the dog can keep their mouth open for a longer time period the trainer decides is appropriate. For example, a trainer may decide to have the dog hold their mouth open for 1 or 2 seconds, or 10, 20, or 30 seconds, etc.

Step 5: The trainer may add a cue such as the verbal cue “hold.” Or they may decide that the “open mouth” verbal command means “open your (the dog) mouth and keep it open until I (trainer), ask you (the dog) to close it.” The trainer may repeat the training until the dog can reliably do the behavior when cued. The trainer may repeat the training until the dog can reliably do the behavior when cued.

The following steps may be followed to train a dog to close his or her mouth:

Step 1: The trainer may train the dog to close his/her mouth a variety of ways. One way may be to use “close mouth” as a release command. When the trainer says “close mouth” the dog may stop opening its mouth. The trainer may click and mark the behavior.

Step 2: The trainer may repeat the training until the dog can reliably do the behavior when cued.

Training for “open mouth” and “close mouth” may be applied to training a dog to start and stop audio output through interactions with the harness:

Step 1: The trainer places the non-limiting harness embodiment on the dog, without turning the device on.

Step 2: The trainer cues dog to perform “open mouth” and “close mouth” behaviors in order to have the dog practice the behaviors while wearing a non-limiting harness embodiment.

Step 3: Once the dog is consistently performing the “open mouth” and “close mouth” behaviors while wearing an inactive harness the trainer may turn the harness embodiment on, activating the device.

Step 4: The trainer cues the dog to “open mouth.” The dog opens his or her mouth and the embodiment may output audio feedback. The trainer turns off the harness and rewards the dog. The dog will have successfully started a phonetic sequence.

Step 5: The trainer repeats turning the harness on and cueing the dog to “open mouth” and then turning off the harness and treating. Extending the length of time the harness is turned on over time.

Step 6: When the dog is comfortably and reliably opening his or her mouth and producing audio feedback when cued (and or on the dog's own) the trainer may leave the harness turned on and cue the command “close mouth.” The dog may close their mouth in response triggering the embodiment stop the audio output. The dog has successfully ended a phonetic sequence. The trainer may turn off and inactivate the embodiment and reward the dog. When the trainer feeds the dog a treat, the dog's mouth may open and close a number of times as the treat is consumed, and by turning off the embodiment first before treating the trainer avoids placing the dog in a situation where the dog unintentionally trigger the embodiment to start and stop audio output over and over again. In early training the trainer may decide to strategically turn off the harness to avoid potentially confusing the dog.

Step 7: The trainer may repeat the exercise described above in Step 6 until the dog consistently performs the trained behaviors “open mouth” and “close mouth” while the harness embodiment is turned on.

Step 8: The trainer may keep the harness turned on after the “close mouth” command. The trainer has the dog practice the behaviors of opening and closing the mouth with cues while keeping the harness turned on.

Step 9: The trainer may repeat Step 8 until the dog can consistently do the trained behaviors of opening and closing the dog's mouth. When the dog is comfortably and reliably starting and stopping audio feedback via the non-limiting embodiment then the trainer may introduce other aspects of training related to the functions and use of the non-limiting embodiment.

A dog may also be trained using target methods to communicate using a harness embodiment. For example, a dog may be trained by a trainer to touch their nose on a target. Targets can take many forms including but not limited to: post-it notes, a trainer's hand, and frisbees.

In the following non-limiting example, a trainer uses a wooden stick with a small ball attached to the end. The small ball may act as a target that the dog may touch. The stick attached to the small ball may aid the trainer in moving the target to desired significant positions so that the dog may, for example, touch their nose on the target and therefore move the dog's body to significant positions. The trainer may use a training tool to aid the trainer in determining the dog's position such as the headphone training tool embodiment mentioned earlier:

Step 1: Trainer shows the target to the dog. The dog may investigate the target. When the dog investigates, approaches, touches, looks at, and/or smells the target, etc., the trainer praises and rewards the dog.

Step 2: If the dog does not show any interest in the target (does not investigate, approach, touch, look at, or smell, etc.) then the trainer may place a treat in the trainer's hand and hold the treat next to or near the target.

Step 3: When the dog investigates the treat the trainer rewards the dog.

Step 4: The trainer may encourage the user to place their nose against the target by using treats, praise, etc.

Step 5: The trainer may repeat this exercise until the dog consistently attempts to touch the target with the dog's nose

Step 6: The trainer may add cue to the behavior such as the verbal command “touch.” The trainer repeats the training until the dog consistently performs the behavior.

Step 7: The trainer moves the stick to new and different positions (moving the target) and cue's the dog to touch the target. The dog may learn to touch the target even when the target is placed in various locations and not just at one set location.

The “touch the target” training may allow a trainer to direct a dog's head more precisely and direct it towards various significant positions. A trainer may direct a dog to move to a significant position. The target behavior may include a Phonetic Sound Sequence, a word sequence, a sentence sequence, or other sounds:

Step 1: A trainer may decide on what training goal he or she wishes to train such as: what sounds and/or the one or more words that the trainer wishes the dog to learn to communicate. If the trainer wishes to teach a word or words, the trainer may look up how the one or more words are constructed phonetically. After locating which phonetic sounds comprise the target goal, the trainer may look up which significant positions correspond to the target goal's phonetic sounds.

Step 2: A trainer may wear a headphone training tool, such as a non-limiting headphone training device.

Step 3: A trainer may place a harness capable of accessing significant spatial positions on the dog and powers on the device.

Step 4: A second trainer may hold the dog's torso in place so that the dog may only easily move the dog's head and neck.

Step 5: The first trainer may hold the targeting training stick and move the target (small ball or sphere attached to the stick) to the significant spatial position the trainer would like to teach to the dog. As the dog moves to touch the target, the trainer thus may direct the dog's head position to the one or more targeted significant spatial positions.

Step 6: When the dog touches the target, the trainer listens via the headphone training tool to assess if the dog has reached the significant position the trainer is targeting. When the trainer hears the audio output (through the headphones) that corresponds to the targeted significant positions, the trainer has successfully directed the dog to reach the targeted praises and rewards the dog.

Step 7: Trainer may use target training to direct the dog's head to the Significant Consonant Positions and the Significant Vowel positions. Many positions may easily be reached via the above training methods. If needed there may be additional techniques to support Head Tilt and Head Forward/back Positions.

Examples of how a trainer may pre-train or train a user in parallel with target training to use the head tilt gesture to reach significant positions may include but are not limited to:

i. The trainer making a novel sound that the dog tilts its head when, using clicker training, and/or praise or reward to capture the behavior and reward the behavior, so the dog may try to do it again. The trainer may gently move the dog's head so the dog's head tilts. The trainer rewards the dog and repeats the training until the dog reliably does the behavior when cued.

ii. The trainer may put a toy in the dog's mouth (such as but not limited to a rope tug toy) and then the trainer may grip the toy on either side with the trainer's hands. The trainer may grip the ends of the toy and gently move the dog's head physically until it tilts and reaches the targeted significant position. The trainer may treat or reward the dog to capture the position and continue to practice until the behavior is consistent.

iii. The trainer may scratch the dog around the collar and or behind the ear (that general region that a lot of dogs find to be itchy), and the dog's head may begin to tilt in reaction. The trainer may use a clicker to mark the behavior and reward the dog. The trainer repeats the training until the dog reliably does the behavior when cued.

iv. A trainer may wait for the dog to perform the tilt head behavior naturally and spontaneously. The trainer may reward the behavior immediately with a treat and praise the dog to capture the behavior. The trainer may reward the dog whenever the dog does the behavior and practice a cue for the behavior until the dog consistently does the behavior when cued.

A trainer may train a dog to move its head and neck forward while the dog's main body does not move forward, such that the head and neck moves forward and stretches forward. A trainer may place a short block such as a short wall or ask a second trainer to hold the dog's body back physically, leaving the dog's head and neck able to freely move. The trainer may then use a target, treats, etc., to motivate the dog to move forward. To reach the target, treats, etc., the dog stretched its head forward and reaches the significant position 2008.

Step 8: The trainer may train the dog to hold both significant vowel and significant consonant positions simultaneously. The trainer may place the target in a significant position that is a combination of both a vowel and a consonant position. For example, the dog may trigger the audio output for the question word: “Who?” The trainer looks up the phonetic sounds that makes up the word. Those sound's phonetic symbols are: “h” (the h sound in ‘ha” or “who”) and “u” (the “o” sound in “ooh”). The phonetic sounds “h”+“u” combined together phonetically create the sound of the question word “who.”. The consonant “h” 1723. The “u” phonetic sound has been assigned to the position described in FIG. 12 at vowel 1215, which is a combination of the gestures or positions illustrated in FIGS. 19A, 20A and 20C, and 18C. The trainer uses various techniques mentioned above to direct the dog's head to a combined position including all the relevant consonant and vowel positions. The dog's head is turned to the left while also in the upper, back, and tilted left positions. All these positions may be held simultaneously as they do not interfere with one another.

Step 9: The trainer instructs the dog to open its mouth with the verbal command “mouth open.” The dog is cued to open his or her mouth, such as is illustrated in 1623 in FIG. 21A to 1623 in FIG. 21B. The embodiment is triggered by the mouth opening to produce audio output. The audio output the speaker plays is are the phonetic sounds assigned to the position the dog is holding (which is comprised of the combination of both the phonetic position for the consonant “h” and the vowel phonetic position for “u.” When both positions are taken C+V (consonant position+vowel position), the consonant sound may play first, followed by a transition sound, and finally the vowel sound. The speaker plays the sound “who.”

Step 10: When a dog opens its mouth a word sequence or phonetic sound sequence may begin. If the dog's mouth remains open, the ending phonetic sound of the sequence (phonetic sound sequence, word sequence, and or sentence sequence) will continue to stretch and play. If the dog outputted the word “who” and kept his/her mouth open then the phonetic sound “u” (“ooh”) would continue to stretch out and play. The dog would be saying “whoooooooooooo . . . ” until the dog closes his or her mouth and ends the sequence (the sound would halt). The trainer may give the verbal command “close mouth” to cue the dog to close its mouth. After closing his or her mouth, the dog may start a new separate sequence whose sound is not affected by the last sequence.

Step 11: Training a user to take the first phonetic sequence's sound's position, open his or her mouth, and while the mouth remains open, move to the second phonetic sound sequence's position, playing and transitioning between the phonetic sounds of Unit A and Unit B. The user may end the Unit A to Unit B sequence by closing his or her mouth. More complex sequences can be made by moving between additional positions while the mouth remains open. This technique may result in a user creating a more complex “word.”

The trainer may wish the user to combine one or more phonetic sound sequences into a word sequence such as with the word “hood”. For example. The dog could be in the combined position that includes the positions for “h”+“u” (as was described in steps 8-10). The dog may be instructed to open their mouth and produce the sound “whoooooooo . . . ” the trainer may not release the dog from the mouth open position by not giving the cue for “mouth close.” While the dog's mouth remains open and the sound “whoooooooo” continues to play speaker, the instructor moves the target to the significant consonant position assigned to the phonetic sound “d” (the “d” sound in “hood”). The dog's head is directed to the combined significant vowel position that is assigned to play no vowel sound (neutral vowel position) located at the combined locations of 1858 in FIG. 18B, 1908 in FIG. 19B, 2007 in FIGS. 20A and 20C and the significant consonant position 1725 described in FIG. 17. The trainer has the dog move directly to the new position. The dog may feel other significant positions it may pass by via haptic feedback, but the audio from those positions will not be triggered to play unless the dog pauses long enough on one of those positions. The dog moves to the target at the targeted position and holds their position. The sound transitions to the next phonetic sound “whooooo . . . ” becomes “hood.” The transition sound between the phonetic sounds “u” and “d” is automatically added between the two sounds. The trainer may cue the dog to close the dog's mouth. The dog may close its mouth and end the sequence.

Step 12: The trainer may direct the dog to start and end multiple phonetic sound sequences, which may result in multiple words being spoken in sequence. This may create a sentence sequence. An example may include but is not limited to: “Max loves Dad.”

In some training method embodiments, the trainer may lead a user through a word made up of phonetic sounds using a targeting instrument or device as was described in non-limiting examples above. Another technique may include the trainer trains the dog to use commands for the various behaviors, and instead of using a targeting system, the trainer may use commands to move the dog's body into significant positions. In a non-limiting example: the dog may be trained to turn its head using the commands “right” or “left”, “up” or “down”, “tilt right” or “tilt left”, “forward” or “back”, “mouth open” or “mouth closed” etc. The dog has been trained what gestures/general positions these verbal commands correspond to and may move their bodies around until they reach a significant position the trainer wishes to train the dog at. The trainer may repeat certain commands “right,” “right,” “right,” to indicate the trainer wishes the dog to go further in the direction of the command and so the dog may gradually move its head (in a non-limiting example) more and more to the right until the amount desired by the trainer is reached. The trainer may verbally or nonverbally command various non-limiting types of commands “right,” “down,” “forward,” for example.

A trainer may also train the dog to pair the output the dog triggers, such as words, with meaning, such as the meaning associated with those words. A meaning of a word (or other communicative output) may be learned via induction. A learner may have a hypothesis of what a word means based on the situation in which it observes the word being used. The context the word is used in may teach a user what the word means. The user may learn by having the range of meanings that a word could possibly mean be limited. For example, pairing the word “walk” with a dog leash by praising or rewarding the dog when the trainer has said the word “leash” and showing the leash to the dog. The trainer may also repeat the word “leash” verbally themselves.

The social context of a word's use may also aid in understanding. The user may also gain feedback from the environment. For example, the user may learn to turn on and off lights using smart home devices such as Alexa or Apple's home pod that are in the environment. The user may also receive reactions from other humans, and other users who are either human or animal. Multiple dogs wearing an apparatus allowing access to significant spatial positions may have the opportunity to verbally communicate with one another.

An environmental factor may actively or passively give feedback that may result in the user reinforcing the user's understanding and fluidity with an apparatus such as a harness. For example, where the owner's back is turned from the dog and the dog knocks their head on a coffee table and says “ow,” the owner may turn and be able to sooth or help the dog. The dog interacting with the coffee table in its environment and interacting with an apparatus to produce output resulted in feedback from the owner. The dog was hurt, and the human soothed the dog. The dog received positive feedback that communicating through using an apparatus to express the word “ouch” resulted in attention and care from their owner. The user may learn that using the word “ouch” and/or other words can aid the user in communicating their needs.

Through interactions and feedback from the trainer, or environment, social context, and/or from an apparatus such as a harness, the user may learn to interact the apparatus with deliberate actions to facilitate communication or creation of data.

For example, the dog may form a word as an output in a non-limiting embodiment and a trainer may reward the dog for this behavior. The dog may practice the word with the trainer until he or she can consistently use the word. The trainer may pair/assign the word with a command, such as: “Out” (the trainer may say “say out” to command the dog to use an embodiment to output the word “out”).

As another example, a dog may be encouraged to repeat the word “out” when they want to go outside. A trainer may observe the dog indicating that he or she wishes to go outside nonverbally: the dog pawing at the door, the dog going back and forth with their gaze between a trainer and a door, the dog grabbing a leash with its mouth and presenting it to a trainer, etc. A trainer may encourage a dog to use an embodiment to output the word “out” while the trainer gazes at the dog and the door. The trainer may verbally command a dog “say out,” wait for the dog to say “out” without opening the door, reward the dog whenever they say “out” (for example, by opening the door to let a dog out, and then praising/rewarding, etc.).

The frequency a word is spoken may also be a factor in connecting output with meaning. A trainer may repeat words and connect the sounds to meaning. A trainer may start simply with objects etc. Any sound with deliberate purpose is rewarded. After numerous repetitions, a user may begin to use the device more effortlessly and naturally, and his or her attention many be more focused on what they wish to communicate rather than the mechanical steps required o produce that output using the device, such as a harness embodiment of the invention. In some non-limiting embodiments, a trainer may pair a word with an action, a noun, and concept, etc. For example, a police dog may say “bomb” when presented with the smell of the chemicals used in a bomb (which they are trained to detect in police training).

In a non-limiting example of a harness embodiment that may use phonetic systems, the trainer may produce a tennis ball and repeat the word “ball.” The user may hear the word repeatedly and attempt to repeat the sound via interaction with an embodiment. At first, the trainer may reward the user every time the user makes an attempt to make a sound when presented with the ball. The trainer may then encourage further sound making with rewarding the user every time they make a sound and look and or interact (or attempt to interact) with the ball. The user may make a sound that is close or partially correct to the phonetic sound of “ball.” The user may say “bah” or “buh” and not include the end sound of “1.” Even small phonetic sounds that are not perfectly mimicking the word may be used by the user. The trainer may praise or reward these attempts to further encourage and provide feedback to the user that they are moving towards a desired goal. The dog may be encouraged and continue to experiment. The dog may on its own without a ball say “bah” or “ball” to the trainer. The trainer may present the tennis ball to the user to reinforce the meaning (and also may reward the user). The user may feel encouraged and more motivated to attempt this word/sound/embodiment interaction and may continue to say “ball.” The user may learn to ask for the ball and expect the trainer to understand that the dog wants to see/interact with the ball, and/or is attempting to communicate to the trainer that it is thinking about the ball. The user may begin to use the word it learned to request the ball, and/or express other communications.

A dog may be trained to turn the harness on and off. A non-limiting harness embodiment may include a switch on the side of the harness or include another means by which the harness may be turned on and off. The trainer uses a different shaped target, such as a small cube shaped target at the end of the targeting stick, to teach the dog to touch the target with its paw. The trainer may train the dog to touch the cube target with its paw and have the target move to the location of the on/off switch. The dog may attempt to touch the target and instead touch the switch. The trainer may reward the dog. The trainer introduces a cue and repeats the training until the dog reliably can turn the harness on and off. Through experimentation, the dog may learn that the on/off switch turns the harness on and off. The dog may make deliberate choices to turn the harness on or off. For example, the dog may decide to eat the dog kibble in his or her bowl while the harness is powered off, and then turn it on to tell its owner how much it prefers chicken.

### 5. Exemplary Use Cases

There are numerous ways communication may be facilitated via non-limiting embodiments, including those embodying devices such as a harness that allows access to significant spatial positions in order to phonetically construct speech and/or those that use gestures to play prerecorded messages. The examples below include but are not limited to circumstances where communication may occur and various use cases. The examples are non-limiting and there are numerous additional ways an embodiment may facilitate communication and/or information transfer. The list of use cases is numerous and nonlimited by the examples described below.

Owners keep pets for various reasons such as but not limited to companionship, security in their home, etc. There are various ways that an embodiment of this invention, such as a harness, used by a dog and or other pets may facilitate communication under various circumstances. Nonlimiting examples of words and other forms of communication that may be used are described below, many numerous variations of words and or other forms of communication may be used. The descriptions below show nonlimiting examples of use cases using nonlimiting embodiments:

A dog may be hungry and may interact with an embodiment. Through training, a user such as a dog may have learned to create the word “food,” “meal,” “hunger,” or codes or short hands, for example, shortened sounds representing words, like “foo” instead of “food” a user may have been trained in. A user may also use a sequence of words such as but not limited to “hungry now,” “food now,” “need foo,” etc.

A dog may approach its owner and interact with an apparatus embodiment. A dog may create a sequence of gestures with communicative goals by triggering an embodiment when a dog triggers various significant spatial positions that a dog may locate via haptic feedback devices. A dog may consistently produce these sequences and with training pair the sequences with meaning through additional training (such as but not limited to the examples described in the training section).

A dog may approach its owner, interact with an apparatus embodiment, and indicate that the dog is hungry by asking for “food,” “foo,” “hunger,” “food now,” etc. A dog is thirsty and may communicate this to an owner by interacting with a non-limiting embodiment and outputting the phonetic sequence for “water,” “thirsty,” or “Wander,” etc. A dog may be bored and communicates the word “play” or “toy” etc. A dog may have an emotion and communicate that emotion to the owner such as “Happy,” “worry,” “sad,” “mad,” “scared,” “love,” “excite,” etc.

A dog may see an owner's child is drowning in the owner's pool without the owner realizing and the dog may communicate to notify the owner with words such as “help”. A dog may be injured and communicate the dog's pain, such as “pain”, “ouch.” A dog may hear noise outside and communicate what the dog heard to an owner such as “stranger,” “stranger outside,” “package came,” “Coyote,” “cat,” “friend,” etc.

A dog may communicate its likes and dislikes to an owner with words like “good”, “like”, “bad”, “no”, “yes.” A dog may communicate questions to an owner using question words including but not limited to “how”, “why”, “where”, “when”, “what” etc. For example, the dog may ask “where dad?”

A dog may communicate to a stranger “hello” while walking with the owner, or when greeting a guest at the owner's home. A dog may communicate “belly ache” to a vet who is trying to help diagnose what health problem a dog is having. A dog may communicate to an owner whether they “liked” or “did not like” going to a boarding and or day care facility. A dog may communicate to an owner about whether they “liked” or “did not like” a dog groomer the dog had a haircut with.

### 5.2. Service Animals

Service animals are working animals that perform numerous kinds of tasks in order to support their handler. The handler has a health-related condition that may make it difficult for the handler to do various everyday tasks. A service animal may alleviate a handler's difficulty through the service animal's trained tasks.

There are various ways that an embodiment used by a service animal such as a dog and/or other kinds of service animals like miniature horses etc. may facilitate communication under various circumstances. Nonlimiting examples of words and other forms of communication that may be used are described below, many numerous variations of words and or other forms of communication may be used in various circumstances and contexts, including but not limited to within the categories of service animals listed below. Below describe non-limiting examples of use cases using non-limiting embodiments:

A guide dog that guides people who are blind may communicate their needs “hungry,” “thirsty,” and may communicate information to their handler, such as “stairs,” “car ahead,” “friend,” “curb,” “busy” (when a street ahead of them is busy), “tree branch” (if a tree branch is in the way), “wait,” “stop,” “go,” “help” (if their owner has fallen and needs assistance from third parties a dog may approach another person to ask for help), “walk” (if a guide dog sees a walking sign activate on a street crossing). Dogs may learn to read. A guide dog may learn to read simple words and communicate those words via audio output to their handler, such as “stop” at a stop sign.

A seizure alert or response service dog may detect that their handler is going to have a seizure before the seizure event occurs. The dog may communicate “seizure,” “coming,” “help,” “lie down” etc. to the owner or third parties.

Diabetic alert service dogs may smell blood sugar levels and may communicate additional details about the status of the dog's handler's blood sugar using a non-limiting embodiment. A diabetic alert service dog may communicate “low” or “high” to communicate the owner's blood sugar level. A diabetic alert service dog may also alert a handler and or other third parties about other surrounding people who may have diabetes, such as in a hospital setting.

Mobility assistance service dogs may aid people with mobility issues, including physical disabilities such as people who require devices such as scooters, crutches, wheelchairs, canes, etc. A mobility assistance service dog may communicate to the dog's handler “potty” (if the dog has to urinate or defecate), “which can?” (to ask which beverage the handler wishes the service dog to retrieve for the handler such as a can of sparkling water), “help” (if the person has fallen and needs assistance from another third party in an emergency), “lights” (a dog asking it's handler if he/she would like the lights turned on/off, and if so they may jump and paw at the switch to turn it on/off).

PTSD service dogs such as but not limited to those service dogs who work with veterans. PTSD service dogs may communicate to a handler with words such as but not limited to “it's okay” (soothing phrase), “love dad” (or mom), “wake” (if the person with PTSD is showing signs of having a nightmare), “calm” (notify a handler that they may be feeling triggered), “help” (if a handler needs help from a third party), “space” (a service dog would like to inform a third party that their handler needs space, such as when they are feeling triggered), “stop” (a service dog interrupts a handler's self-harm attempt).

Autism service dogs may aid a handler with (nonlimiting example) using calming or soothing communication: “calm,” “you okay,” “love” etc. An autism service animal may communicate to a handler that the handler should pet the dog with a word such as “pet.” An autism service dog may remind a handler with autism to use self-soothing and grounding behaviors such as “breathe” (to remind the handler that they may try a breathing exercise to ground themselves). Sometimes those living with autism may spend long periods of time where they do not speak. An autism service dog may be taught to relay communication. An autistic handler may use hand signals to indicate which words the handler would like the dog to communicate to a third party such as but not limited to “yes,” “no,” “later,” “now,” “tired,” “space,” “happy,” “sad,” “book” etc.

A hearing service dog may aid a person with a hearing disability (handler) with communication to third parties and/or to the handler. A hearing-impaired person who reads lips and may be talking to a hearing person who does not understand sign may signal to a hearing dog and have the hearing dog communicate words like: “hi,” “yes,” “no,” “where” etc. The dog may translate sign language to a third party who does not understand sign language. A hearing dog may or may not understand a full and complex conversation between a hearing-impaired handler and a third party, but a hearing service dog may understand a hand signal as a command to interact with an apparatus embodiment in a specific way a dog has been trained.

A hearing service dog may use a non-limiting apparatus embodiment that sends text messages in addition to (or instead of) audible output. The apparatus may be programmed to interpret a dog's input and create a text message that a hearing-impaired handler may read. The dog may relay communication such as: “door” (if someone is at the door), “Ray come” (if a friend named Ray came to the door and knocked), “car” (to notify a hearing-impaired person if they cannot hear a car that is coming up behind them in a parking lot) etc. Other forms of text output are possible, including displaying text on an accompanying screen.

Allergy detection service dogs may communicate to their handler if a substance the handler is allergic to is nearby with words like: “bee,” “stop,” “bad” etc. Or if there is an absence of allergens nearby: “okay,” “safe.” A handler may have an allergy detection service dog use shorthand phonetic sound to represent specific allergens, including if a handler is sensitive to multiple allergens: “A” (to denote an allergen like pollen), “B” (to denote an allergen like seafood), “O” (to denote an allergen like peanuts), etc.

### 5.3. Search-and-Rescue Dogs

A search-and-rescue dog is one trained to find missing people after a natural or man-made disaster. Search and rescue dogs may be used during a variety of situations such as but not limited to: searching for a lost person in the wilderness, a child is lost and a search party searches (sometimes a search and rescue dog may smell a missing person's scent and attempt to locate the lost person by following their scent), searching for people in disaster situations (examples: in the terrorist attacks of 9/11 search and rescue dogs looked for survivors in the rubble, other disaster's may include earthquakes, floods, tornadoes and hurricanes etc.). People may be found under water, under snow, under rubble etc.

Some examples of communication a search-and-rescue dog may communicate to the people the dog comes across that a search-and-rescue dog may try to rescue may include but are not limited to: “It's okay,” “I'm here,” “wait,” “found,” “help come” (indicating help is coming). A search-and-rescue dog may communicate to a handler that they have found a human “found,” where they found them “under snow,” the found person's status (“hurt,” “okay,” “dead”). A search-and-rescue dog may communicate the dog's needs to the handler (if a dog is hurt or hungry etc.). A trained dog may also communicate if the dog has caught a scent. A search-and-rescue dog may communicate if the dog is tired or needing a break.

### 5.4. Police Dogs

Police dogs may apprehend suspects, search-and-rescue, and detect by smell. Some examples of communications a police dog may communicate include but are not limited to: “stop,” “ouch,” “hands up,” “see man,” “smell drug.” The police dog may communicate when he or she is injured or in pain, such as “ouch,” “pain,” “help.” A police dog may warn a suspect that he or she is apprehending phrases including “gun down,” “lie down,” “stop.” The dog may communicate to the handler information about the suspect the handler including “smell suspect,” “smell alcohol,” “smell drug,” “smell blood.” The police dog may communicate if there are obstacles in the way of the dog handler team, including “way blocked.” A dog may communicate to the police information about a crime scene, including “blood,” “bleach,” “acid,” etc.

When training police dogs, police may train a dog to either smell for drugs or bombs but not both as the dog is unable to communicate whether the dog smells either a bomb or a drug. Traditionally, the dog is not able to communicate what chemicals are in the bomb or what type of drug they have found. With a harness embodiment, for example, the dog may now communicate “bomb” or “drug.” In addition, the dog may communicate details about what the dog smells, including “C4,” “gunpowder,” “cocaine,” “Fentanyl” etc. Security dogs could communicate what contraband they have found in a suitcase at the airport. Security dogs at a courthouse may help indicate to security personnel if a human who is trying to get in is ill.

### 5.5. Medical Canines

Working dogs may work in a medical related field, such as in a hospital, a senior care facility, a medical tent etc. The dog may communicate if human blood sugar is too “high” or “low.” A dog may communicate if someone is about to have a seizure, including by communicating the word “seizure.” The dog may indicate to the handler that they smell cancer on a patient and potentially what kind, allowing the doctor to diagnose the patient more quickly. Some cancer dogs can distinguish between different types of cancers. Some dogs may smell different disease and may communicate which diseases they smell on a patient.

A dog may travel to a hospital to visit patients as a therapy animal and communicate positive messages such as “hi,” “feel better,” “pet me,” “like you” etc. In a care home, a dog may communicate to a staff member or patient if a senior has already taken his or her medicine, including in circumstances where the senior is attempting to take the medicine a second time that day. In senior care facilities, hospitals, and in home care, a dog can smell if a patient has urinated or defecated and soiled themselves. The dog may communicate to the staff that the patient needs to be cleaned so the staff can promptly aid the patient.

### 5.6. Personal Protection and Guard Dogs

A personal protection dog may protect the dog's handler from physical attack. The dog may warn a threatening person to “stay away.” The dog may warn the dog's handler that a stranger is nearby. The dog may reassure their handler that they are “safe.”

### 5.7. Entertainment and Marketing Animals

In film and media, animals may be trained as “actors” in various medium. A trained dog may perform via communications. In a commercial, a dog may give their feedback on the flavor of a dog food. A dog boarding or daycare facility may ask a dog to review their experience. A dog may communicate spoken word lines as an actor in a film.

### 5.8 Animal Rights and Activism

A dog may communicate to the handler and demonstrate the dog's ability to think and feel. This may be used to advocate for the end of dog fighting, animal abuse, the eating of dogs as food, etc. Animal rights activist may also have other animals use the harness for similar purposes.

### 5.9. Dolphins

Dolphins may use the device to communicate about their species to human handlers. Dolphins can communicate during search and rescue procedures, notifying humans about what they find. Dolphins can communicate to humans they may rescue from drowning. Dolphins may be used for military tactical purposes and communicate to humans for those reasons.

### 5.10. Humans

Humans may use an embodying device to communicate, including for those persons who have damaged their voice box or otherwise cannot speak. With embodiments that employ neural implants, the neural implant receives gesture electrical signals and or thoughts, or positional thoughts or other electrical or chemical signals, that the person may use to communicate via one or more output devices such as but not limited to a speaker. Various professions may benefit from using this invention, including without limitation firemen, policemen, businessmen, military, sports teams, and government agencies.

For example, scuba divers under water may send a signal wirelessly to a third party, such as but not limited to humans up in a boat above them, or to another diver. The diver may communicate thoughts such as “I am out of air,” “there is a hammerhead shark near us,” “Are you okay?” A human hiking up a high mountain such as Everest may be out of breath in the thin air of the atmosphere at high elevations. The human may use an embodying device employing a neural implant to communicate with fellow hikers, or to seek help or assistance. As another example, soldiers may communicate silently and quickly during dangerous tasks. As another example, a coach for a basketball team may communicate nonverbally during sports games.

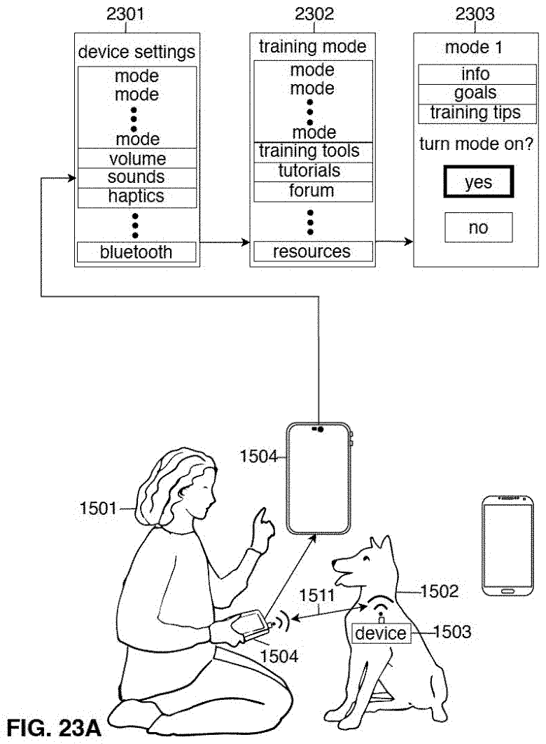

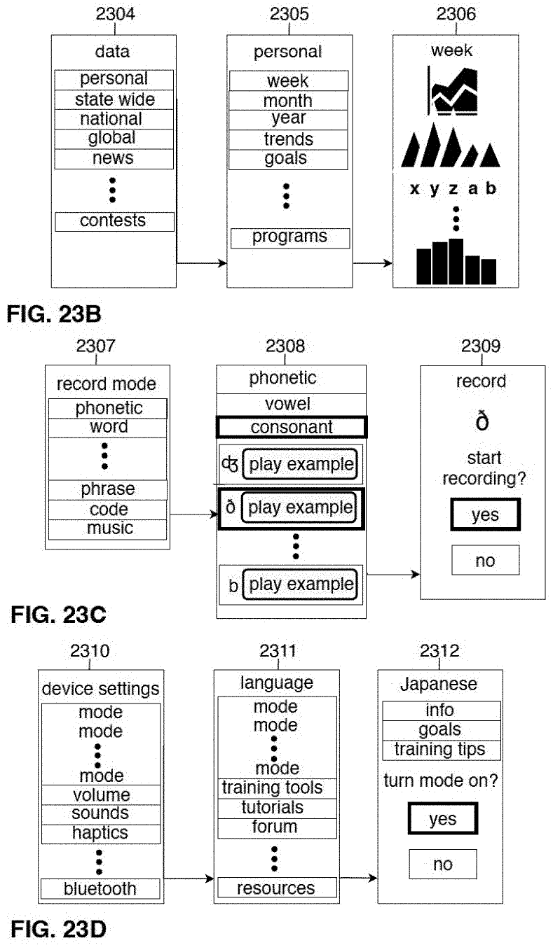

FIGS. 23A-D depict an exemplary app that may be accessed via tablets, phones, computers, screens attached to an embodiment of the invention and on other devices, televisions etc. A user 1502 and trainer 1501 may use the app and the features of the app (especially if the user is a human). FIG. 23A depicts a Trainer 1501 may use the app via a smartphone 1504 to gather data, adjust the settings and modes of a device 1503 worn by a user 1502 who may be a dog but may also be another human or animal. The app may communicate with the device 1511 through a variety of methods including, via a router, via a cloud, directly via Bluetooth or other wireless connection. The interface on the app may allow the trainer (or user if the user is human) to access features to allow customization of the use and training and data of a user with an embodiment. On screen 2301, the trainer 1501 has accessed a settings menu that may allow her to customize various aspects of the device and the experience using the device. Some of these features may include different modes, volume, sounds, haptics, and Bluetooth. Modes may include different ways an embodiment may function and may include language modes (different languages may use different sets of phonetic sounds, words, etc.), modes where phonetic sounds, and/or words and or phrases are assigned to significant spatial positions, and/or significant gestures (and or neural electrical and or chemical signals).

In FIG. 23A, a mode may have phonetic sounds play via a speaker when a significant gesture is made and or significant spatial position is reached. A different mode may have words and or phrases play via speaker when the user 1502 reaches assigned significant spatial positions and or makes a significant gesture. The trainer and/or user (if human, or if an animal user is trained to interact with an animal accessible screen (such as larger size) showing the app), may interact with the app to adjust the volume. The user 1502 may have trouble hearing lower volume sounds due to age, environmental noise etc. The trainer may adjust the sound volume. The trainer may adjust sounds such as in the case of phonetic sounds, words, phrases, the gender and age of the voice speaking prerecorded phonetic sounds. The user 1502 may have a younger or older, male or female, or other kinds of variation in the choice of sounds the user may activate. Haptics may also be adjusted. The user 1502 may have trouble feeling or noticing haptic feedback at varying strengths (a thick haired animal may feel less haptic feedback than a thin furred on despite the haptic feedback strength being on the same level. For some users 1502, strong haptic feedback may be uncomfortable or annoying. Varying types of haptic feedback sensations may also be adjusted via an app. Bluetooth capabilities and internet connection may allow the trainer 1501 to connect with the user's device and gather data, make adjustments to the device etc. The device may have zero, one, two, three, four, five, six, seven, eight, nine, ten, eleven, twelve, thirteen, fourteen, fifteen, sixteen, seventeen, eighteen, nineteen, twenty, and hundreds, thousands, and hundreds of thousands of modes.

The trainer 1501 has selected a training mode that appears on screen 2302. Screen 2302 is a training focused screen with different training features available for the trainer and or user to make use of. Within the training mode are additional modes. When beginning to train a user 1502, a trainer 1501 may decide to set the device to a limited number of options. A simpler set of options may make early training of the user 1502 with the embodiment simpler and easier. For example, a training mode may allow one significant position and or one gesture to be able to be interacted with. The user 1502 may practice interacting with the significant spatial position and or significant gesture until he/she is comfortable making a sound. Different modes may vary the way communication is produced (significant gesture, reaching for significant spatial positions, phonetic, word, phrase, tone, text message, etc.).

The trainer 1501 may also make use of training tool including but not limited to, useful signs and or images for the user 1502 to interpret (pictures of food, places, water, stick figures of dogs, short flash cards with words that the dog has learned to read as cues etc.), a clicker noise that the trainer 1501 may activate by tapping on the screen of 1504, earphone/headphone training where the user 1502 may interact with significant positions without activating sound (keeping mouth closed) but the trainer 1501 may still hear the sounds via earphone and/or headphone, allowing easier training. The trainer 1501 may use the knowledge of what sound the use 1502 is activating without opening his/her mouth, to understand what motion and orientation the user is in, and how to help the user direct a motion towards a communication goal. Other training features include tutorials (may be written training tutorials, video training tutorials, one on one coaching etc.), a forum where a community can take part in discussions, events, set up play dates, and exchange training tips, additional resources may include informational articles and other matter that may aid the user 1502 in training and or the trainer 1501 in learning how to train. Screen 2303 depicts the app showing an option to turn a mode on or off. The trainer 1501 may tap on the switch to turn the mode on or off. Additional information such as goals related to the mode, and training tips and info are also options that the trainer 1501 may tap on to open and learn more about. 2302, 2305, and 2306 in FIG. 23B may allow the trainer 1501 and/or user 1502 to access data on the user 1502's progress and interactions with a device embodiment. This may include trends over time, how often certain words or communications are used, and the overall proficiency and progress the user makes in learning to interact and use an embodiment. Trends of other parties and populations may also be included as well as news relating to data and trends and or new insights into how to effectively train, contests that may be occurring, shopping, etc.

FIG. 23C screen 2307 depicts a recording mode. The trainer 1501 may record different sounds using his or her own voice. These self-recording may be assigned to different significant spatial positions and or gestures that the user may then output and play via an worn embodiment such as a non-limiting harness embodiment. There may be multiple options such as phonetic sounds, words, music, code, phrases etc. that the trainer 1501 may record using his or her own voice to be used as output when the user 1502 interacts with an embodiment. Screen 2308 allows the trainer 1501 to record phonetic sounds to be assigned to significant spatial positions and or gestures using the trainer's own voice. The app offers example audio to be played to aid the trainer 1501 in accurately recording the phonetic sounds the trainer wishes to record his or her own voice over. 2309 may ask the trainer and or user if he or she would like to start recording. If the trainer 1501 presses yes, then the app will start to record, the trainer may begin to record the sound of their voice.

FIG. 23D screens 2310, 2311, and 2312 show the process by which a trainer 1501 may navigate through the app, similarly to how they navigate through FIG. 23B and FIG. 23A by touching different options which lead to additional menus. The trainer 1501 in screen 2310 has various options similar to depicted in screen 2301. The mode selected through 2311 is a language mode. A choice of language shows as options on the screen 2311. Screen 2312 shows that a mode of Japanese language has been selected. Japanese language does not use all of the same phonetic sounds as the English language does. The embodiment will shift to offer Japanese sounds only to the user 1502.

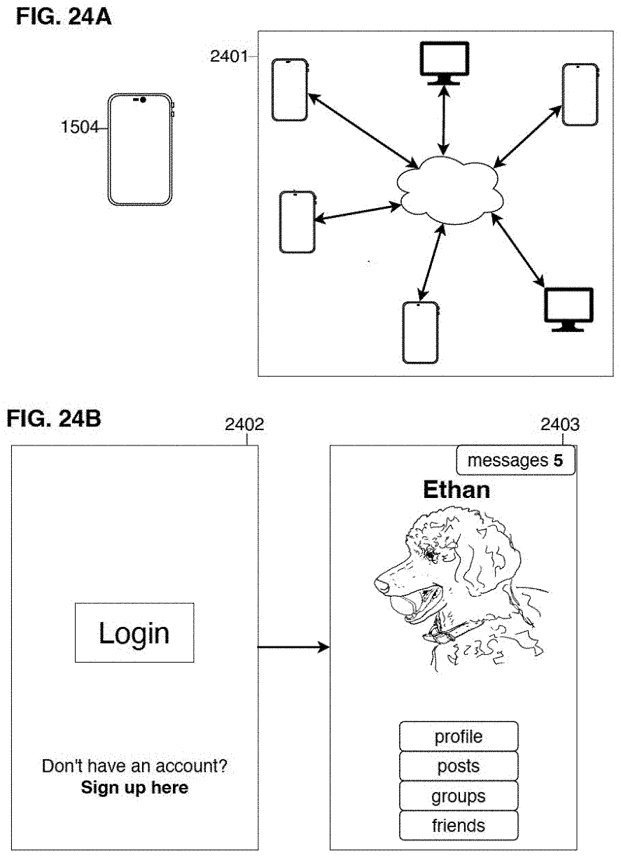

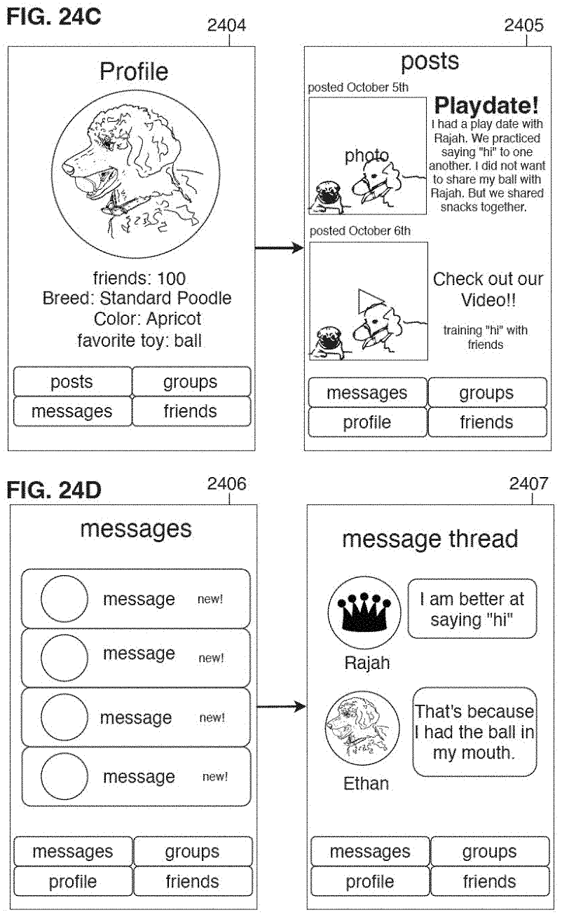

FIGS. 24A-D depicts an exemplary social media application that may be accessed on device 1504, which is a smart phone but may also be other devices such as tablets, computers, etc. The trainer and or user or third party may access the social media network 2401 through cloud. This may allow many users, trainers, and interested third parties to participate in a community that can aid one another in training, learning about the embodiment and its use cases, build friendships and relationships etc. FIG. 24B screen 2405 depicts a login screen. A trainer, user, and or third party may login to his or her profile. If the party that is trying to enter does not have a login, he or she will be prompted to sign up for his/her own account. Screen 2403 depicts a welcome menu. The user, trainer, and or third party's picture and name are shown along with menu options that the individual using the application may press and go to other screens of the app. FIG. 24C depicts a profile menu options that lead to other parts of the app. Other parties such as friends using the app may see the profile. Screen 2405 depicts social media posts such as videos, text, and pictures that the trainer 1501, user 1502, and or other parties may post onto the app to share with friends and others.

FIG. 24D screen 2406 depicts a message menu, showing messages the owner of the profile may see by selecting a message bubble leading them to a message thread screen 2407. Trainers 1501, users 1502, and other parties may interact and message one another. Dog owners may for example, set up play dates, have their pets interact with one another and practice training together. The experience of a dog who sees another dog perform a behavior may aid in training. There are many other functions that the application may have. Groups for example, may allow multiple members to message one another and plan activities, hold discussions, etc.

### 7. Additional Embodiments

There are numerous other non-limiting embodiments, some of which may be described below.

In some non-limiting embodiments, neural implants may learn to recognize electrical and or chemical signals from the brain that will allow spatial positions and or gestures to be recognized. The neural implant may be used to implement various embodiments including but not limited to PSOS in lieu of external physical attachments. The electrical and or chemical signals generated by the user's neurons corresponding to a spatial position may be read by a neural implant. Once the neural implant receives data it may interpret the data to determine if a significant spatial position has been reached and or significant gesture has been made. If so, the neural implant may signal a component such as but not limited to an audio speaker to release an output. In some PSOS related embodiments this may result in phonetic sounds being played, in some other embodiments, music, words, sentences, text messages, images, and other forms of output may be outputted.

The brain may also receive stimulus from a non-limiting neural implant embodiment. A neural implant may output electrical and or chemical signals into the brain of a user. The brain of a user may interpret these signals in different ways which may include but are not limited to tactile feedback, gustatory feedback, visual feedback, olfactory feedback, auditory feedback, balance changes, sensations of movement, itchiness, a sense of relaxation, etc. Some neural implant embodiments may provide feedback directly to the brain of a user to give a user the feedback that feels like a physical sensation. For example (non-limiting) a user could feel the neural implant signal like a haptic feedback device outputting feedback. The user could see significant spatial positions in the air in front of them as the neural implant provides signals to the visual tissues and systems within the brain. The significant spatial positions may be “felt” or otherwise sensed by a user, allowing him or her to navigate and locate various positions. As the user's brain becomes accustomed to significant spatial positions and or significant gestures, the user's brain may more powerfully recognize and signal when interactions and gestures occur. The brain adapts and becomes more fluid in using a PSOS embodiment and or significant gesture system. A neural implant embodiment may learn and recognize the electric and or chemical signals released by the user's brain through interaction with PSOS and or some other embodiments. The brain may become so used to the embodiments of the invention that the signal persists just by a user thinking about making a communication even if no active interaction takes place in the physical world. Conceptually the user may think about making a significant gesture towards a communicative goal for example, and the brain of the user may release the same or similar signal as when the user physically makes a significant gesture towards a communicative goal. The neural implant may learn to recognize the signal and produce output regardless of if the physical manifestation of a significant gesture had been performed or not. The user may begin to make communications just by thinking about using some embodiments and having a neural implant interact.

Neural implants in some embodiments may receive electrical signals from the brain which may include data such as body movement, position, and thoughts. The neural implant may apply the phonetic system described earlier based on this input data.

In some embodiments, a device may also be used in conjunction with a computer to brain connecting interface to identify signals that signal the brain using the systems and methods described in this patent to directly move to a brain to computer interface and allow the dog to intentionally trigger sounds with just the connection to the computer. The dog may still think based on the system, but now the mental changes to the brain that the device has resulted may now transferred to a brain to computer interface (the computer picks up the brain's chemical electrical signals resulting from the brain being exposed to experiences with a non-limiting embodiment and adapting. The physical non-limiting embodiment is no longer required to communicate via the significant spatial position and or significant gesture systems that the brain has adapted to and learned to use with a non-limiting neural implant embodiment. The non-limiting embodiment's effect on the brain is now in use seamlessly with a computer without a physical embodiment of the device such as the earlier embodiment described using a harness. The dog's brain has adapted to the device and now those changes remain in place, the system imbeds into the dog's brain, and the dog's brain may continue to use the system. Although the dog may no longer use a non-limiting physical embodiment, the dog is using an conceptual non-limiting embodiment, and now uses a nonlimiting embodiment that may use a computer brain interface to achieve the same or similar communicative goals as before.

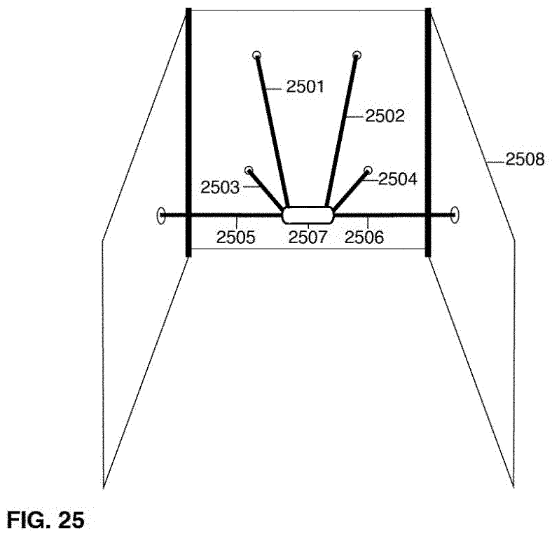

FIG. 25 depicts a non-limiting device 2508 that is not attached to the dog/user 1731, but may be accessed by the dog/user 1731. In some embodiments, there may be a mouth grip 2507 connected and suspended by extending structures 2501-2506 (there may be more or less in some non-limiting embodiments) attached to structure 2508. The extending structures maybe attached to a structure that the user may grip 2507. A dog, dolphin, or other animal may hold the grip 2507 in his/her mouth and move it in numerous directions in 3D space. The grip-able component 2507 may be gripped in the dog/user 1731 mouth. User 1731 may pull the grip-able component 2507 around to significant spatial positions and or significant gestures within 3d space. The thread, rope, extending structures etc. 2501-2506 that may hold the grip-able component 2501 suspended in space may retract into the surrounding wall or housing or structure of 2508 when moved by a user, similar to measuring tape.

The extending structures 2501-2507 may have sensors such as positional sensors attached to them to determine how much the user has moved the grip-able component and the new position. In some embodiments, sensors may be located at the end of the extending structures, within them, or within the gripping structure (or positional data may be detected by cameras or other sensors). In some embodiments, when tension, movement, and or change in position is detected the sensors may send a signal to a computer that may be similar to the computer depicted in FIG. 13 that may interprets the positional data. If the positional data is determined to show that a significant spatial position, and or significant gesture had been reached then a computer may signal to audio speakers to produce audio output. The audio output played would be determined by what significant position and or gesture was accessed by the dog/user 1731. The audible activation system may be replaced by gestures that are sensed through gestures made by other body parts (including but not limited to a paw).

The extending structures 2501-2507 may also contain haptic feedback devices and or other feedback devices to give feedback to the user. The structure may include components beyond the extending structures 2501-2507, haptic feedback components, sensors, and gripping structure 2501, including but not limited to a speaker, computer, and battery or wall plug in cable. In some embodiments a user may make similar or same significant gestures and or reach similar significant spatial positions as is discussed in FIG. 12, positions 1201, 1202, 1203, 1204, 1205, 1224, 1225, 1226, 1804, 1805, 1806, 1905, 1908, 1909, 2007, 2008, FIG. 17, and was discussed in non-limiting embodiment 1732 depicted in FIGS. 21A-D. For example, in some embodiments a user may turn his/her head left and right on a horizontal axis to feel and trigger consonant significant positions and or significant gestures such as was similarly described in FIG. 17 and FIGS. 21A-D.

Device 2508 may be attached to a wheelchair to be accessed by a service dog, may be attached to a wall to be accessed by a user 1731, and may be placed underwater to allow dolphin human communication, and may have other use cases that are not limited to those just described. Humans may grip the gripping structure 2507 and interact with the non-limiting embodiment to create communications.

In some non-limiting embodiments, a dog may wear AR contact lenses and or AR headset in order to be able to visually see embodiments significant spatial positions and/or significant gestures in three-dimensional space. A manifestation of this AR embodiment may include small colored balls. The dog's head may move independently of the significant spatial positions, so that the dog may move his or her head to interact with the significant spatial positions using visual cues.

In some embodiments the dog's position may be mapped through AR technology such as AR tracking software and cameras. Through cameras or other sensors used to track movement, the dog's head and body may be tracked and through those means the dog could use a phonetic system similar to the ones described earlier in this document. The position of the dog's body could be tracked by the AR tracking tech which may be used to trigger a speaker with various sounds. Haptic feedback, such as those that people use to touch holograms, may be employed to give feedback to the user. The dog may also wear physical haptic feedback components that indicate to the dog when it hits a significant spatial position. The dog's movements in three-dimensional space may be picked up through cameras located on a vest attached to the dog. Software could be used to identify the position the dog's head is in. The location of the cameras may include in the back, where it can easily locate the position of the dog's head. The cameras may also be located on the front of the vest. Once the location of the dog's head may be mapped visually (through computer vision software, similar or the same to that used in AR technology), a phonetic system described earlier in this document may be applied.

Lidar cameras may also be used to track a dog's head position. The lidar camera may be located outside of the dog or attached to the dog via a harness, collar, vest, or other structure.

Another nonlimiting embodiment may include implants that may surgically be placed inside (or taped to the surface of the skin) of a human or animal that may have sensors or beacons attached inside of it. The sensors or beacons may send a signal and positional data can be gathered from that. As the person or animal moves their mouth and body, the positional data may gather that info. Different positions may be assigned to different vowels and consonants (similar to the phonetic system described in earlier described embodiments) that may be played on a speaker. The mouth opening, closing, and or other movement may halt or start phonetic sequence sounds.

Many ways in which the body position and movement may be mapped by sensors, and this movement may use the artificial phonetic system described earlier to produce phonetic sounds and sequences. In some nonlimiting embodiments, these taped or surgical embodiments may be used in combination with neural implant embodiments.

What is claimed is:

1. An apparatus, comprising:
one or more sensors configured to generate signals indicative of at least one of a spatial position and an orientation of a user; and
one or more processors configured to receive the signals wherein the one or more processors execute instructions for:
determining that at least a portion of the user has intersected a defined spatial region or that the user has assumed a defined orientation; and
generating, based upon the determining, one or more output signals.

2. The apparatus of claim 1, wherein the user is an animal.

3. The apparatus of claim 1, further comprising:
one or more components configured to store data wherein the data includes sound data corresponding to one or more prerecorded sounds;
one or more speakers;
wherein the instructions further include instructions for:
selecting at least one of the one or more prerecorded sounds corresponding to the defined spatial region;
generating, based on the selecting, an output signal based upon the sound data corresponding to the least one of the one or more prerecorded sounds;
wherein the one or more speakers are configured to produce sound comprising the least one of the one or more prerecorded sounds in response to the output signal.

4. The apparatus of claim 3, wherein the one or more prerecorded sounds comprise phonetic sounds.

5. The apparatus of claim 1, further comprising:
one or more haptic feedback components configured to produce haptic feedback;
wherein the instructions further include instructions for generating, based on the determining, an output signal configured to activate the one or more haptic feedback components;
wherein the one or more haptic feedback components are configured to generate first haptic feedback in response to the output signal.

6. The apparatus of claim 5, further comprising:
one or more components configured to store data wherein the data includes sound data corresponding to one or more prerecorded sounds;
one or more speakers;
wherein the determining includes determining that the portion of the user has intersected the defined spatial region or that the user has assumed the defined orientation fora period of time that exceeds a threshold value representing a period of time;
wherein the instructions further include instruction for:
selecting, based upon the determining, at least one of the one or more prerecorded sounds corresponding to the defined spatial region;
generating, based on the selecting, an output signal corresponding to the at least one of the one or more prerecorded sounds;
wherein the one or more speakers are configured to generate sound comprising the at least one of the one or more prerecorded sounds in response to the output signal.

7. A system, comprising:
one or more sensors configured to generate signals indicative of at least one of a spatial position and an orientation of an appendage of a user wherein paths or rotations of the appendage in three-dimensional space fixed relative to a direction of a gaze of the user correspond to one or more gestures; and
one or more processors configured to receive the signals wherein the one or more processors execute instructions for:
determining that the user has at least one of: (i) moved the appendage along a first of the paths corresponding to a first gesture of the gestures, and (ii) rotated the appendage in a manner corresponding to a second gesture of the gestures;
generating, based upon the determining, an output signal corresponding to at least one of the first gesture and the second gesture.

8. The system of claim 7, further comprising:
one or more components configured to store data wherein the data includes sound data corresponding to one or more prerecorded sounds;
one or more speakers;
wherein the instructions further include instructions for:
selecting at least one of the one or more prerecorded sounds corresponding to the at least one of the first gesture and the second gesture;
generating, based on the selecting, an output signal corresponding to the at least one of the one or more prerecorded sounds;
wherein the one or more speakers are configured to generate sound comprising the at least one of the one or more prerecorded sounds in response to the output signal.

9. The system of claim 8, further comprising:
one or more components configured to produce haptic feedback; wherein the instructions further include instructions for generating, based on the determining, an output signal configured to activate the one or more haptic feedback components;
wherein the one or more components configured to produce haptic feedback generate first haptic feedback in response to the output signal.

10. The system of claim 9, wherein the one or more prerecorded sounds comprise one or more phonetic sounds.

11. The system of claim 10, wherein the user is an animal.

12. An apparatus for use with a dog, the apparatus comprising:
a harness adapted to fit over a dog's snout and body;
one or more processors attached to the harness;
one or more sensors attached to the harness, the one or more sensors operatively connected to the one or more processors;
one or more haptic motors attached to the harness, the one more haptic motors operatively connected to the one or more processors;
one or more speakers attached to the harness, the one or more speakers operatively connected to the one or more processors; and
one or more power sources attached to the harness and electrically coupled to at least the one or more processors and the one or more haptic motors.

13. The apparatus of claim 12, further comprising:
one or more storage components, the one or more storage components operatively connected to the one or more processors and configured to store sound data corresponding to one or more prerecorded sounds;
the one or more power sources further electrically coupled to the one or more storage components.

14. The apparatus of claim 13, wherein the one or more prerecorded sounds comprise
one or more phonetic sounds or one or more prerecorded sounds or phrases.

15. The apparatus of claim 13, further comprising:
one or more transceivers, the one or more transceivers operatively connected to the one or more processors;
the one or more power sources further electrically coupled to the one or more transceivers.

16. A system, comprising:
a first apparatus comprising:
one or more components configured to store and play sound;
one or more transceivers capable of communicating wirelessly;
a second apparatus comprising:
one or more transceivers capable of communicating wirelessly;
one or more microphones capable of recording sound;
one or more components configured to store and play sound;
a non-transitory computer readable storage medium embodying a computer program comprising computer instructions for:
recording one or more sounds using the one or more microphones;
connecting to the first apparatus wirelessly;
transmitting a recorded sound to the first apparatus.
wherein the second apparatus transmits recorded sound to the first apparatus,
wherein the first apparatus stores the recorded sound.

17. A system comprising:
a processor configured to:
determine social networking context, wherein said social networking context includes information regarding pets, comprising at least one of the following:
pet name;
pet age;
training statistics;
speech statistics;
generate at least one view based at least in part on the social networking context;
display the generated view.

18. A training method involving a trainer and a trainee wherein the trainer is a person and the trainee is a dog, the training method comprising:
observing, by the trainer, the trainee interacting with an apparatus wherein the apparatus comprises components that audibly generate at least one prerecorded sound in response to one or predefined actions of the trainee;
hearing, by the trainer, the apparatus audibly generate at least one prerecorded sound;
providing, by the trainer, a reward to the trainee.

19. A training method involving a trainer and trainee wherein the trainer is a person and the trainee is a dog wearing an apparatus, the apparatus including:
one or more sensors configured to generate signals indicative of at least
one of a spatial position and an orientation of the trainee;
one or more data storage components;
one or more speakers configured to receive signals and generate sound;
one or more prerecorded sounds comprising the phonetic alphabet stored on the one or more data storage components;
one or more processors configured to receive the signals wherein the one or more processors execute instructions for:
determining that at least a portion of the trainee has intersected a defined spatial region or that the user has assumed a defined orientation;
generating, based upon the determining, an output signal comprising the one or more prerecorded sounds;
wherein the one or more speakers configured to receive signals and generate sound receive said output signal comprising the one or more prerecorded sounds and generate sound comprising the selected one or more prerecorded sounds.
the training method comprising:
observing, by the trainer, that the apparatus generates the sound comprising the selected one or more prerecorded sounds;
providing, by the trainer, a reward to the trainee.
